(19) United States
(12) Patent Application Publication
(10) Pub. No.: US 2023/0382787 A1
(43) Pub. Date: Nov. 30, 2023

(54) Li2O-Al2O3-SiO2-BASED CRYSTALLIZED GLASS

(71) Applicant: NIPPON ELECTRIC GLASS CO., LTD., Otsu-shi, Shiga (JP)

(72) Inventors: Yuki YOKOTA, Otsu-shi (JP); Yusuke OKADA, Otsu-shi (JP); Takahiro TAKAHASHI, Otsu-shi (JP)

(21) Appl. No.: 18/024,158

(22) PCT Filed: Sep. 6, 2021
(86) PCT No.: PCT/JP2021/032579

§ 371 Date: Jun. 6, 2023

(30) Foreign Application Priority Data
Sep. 11, 2020 (JP) 2020-153032

(51) Int. Cl. C03C 10/00

(52) U.S. Cl. CPC C03C 10/0009; C03C 10/0054; C03C 2204/00

(57) ABSTRACT

To provide a Li₂O—Al₂O₃—SiO₂-based crystallized glass in which yellow coloration caused by TiO₂, Fe₂O₃, and the like is suppressed and yet transparency is ensured. The Li₂O—Al₂O₃—SiO₂-based crystallized glass is characterized by containing, in mass %, less than 0.5% of TiO₂ and having a β-OH value from 0.001 to 2/mm.

### TECHNICAL FIELD

The present invention relates to a Li₂O—Al₂O₃—SiO₂-based crystallized glass. In particular, the present invention relates to a Li₂O—Al₂O₃—SiO₂-based crystallized glass, for example, suitable as a material for a front window of a kerosine stove, a wood stove, and the like, substrate for a high-tech product such as a color filter and an image sensor substrate, a setter for firing an electronic part, a light diffusion plate, a furnace tube for semiconductor manufacture, a mask for semiconductor manufacture, an optical lens, a member for dimension measurement, a member for communications, a member for construction, a chemical reaction vessel, an electromagnetic cooking top plate, a heat-resistant tableware, a heat-resistant cover, a window glass for a fire door, an astronomical telescope member, a space optical member, and the like.

### BACKGROUND ART

Typically, a Li₂O—Al₂O₃—SiO₂-based crystallized glass is used as a material for a front window of a kerosine stove, a wood stove, and the like, a substrate for a high-tech product such as a color filter and an image sensor substrate, a setter for firing an electronic part, a light diffusion plate, a furnace tube for semiconductor manufacture, a mask for semiconductor manufacture, an optical lens, a member for dimension measurement, a member for communications, a member for construction, a chemical reaction vessel, an electromagnetic cooking top plate, a heat-resistant tableware, a heat-resistant cover, a window glass for a fire door, an astronomical telescope member, a space optical member, and the like. For example, Patent Literatures 1 to 3 disclose a Li₂O—Al₂O₃—SiO₂-based crystallized glass in which a Li₂O—Al₂O₃—SiO₂-based crystal such as a β-quartz solid solution (Li₂O·Al₂O₃·nSiO₂ (2≤n≤4)) and a β-spodumene solid solution (Li₂O·Al₂O₃·nSiO₂ (n≥4)) are precipitated as a main crystal.

The Li₂O—Al₂O₃—SiO₂-based crystallized glass has a low thermal expansion coefficient and a high mechanical strength, and thus has excellent thermal properties. When a heat treatment condition in crystallization step is appropriately adjusted, it is possible to control a type of precipitated crystals, and thus, it is possible to easily produce transparent crystallized glass (in which β-quartz solid solution is precipitated).

However, melting process at a high temperature above 1400° C. is required to produce such a type of crystallized glass. Therefore, in a fining agent added to a glass batch, As₂O₃ and Sb₂O₃ which generate a large amount of fining gas when melted at high temperatures are used. However, As₂O₃ and Sb₂O₃ are highly toxic, and may pollute the environment during various processing such as glass manufacturing processing and treatment of waste glass.

Thus, as an alternative fining agent to As₂O₃ and Sb₂O₃, SnO₂ and Cl are proposed (see, for example, Patent Literatures 4 and 5). However, Cl may easily corrode a metal mold or a metal roll during formation of glass, and as a result, may possibly deteriorate a surface quality of the glass.

### CITATION LIST

### Patent Literature

Patent Literature 1: JP 39-21049 B

Patent Literature 2: JP 40-20182 B

Patent Literature 3: JP 01-308845 A

Patent Literature 4: JP 11-228180 A

Patent Literature 5: JP 11-228181 A

### SUMMARY OF INVENTION

### Technical Problem

Further, a Li₂O—Al₂O₃—SiO₂-based crystallized glass has a yellowish appearance caused by TiO₂, Fe₂O₃, and the like, and such coloration is undesirable. To improve the yellow coloration of transparent crystallized glass, a content of TiO₂ may preferably be reduced, but when the content of TiO₂ is reduced, a crystal nucleus formation rate in crystallization step is decreased, and thus, an amount of crystal nuclei to be generated tends to decrease. As a result, the amount of coarse crystals increases, making the crystallized glass cloudy and easily impairing transparency of such glass.

An object of the present invention is to provide a Li₂O—Al₂O₃—SiO₂-based crystallized glass in which yellow coloration caused by TiO₂, Fe₂O₃, and the like is suppressed and yet transparency is ensured.

### Solution to Problem

The present inventors and others discovered that shortage of crystal nuclei due to reduction of the content of TiO₂ could be compensated by increasing the water content.

A Li₂O—Al₂O₃—SiO₂-based crystallized glass of the present invention is characterized by containing, in mass %, 0 to less than 0.5% of TiO₂, and having a β-OH value from 0.001 to 2/mm. Even if the content of TiO₂ is reduced to less than 0.5% to improve yellow coloration, when the β-OH value is increased to 0.001/mm or greater, it is possible to sufficiently crystallize the glass. The “β-OH value” refers to a value obtained by substituting a transmittance of glass measured by using FT-IR, in the following formula.

β-OH value=(1/X)log(T₁/T₂)
X: Glass thickness (mm)
T₁: Transmittance (%) at a reference wavelength of 3846 cm⁻¹
T₂: Minimum transmittance (%) near an absorption wavelength of hydroxyl groups of 3600 cm⁻¹

Further, the Li₂O—Al₂O₃—SiO₂-based crystallized glass of the present invention preferably contains, in mass %, from 40 to 90% of SiO₂, from 5 to 30% of Al₂O₃, from 1 to 10% of Li₂O, from 0 to 20% of SnO₂, from 1 to 20% of ZrO₂, from 0 to 10% of MgO, from 0 to 10% of P₂O₅, and from 0 to less than 2% of Sb₂O₃+As₂O₃.

Even if the total amount of Sb₂O₃ and As₂O₃ as a fining agent is reduced to less than 2%, as described above, when the β-OH value is set to less than 2/mm, it is possible to sufficiently clarify the glass. Note that “Sb₂O₃+As₂O₃” means the total amount of Sb₂O₃ and As₂O₃.

Further, the Li₂O—Al₂O₃—SiO₂-based crystallized glass of the present invention preferably contains, in mass %, from 0 to 10% of Na₂O, from 0 to 10% of K₂O, from 0 to 10% of CaO, from 0 to 10% of SrO, from 0 to 10% of BaO, from 0 to 10% of ZnO, and from 0 to 10% of B₂O₃.

Further, the Li₂O—Al₂O₃—SiO₂-based crystallized glass of the present invention preferably contains, in mass %, 0.1% or less of Fe₂O₃.

In the Li₂O—Al₂O₃—SiO₂-based crystallized glass of the present invention, a mass ratio of SnO₂/(SnO₂+ZrO₂+P₂O₅+TiO₂+B₂O₃) is preferably 0.06 or greater. Here, “SnO₂/(SnO₂+ZrO₂+P₂O₅+TiO₂+B₂O₃)” is a value obtained by dividing the content of SnO₂ by the total amount of SnO₂, ZrO₂, P₂O₅, TiO₂, and B₂O₃.

In the Li₂O—Al₂O₃—SiO₂-based crystallized glass of the present invention, a mass ratio of Al₂O₃/(SnO₂+ZrO₂) is preferably 7.1 or less. Here, “Al₂O₃/(SnO₂+ZrO₂)” means a value obtained by dividing the content of Al₂O₃ by the total amount of SnO₂ and ZrO₂.

In the Li₂O—Al₂O₃—SiO₂-based crystallized glass of the present invention, a mass ratio of SnO₂/(SnO₂+ZrO₂) is preferably from 0.01 to 0.99. Here, “SnO₂/(SnO₂+ZrO₂)” is a value obtained by dividing the content of SnO₂ by the total amount of SnO₂ and ZrO₂.

The Li₂O—Al₂O₃—SiO₂-based crystallized glass of the present invention preferably contains, in mass %, 8% or less of Na₂O+K₂O+CaO+SrO+BaO. Here, “Na₂O+K₂O+CaO+SrO+BaO” is the total amount of Na₂O, K₂O, CaO, SrO, and BaO.

In the Li₂O—Al₂O₃—SiO₂-based crystallized glass of the present invention, a mass ratio of (SiO₂+Al₂O₃)/Li₂O is preferably 20 or greater. Here, “(SiO₂+Al₂O₃)/Li₂O” is a value obtained by dividing the total amount of SiO₂ and Al₂O₃ by the content of Li₂O.

In the Li₂O—Al₂O₃—SiO₂-based crystallized glass of the present invention, a mass ratio of (SiO₂+Al₂O₃)/SnO₂ is preferably 44 or greater. Here, “(SiO₂+Al₂O₃)/SnO₂” is a value obtained by dividing the total amount of SiO₂ and Al₂O₃ by the content of SnO₂.

In the Li₂O—Al₂O₃—SiO₂-based crystallized glass of the present invention, a mass ratio of (MgO+ZnO)/Li₂O is preferably less than 0.395 or greater than 0.754. Here, “(MgO+ZnO)/Li₂O” is a value obtained by dividing the total amount of MgO and ZnO by the content of Li₂O.

In the Li₂O—Al₂O₃—SiO₂-based crystallized glass of the present invention, a mass ratio of (Li₂O+Na₂O+K₂O)/ZrO₂ is preferably 2.0 or less. Here, “(Li₂O+Na₂O+K₂O)/ZrO₂” is a value obtained by dividing the total amount of Li₂O, Na₂O, and K₂O by the content of ZrO₂.

In the Li₂O—Al₂O₃—SiO₂-based crystallized glass of the present invention, a mass ratio of TiO₂/ZrO₂ is preferably from 0.0001 to 5.0. Here, “TiO₂/ZrO₂” is a value obtained by dividing the content of TiO₂ by the content of ZrO₂.

In the Li₂O—Al₂O₃—SiO₂-based crystallized glass of the present invention, a mass ratio of TiO₂/TiO₂+Fe₂O₃ is preferably from 0.001 to 0.999. Here, “TiO₂/(TiO₂+Fe₂O₃)” is a value obtained by dividing the content of TiO₂ by the total amount of TiO₂ and Fe₂O₃.

The Li₂O—Al₂O₃—SiO₂-based crystallized glass of the present invention preferably contains, in mass %, less than 0.05% of HfO₂+Ta₂O₅. Here, “HfO₂+Ta₂O₅” is the total amount of HfO₂ and Ta₂O₅.

The Li₂O—Al₂O₃—SiO₂-based crystallized glass of the present invention preferably contains, in mass %, 7 ppm or less of Pt.

The Li₂O—Al₂O₃—SiO₂-based crystallized glass of the present invention preferably contains, in mass %, 7 ppm or less of Rh.

The Li₂O—Al₂O₃—SiO₂-based crystallized glass of the present invention preferably contains, in mass %, 9 ppm or less of Pt+Rh. Here, “Pt+Rh” is the total amount of Pt and Rh.

The Li₂O—Al₂O₃—SiO₂-based crystallized glass of the present invention preferably has a colorless and transparent appearance.

The Li₂O—Al₂O₃—SiO₂-based crystallized glass of the present invention preferably has a transmittance of 10% or greater at a thickness of 3 mm and a wavelength of 300 nm. In this case, the crystallized glass can be suitable for various uses that require permeability to ultraviolet light.

In the Li₂O—Al₂O₃—SiO₂-based crystallized glass of the present invention, a β-quartz solid solution is preferably precipitated as a main crystal. With such a configuration, it is possibly to easily obtain crystallized glass having a low thermal expansion coefficient.

In the Li₂O—Al₂O₃—SiO₂-based crystallized glass of the present invention, a thermal expansion coefficient at from 30 to 380° C. is preferably 30×10⁻⁷/° C. or less. In this case, the crystallized glass can be suitable for various uses that require low expansion properties.

In the Li₂O—Al₂O₃—SiO₂-based crystallized glass of the present invention, a thermal expansion coefficient at from 30 to 750° C. is preferably 30×10⁻⁷/° C. or less. In this case, the crystallized glass can be suitable for various uses that require low expansion properties in a wide temperature range.

In the Li₂O—Al₂O₃—SiO₂-based crystallized glass of the present invention, a rate of transmittance change before and after crystallization at a thickness of 3 mm and a wavelength of 300 nm is preferably 50% or less. Here, the “rate of transmittance change before and after crystallization” means {(transmittance (%) before crystallization−transmittance (%) after crystallization)/transmittance (%) before crystallization}×100 (%).

In the Li₂O—Al₂O₃—SiO₂-based crystallized glass of the present invention, a mass ratio of Al₂O₃/(Li₂O+(½×(MgO+ZnO)) is preferably from 3.0 to 8.0. Here, “Al₂O₃/(Li₂O+(½×(MgO+ZnO))” is a value obtained by dividing the content of Al₂O₃ by a sum of the content of Li₂O and a value obtained by dividing the total amount of MgO and ZnO by 2.

A Li₂O—Al₂O₃—SiO₂-based crystallized glass of the present invention is characterized by containing, in mass %, greater than 0% of MoO₃, and having a β-OH value from 0.001 to 0.5/mm.

### Advantageous Effects of Invention

According to the present invention, it is possible to provide a Li₂O—Al₂O₃—SiO₂-based crystallized glass in which yellow coloration caused by TiO₂, Fe₂O₃, and the like is suppressed and yet transparency is ensured.

### BRIEF DESCRIPTION OF DRAWINGS

FIG. 1 is a transmittance curve before crystallization of Sample No. 27.

FIG. 2 is a transmittance curve after crystallization of Sample No. 27.

FIG. 3 is a graph showing a relationship between β-OH values and densities of Samples A to E.

FIG. 4 is a graph showing a relationship between β-OH values and densities of Samples F to J.

FIG. 5 is a graph showing a relationship between β-OH values and densities of Samples K to M.

### DESCRIPTION OF EMBODIMENTS

A Li₂O—Al₂O₃—SiO₂-based crystallized glass of the present invention is characterized by including, in mass %, less than 0.5% of TiO₂ and having a β-OH value from 0.001 to 2/mm.

Firstly, a glass composition of the Li₂O—Al₂O₃—SiO₂-based crystallized glass of the present invention will be described. Note that, in the description regarding the content of each component below, “%” means “mass %” unless otherwise indicated.

TiO₂ is a nucleating component for precipitating crystals in a crystallization step. On the other hand, if TiO₂ is contained in a large amount, the degree of coloration of the glass significantly increases. In particular, a zirconia titanate-based crystal containing ZrO₂ and TiO₂ acts as a crystal nucleus, and transition of electrons from a valence band of oxygen serving a ligand to a conduction band of zirconia and titanium, which is a central metal, (LMCT transition) occurs. LMCT transition is involved in the coloration of crystallized glass. If titanium remains in a residual glass phase, the LMCT transition may occur from the valence band of a SiO₂ skeleton to the conduction band of tetravalent titanium in the residual glass phase. In trivalent titanium in the residual glass phase, a d-d transition occurs, and this transition is involved in the coloration of crystallized glass. Furthermore, when titanium and iron coexist, an ilmenite (FeTiO₃)-like coloration develops. It is also known that when titanium and tin coexist, the degree of yellowish coloration increases. Thus, the content of TiO₂ is preferably from 0 to less than 0.5%, from 0 to 0.48%, from 0 to 0.46%, from 0 to 0.44%, from 0 to 0.42%, from 0 to 0.4%, from 0 to 0.38%, from 0 to 0.36%, from 0 to 0.34%, from 0 to 0.32%, from 0 to 0.3%, from 0 to 0.28%, from 0 to 0.26%, from 0 to 0.24%, from 0 to 0.22%, from 0 to 0.2%, from 0 to 0.18%, from 0 to 0.16%, from 0 to 0.14%, from 0 to 0.12%, and in particular, from 0 to 0.1%. However, TiO₂ is easily mixed as an impurity, and thus, when it is attempted to completely remove TiO₂, the production cost tends to increase due to increase in the cost of the raw material batch. In order to suppress the increase in production cost, a lower limit of the content of TiO₂ is preferably 0.0003% or greater, 0.0005% or greater, 0.001% or greater, 0.005% or greater, 0.01% or greater, and in particular, 0.02% or greater.

The Li₂O—Al₂O₃—SiO₂-based crystallized glass of the present invention may contain the following components in the glass composition in addition to the above components.

SiO₂ is a component that forms the skeleton of the glass and forms a Li₂O—Al₂O₃—SiO₂-based crystal. The content of SiO₂ is preferably from 40 to 90%, from 52 to 80%, from 55 to 75%, from 56 to 70%, from 59 to 70%, from 60 to 70%, from 60 to 69.5%, from 60.5 to 69.5%, from 61 to 69.5%, from 61.5 to 69.5%, from 62 to 69.5%, from 62.5 to 69.5%, from 63 to 69.5%, and in particular, from 63.5 to 69.5%. If the content of SiO₂ is excessively small, the thermal expansion coefficient tends to be high, and thus, it is difficult to produce crystallized glass having excellent thermal shock resistance. Further, the crystallized glass tends to have poor chemical durability. On the other hand, if the content of SiO₂ is excessively large, the meltability of the glass decreases and the viscosity of the glass melt increases. Thus, glass fining and glass forming becomes difficult, resulting in decrease in productivity. In addition, a time required for crystallization is increased, and the productivity easily decreases.

Al₂O₃ is a component that forms the skeleton of the glass and forms a Li₂O—Al₂O₃—SiO₂-based crystal. In addition, Al₂O₃ is a component that is located around a crystal nucleus and forms a core-shell structure. The presence of the core-shell structure makes it less likely to feed a crystal nucleus component from the outside of the shell, and thus, the crystal nuclei are less likely to be enlarged, and a large number of small crystal nuclei are easily formed. The content of Al₂O₃ is preferably from 5 to 30%, from 8 to 30%, from 9 to 28%, from 10 to 27%, from 12 to 27%, from 14 to 27%, from 16 to 27%, from 17 to 27%, from 18 to 27%, from 18 to 26.5%, from 18.1 to 26.5%, from 19 to 26.5%, from 19.5 to 26.5%, from 20 to 26.5%, from 20.5 to 26.5%, and in particular, from 20.8 to 25.8%. If the content of Al₂O₃ is excessively small, the thermal expansion coefficient tends to be high, and thus, it is difficult to produce crystallized glass having excellent thermal shock resistance. Further, the crystallized glass tends to have poor chemical durability. In addition, the crystal nuclei increase in size, and the crystallized glass is more likely to be cloudy. On the other hand, if the content of Al₂O₃ is excessively large, the meltability of the glass decreases and the viscosity of the glass melt increases. Thus, glass fining and glass forming becomes difficult, resulting in decrease in productivity. In addition, the crystal of mullite tends to be precipitated, causing devitrification of the glass. In such a case, the crystallized glass is easily breakable.

Li₂O is a component forming a Li₂O—Al₂O₃—SiO₂-based crystal, and a component having a large effect on crystallinity and reducing the viscosity of the glass to improve the meltability and the formability of glass. The content of Li₂O is preferably from 1 to 10%, from 2 to 10%, from 2 to 8%, from 2.5 to 6%, from 2.8 to 5.5%, from 2.8 to 5%, from 3 to 5%, from 3 to 4.5%, from 3 to 4.2%, and in particular, from 3.2 to 4%. If the content of Li₂O is excessively small, the crystal of mullite tends to be precipitated, causing devitrification of the glass. In addition, in crystallizing the glass, Li₂O—Al₂O₃—SiO₂-based crystal does not easily precipitate, and thus, it is difficult to obtain crystallized glass having excellent thermal shock resistance. Further, the meltability of the glass decreases and the viscosity of the glass melt increases. Thus, glass fining and glass forming becomes difficult, resulting in decrease in productivity. On the other hand, if the content of Li₂O is excessively large, crystallinity is excessively high, and thus, the glass tends to be subject to devitrification and crystallized glass becomes easily breakable.

SiO₂, Al₂O₃, and Li₂O are main constituent components of β-quartz solid solution, which is the main crystal, and Li₂O and Al₂O₃ compensate the mutual charges to dissolve into the SiO₂ skeleton. With such three components being contained in a suitable ratio, crystallization progresses efficiently to enable low-cost production. The mass ratio of (SiO₂+Al₂O₃)/Li₂O is preferably 20 or greater, 20.2 or greater, 20.4 or greater, 20.6 or greater, 20.8 or greater, and in particular, 21 or greater.

SnO₂ is a component that acts as a fining agent. In addition, SnO₂ is also a component necessary to efficiently precipitate crystals in a crystallization step. On the other hand, if SnO₂ is contained in large amounts, the degree of coloration of the glass significantly increases. The content of SnO₂ is preferably from 0 to 20%, from greater than 0 to 20%, from 0.05 to 20%, from 0.1 to 10%, from 0.1 to 5%, from 0.1 to 4%, from 0.1 to 3%, from 0.15 to 3%, from 0.2 to 3%, from 0.2 to 2.7%, from 0.2 to 2.4%, from 0.25 to 2.4%, from 0.3 to 2.4%, from 0.35 to 2.4%, from 0.4 to 2.4%, from 0.45 to 2.4%, from 0.5 to 2.4%, from 0.5 to 2.35%, from 0.5 to 2.3%, from 0.5 to 2.2%, from 0.5 to 2.1%, from 0.5 to 2.05%, from 0.5 to 2%, from 0.5 to 1.95%, from 0.5 to 1.93%, from 0.5 to 1.91%, from 0.5 to 1.9%, from 0.5 to 1.88%, from 0.5 to 1.85%, from 0.5 to 1.83%, from 0.5 to 1.81%, and in particular, from 0.5 to 1.8%. If the content of SnO₂ is excessively small, it is difficult to clarify the glass, and the productivity tends to decrease. Further, the crystal nuclei are not sufficiently formed, and coarse crystals may precipitate out, and the glass may possibly be cloudy or damaged. On the other hand, if the content of SnO₂ is excessively large, the coloration of the crystallized glass may be strong. In addition, the amount of SnO₂ to be evaporated at melting tends to increase, and thus environmental burden tends to increase.

ZrO₂ is a nucleating component for precipitating crystals in the crystallization step. The content of ZrO₂ is preferably from 1 to 20%, from 1 to 15%, from 1 to 10%, from 1 to 5%, from 1.5 to 5%, from 1.75 to 4.5%, from 1.75 to 4.4%, from 1.75 to 4.3%, from 1.75 to 4.2%, from 1.75 to 4.1%, from 1.75 to 4%, from 1.8 to 4%, from 1.85 to 4%, from 1.9 to 4%, from 1.95 to 4%, from 2 to 4%, from 2.05 to 4%, from 2.1 to 4%, from 2.15 to 4%, from 2.2 to 4%, from 2.25 to 4%, from 2.3 to 4%, from 2.3 to 3.95%, from 2.3 to 3.9%, from 2.3 to 3.95%, from 2.3 to 3.9%, from 2.3 to 3.85%, from 2.3 to 3.8%, from greater than 2.7 to 3.8%, from 2.8 to 3.8%, from 2.9 to 3.8%, and in particular, from 3 to 3.8%. If the content of ZrO₂ is excessively small, the crystal nuclei are not sufficiently formed, and coarse crystals may precipitate out, and the crystallized glass may possibly be cloudy or damaged. On the other hand, if the content of ZrO₂ is excessively large, coarse ZrO₂ crystals precipitate and the glass is easily subject to devitrification, and the crystallized glass becomes easily breakable.

TiO₂ and ZrO₂ are components that may function as a crystal nucleus. Ti and Zr are congeners, and are similar in electrical electronegativity, ion radii, and the like. Thus, it is known that both components easily adopt a similar molecular conformation as an oxide, and in the coexistence of TiO₂ and ZrO₂, phase separation in the early stage of crystallization tends to occur. Thus, as long as an unacceptable level of coloration does not occur, the mass ratio of TiO₂/ZrO₂ is preferably from 0.0001 to 5.0, from 0.0001 to 4.0, from 0.0001 to 3.0, from 0.0001 to 2.5, from 0.0001 to 2.0, from 0.0001 to 1.5, from 0.0001 to 1.0, from 0.0001 to 0.5, from 0.0001 to 0.4, and in particular, from 0.0001 to 0.3. If TiO₂/ZrO₂ is excessively small, the production cost tends to increase due to increase in the cost of the raw material batch. On the other hand, if TiO₂/ZrO₂ is excessively large, crystal nucleation rate is decreased, and production costs may increase.

SnO₂+ZrO₂ is preferably from 1 to 30%, from 1.1 to 30%, from 1.1 to 27%, from 1.1 to 24%, from 1.1 to 21%, from 1.1 to 20%, from 1.1 to 17%, from 1.1 to 14%, from 1.1 to 11%, from 1.1 to 9%, from 1.1 to 7.5%, from 1.4 to 7.5%, from 1.8 to 7.5%, from 2.0 to 7.5%, from 2.2 to 7%, from 2.2 to 6.4%, from 2.2 to 6.2%, from 2.2 to 6%, from 2.3 to 6%, from 2.4 to 6%, from 2.5 to 6%, and in particular, from 2.8 to 6%. If SnO₂+ZrO₂ is excessively small, crystal nuclei are less likely to precipitate, and less likely to crystallize. On the other hand, if SnO₂+ZrO₂ is excessively large, the crystal nuclei increase in size, and the crystallized glass is more likely to be cloudy.

SnO₂ has an effect of promoting phase separation in the glass. To efficiently cause separation of phases while maintaining a liquidus temperature low (while suppressing the risk of devitrification due to primary phase precipitation) to promptly perform nucleation and crystal growth in later steps, the mass ratio of SnO₂/(SnO₂+ZrO₂) is preferably from 0.01 to 0.99, from 0.01 to 0.98, from 0.01 to 0.94, from 0.01 to 0.90, from 0.01 to 0.86, from 0.01 to 0.82, from 0.01 to 0.78, from 0.01 to 0.74, from 0.01 to 0.70, from 0.03 to 0.70, and in particular, from 0.05 to 0.70.

In addition, when SnO₂ is under a high temperature condition, a reaction of SnO₂→SnO+½O₂ occurs, and O₂ gas is released into the glass melt. Such a reaction is known as a fining mechanism by SnO₂, and the O₂ gas released during the reaction has a “defoaming effect” in which the fine bubbles existing in the glass melt are enlarged and the bubbles are released outside the glass system, and in addition, a “stirring effect” in which the glass melt is mixed. In the Li₂O—Al₂O₃—SiO₂-based crystallized glass of the present invention, the contents of SiO₂ and Al₂O₃ accounts for the majority and these components are poorly soluble, and thus, in order to efficiently form a homogeneous glass melt, these three components should be contained in suitable proportions. The mass ratio of (SiO₂+Al₂O₃)/SnO₂ is preferably 44 or greater, 44.3 or greater, 44.7 or greater, 45 or greater, 45.2 or greater, 45.4 or greater, 45.6 or greater, 45.8 or greater, and in particular, 46 or greater.

The mass ratio of Al₂O₃/(SnO₂+ZrO₂) is preferably 7.1 or less, 7.05 or less, 7.0 or less, 6.95 or less, 66.9 or less, 6.85 or less, 6.8 or less, 6.75 or less, 6.7 or less, 6.65 or less, 6.6 or less, 6.55 or less, 6.5 or less, 6.45 or less, 6.4 or less, 6.35 or less, 6.3 or less, 6.25 or less, 6.2 or less, 6.15 or less, 6.1 or less, 6.05 or less, 6.0 or less, 5.98 or less, 5.95 or less, 5.92 or less, 5.9 or less, 5.8 or less, 5.7 or less, 5.6 or less, and in particular, 5.5 or less. If Al₂O₃/(SnO₂+ZrO₂) is excessively high, nucleation does not proceed efficiently, which makes it difficult to achieve efficient crystallization. On the other hand, if Al₂O₃/(SnO₂+ZrO₂) is excessively small, the crystal nuclei increase in size, and the crystallized glass is more likely to be cloudy. Thus, the lower limit of Al₂O₃/(SnO₂+ZrO₂) is preferably 0.01 or greater.

MgO is a component that can be incorporated into Li₂O—Al₂O₃—SiO₂-based crystal to form a solid solution together to increase the thermal expansion coefficient of a Li₂O—Al₂O₃—SiO₂-based crystal. The content of MgO is preferably from 0 to 10%, from 0 to 8%, from 0 to 6%, from 0 to 5%, from 0 to 4.5%, from 0 to 4%, from 0 to 3.5%, from 0.02 to 3.5%, from 0.05 to 3.5%, from 0.08 to 3.5%, from 0.1 to 3.5%, from 0.1 to 3.3%, from 0.1 to 3%, from 0.13 to 3%, from 0.15 to 3%, from 0.17 to 3%, from 0.19 to 3%, from 0.2 to 2.9%, from 0.2 to 2.7%, from 0.2 to 2.5%, from 0.2 to 2.3%, from 0.2 to 2.2%, from 0.2 to 2.1%, and in particular, from 0.2 to 2%. If the content of MgO is excessively small, the thermal expansion coefficient tends to be excessively small. In addition, the amount of volume shrinkage that occurs in the crystal precipitation may be excessively large. In addition, a difference in thermal expansion coefficient between a crystal phase and a residual glass phase after crystallization becomes large, and thus, crystallized glass may become easily breakable. If the content of MgO is excessively large, crystallinity is excessively strong and the crystallized glass is easily subject to devitrification and becomes easily breakable. The thermal expansion coefficient tends to be excessively high.

P₂O₅ is a component that suppresses the precipitation of coarse ZrO₂ crystals. The content of P₂O₅ is preferably from 0 to 10%, from 0 to 8%, from 0 to 6%, from 0 to 5%, from 0 to 4%, from 0 to 3.5%, from 0.02 to 3.5%, from 0.05 to 3.5%, from 0.08 to 3.5%, from 0.1 to 3.5%, from 0.1 to 3.3%, from 0.1 to 3%, from 0.13 to 3%, from 0.15 to 3%, from 0.17 to 3%, from 0.19 to 3%, from 0.2 to 2.9%, from 0.2 to 2.7%, from 0.2 to 2.5%, from 0.2 to 2.3%, from 0.2 to 2.2%, from 0.2 to 2.1%, from 0.2 to 2%, and in particular, from 0.3 to 1.8%. If the content of P₂O₅ is excessively small, coarse ZrO₂ crystals precipitate and the glass is easily subject to devitrification, and thus, the crystallized glass may become easily breakable. On the other hand, if the content of P₂O₅ is excessively large, the amount of Li₂O—Al₂O₃—SiO₂-based crystals to precipitate decreases and the thermal expansion coefficient tends to be high.

Na₂O is a component that can be incorporated into a Li₂O—Al₂O₃—SiO₂-based crystal to form a solid solution together, and is a component that has a significant effect on crystallinity and reduces the viscosity of the glass to improve glass meltability and formability. Na₂O is used also for adjusting the thermal expansion coefficient and the refractive index of the crystallized glass. The content of Na₂O is preferably from 0 to 10%, from 0 to 8%, from 0 to 6%, from 0 to 5%, from 0 to 4.5%, from 0 to 4%, from 0 to 3.5%, from 0 to 3%, from 0 to 2.7%, from 0 to 2.4%, from 0 to 2.1%, from 0 to 1.8%, and in particular, from 0 to 1.5%. If the content of Na₂O is excessively large, crystallinity is excessively strong and the glass is easily subject to devitrification and the crystallized glass becomes easily breakable. An ionic radius of a Na cation is larger than a Li cation, a Mg cation, and the like, which are the constituent components of the main crystal, and the Na cation is not easily incorporated into the crystal, and thus, the Na cation after crystallization is likely to remain in the residual glass (glass matrix). Therefore, if the content of Na₂O is excessively large, a refractive index difference between the crystal phase and the residual glass is likely to occur, and the crystallized glass tends to be cloudy. However, Na₂O is easily mixed as an impurity, and thus, when it is attempted to completely remove Na₂O, the production cost tends to increase due to increase in the cost of the raw material batch. In order to suppress the increase in production cost, the lower limit of the content of Na₂O is preferably 0.0003% or greater, 0.0005% or greater, and in particular, 0.001% or greater.

K₂O is a component that can be incorporated into a Li₂O—Al₂O₃—SiO₂-based crystal to form a solid solution together, and is a component that has a significant effect on crystallinity and reduces the viscosity of the glass to improve glass meltability and formability. K₂O is used also for adjusting the thermal expansion coefficient and the refractive index of the crystallized glass. The content of K₂O is preferably from 0 to 10%, from 0 to 8%, from 0 to 6%, from 0 to 5%, from 0 to 4.5%, from 0 to 4%, from 0 to 3.5%, from 0 to 3%, from 0 to 2.7%, from 0 to 2.4%, from 0 to 2.1%, from 0 to 1.8%, from 0 to 1.5%, from 0 to 1.4%, from 0 to 1.3%, from 0 to 1.2%, from 0 to 1.1%, from 0 to 1%, from 0 to 0.9%, and in particular, from 0.1 to 0.8%. If the content of K₂O is excessively large, crystallinity is excessively strong and the glass is easily subject to devitrification and the crystallized glass becomes easily breakable. An ionic radius of a K cation is larger than a Li cation, a Mg cation, and the like, which are the constituent components of the main crystal, and the K cation is not easily incorporated into the crystal, and thus, the K cation after crystallization is likely to remain in the residual glass. Therefore, if the content of K₂O is excessively large, a refractive index difference between the crystal phase and the residual glass is likely to occur, and the crystallized glass tends to be cloudy. However, K₂O is easily mixed as an impurity, and thus, when it is attempted to completely remove K₂O, the production cost tends to increase due to increase in the cost of the raw material batch. In order to suppress the increase in production cost, the lower limit of the content of K₂O is preferably 0.0003% or greater, 0.0005% or greater, and in particular, 0.001% or greater.

Li₂O, Na₂O, and K₂O are components that improve the meltability and the formability of the glass, but if the content of these components is excessively large, the low temperature viscosity excessively decreases, which may result in too high fluidity of the glass during crystallization. Li₂O, Na₂O, and K₂O are components that may deteriorate the weather resistance, the water resistance, the chemical resistance, and the like of the glass before crystallization. If the glass before crystallization is degraded by moisture or the like, desired crystallization behavior, by extension, desired characteristics, may not be possibly obtained. On the other hand, ZrO₂ is a component that functions as a nucleating agent, and has an effect of preferential crystallization at the initial stage of crystallization to suppress the flow of residual glass. ZrO₂ has an effect of efficiently filling a void part of a glass network mainly composed of a SiO₂ skeleton and inhibiting a diffusion of protons and various chemical components in the glass network, and improves weather resistance, water resistance, chemical resistance, and the like of glass before crystallization. To obtain crystallized glass having a desired shape and properties, (Li₂O+Na₂O+K₂O)/ZrO₂ should be controlled in a suitable manner The mass ratio of (Li₂O+Na₂O+K₂O)/ZrO₂ is preferably 2.0 or less, 1.98 or less, 1.96 or less, 1.94 or less, 1.92 or less, and in particular, 1.90 or less.

CaO is a component that reduces the viscosity of the glass and enhances the meltability and formability of the glass. CaO is used also for adjusting the thermal expansion coefficient and the refractive index of the crystallized glass. The content of CaO is preferably from 0 to 10%, from 0 to 8%, from 0 to 6%, from 0 to 5%, from 0 to 4.5%, from 0 to 4%, from 0 to 3.5%, from 0 to 3%, from 0 to 2.7%, from 0 to 2.4%, from 0 to 2.1%, from 0 to 1.8%, and in particular, from 0 to 1.5%. If the content of CaO is excessively large, the glass is easily subject to devitrification, and thus, the crystallized glass becomes easily breakable. An ionic radius of a Ca cation is larger than a Li cation, a Mg cation, and the like, which are the constituent components of the main crystal, and the Ca cation is not easily incorporated into the crystal, and thus, the Ca cation after crystallization is likely to remain in the residual glass. Therefore, if the content of CaO is excessively large, a refractive index difference between the crystal phase and the residual glass is likely to occur, and the crystallized glass tends to be cloudy. However, CaO is easily mixed as an impurity, and thus, when it is attempted to completely remove CaO, the production cost tends to increase due to increase in the cost of the raw material batch. In order to suppress the increase in production cost, the lower limit of the content of CaO is preferably 0.0001% or greater, 0.0003% or greater, and in particular, 0.0005% or greater.

SrO is a component that reduces the viscosity of the glass and enhances the meltability and formability of the glass. SrO is used also for adjusting the thermal expansion coefficient and the refractive index of the crystallized glass. The content of SrO is preferably from 0 to 10%, from 0 to 8%, from 0 to 6%, from 0 to 5%, from 0 to 4.5%, from 0 to 4%, from 0 to 3.5%, from 0 to 3%, from 0 to 2.7%, from 0 to 2.4%, from 0 to 2.1%, from 0 to 1.8%, from 0 to 1.5%, and in particular, from 0 to 1%. If the content of SrO is excessively large, the glass is easily subject to devitrification, and thus, the crystallized glass becomes easily breakable. An ionic radius of a Sr cation is larger than a Li cation, a Mg cation, and the like, which are the constituent components of the main crystal, and the Sr cation is not easily incorporated into the crystal, and thus, the Sr cation after crystallization is likely to remain in the residual glass. Therefore, if the content of SrO is excessively large, a refractive index difference between the crystal phase and the residual glass is likely to occur, and the crystallized glass tends to be cloudy. However, SrO is easily mixed as an impurity, and thus, when it is attempted to completely remove SrO, the production cost tends to increase due to increase in the cost of the raw material batch. In order to suppress the increase in production cost, the lower limit of the content of SrO is preferably 0.0001% or greater, 0.0003% or greater, and in particular, 0.0005% or greater.

BaO is a component that reduces the viscosity of the glass and enhances the meltability and formability of the glass. BaO is used also for adjusting the thermal expansion coefficient and the refractive index of the crystallized glass. The content of BaO is preferably from 0 to 10%, from 0 to 8%, from 0 to 6%, from 0 to 5%, from 0 to 4.5%, from 0 to 4%, from 0 to 3.5%, from 0 to 3%, from 0 to 2.7%, from 0 to 2.4%, from 0 to 2.1%, from 0 to 1.8%, from 0 to 1.5%, and in particular, from 0 to 1%. If the content of BaO is excessively large, crystals containing Ba precipitate, and the glass is easily subject to devitrification, and the crystallized glass becomes easily breakable. An ionic radius of a Ba cation is larger than a Li cation, a Mg cation, and the like, which are the constituent components of the main crystal, and the Ba cation is not easily incorporated into the crystal, and thus, the Ba cation after crystallization is likely to remain in the residual glass. Therefore, if the content of BaO is excessively large, a refractive index difference between the crystal phase and the residual glass is likely to occur, and the crystallized glass tends to be cloudy. However, BaO is easily mixed as an impurity, and thus, when it is attempted to completely remove BaO, the production cost tends to increase due to increase in the cost of the raw material batch. In order to suppress the increase in production cost, the lower limit of the content of BaO is preferably 0.0001% or greater, 0.0003% or greater, and in particular, 0.0005% or greater.

MgO, CaO, SrO, and BaO are components that improve the meltability and the formability of the glass, but if the content of these components is excessively high, the low temperature viscosity excessively decreases, which may result in too high fluidity of the glass during crystallization. On the other hand, ZrO₂ is a component that functions as a nucleating agent, and has an effect of preferential crystallization at the initial stage of crystallization to suppress the flow of residual glass. To obtain crystallized glass having a desired shape and properties, (MgO+CaO+SrO+BaO)/ZrO₂ should be controlled in a suitable manner The mass ratio of (MgO+CaO+SrO+BaO)/ZrO₂ is preferably from 0 to 3, from 0 to 2.8, from 0 to 2.6, from 0 to 2.4, from 0 to 2.2, from 0 to 2.1, from 0 to 2, from 0 to 1.8, from 0 to 1.7, from 0 to 1.6, and in particular, from 0 to 1.5.

Na₂O, K₂O, CaO, SrO, and BaO are likely to remain in the residual glass after crystallization. Therefore, if the total amount of these components are excessively large, a refractive index difference between the crystal phase and the residual glass is likely to occur, and the crystallized glass is likely to be cloudy. Therefore, the content of Na₂O+K₂O+CaO+SrO+BaO is preferably 8% or less, 7% or less, 6% or less, 5% or less, 4.5% or less, 4% or less, 3.5% or less, 3% or less, 2.7% or less, 2.42% or less, 2.415% or less, 2.410% or less, 2.405% or less, and in particular, 2.4% or less.

Li₂O, Na₂O, K₂O, MgO, CaO, SrO, and BaO are components that improve the meltability and the formability of the glass. A glass melt containing a large amount of MgO, CaO, SrO, and BaO tends to exhibit a gradual change in viscosity (viscosity curve) versus the temperature, and a glass melt containing a large amount of Li₂O, Na₂O, and K₂O tends to exhibit a steep change. If the change in the viscosity curve is excessively gradual, the glass still flows even after the glass is formed into a desired shape, and obtaining a desired shape is not easy. On the other hand, if the change in the viscosity curve is excessively steep, the glass melt solidifies during the formation, and obtaining a desired shape is not easy. Therefore, (MgO+CaO+SrO+BaO)/(Li₂O+Na₂O+K₂O) should be controlled in a suitable manner The mass ratio of (MgO+CaO+SrO+BaO)/(Li₂O+Na₂O+K₂O) is preferably from 0 to 2, from 0 to 1.8, from 0 to 1.5, from 0 to 1.2, from 0 to 1, from 0 to 0.9, from 0 to 0.8, from 0 to 0.7, from 0 to 0.6, from 0 to 0.5, and in particular, from 0 to 0.45.

ZnO is a component that can be incorporated into Li₂O—Al₂O₃—SiO₂-based crystal to form a solid solution together and applies a great effect on the crystallinity. ZnO is used also for adjusting the thermal expansion coefficient and the refractive index of the crystallized glass. The content of ZnO is preferably from 0 to 10%, from 0 to 8%, from 0 to 6%, from 0 to 5%, from 0 to 4.5%, from 0 to 4%, from 0 to 3.5%, from 0 to 3%, from 0 to 2.7%, from 0 to 2.4%, from 0 to 2.1%, from 0 to 1.8%, from 0 to 1.5%, and in particular, from 0 to 1%. If the content of ZnO is excessively large, crystallinity is excessively strong and the crystallized glass is more susceptible to devitrification and becomes easily breakable. However, ZnO is easily mixed as an impurity, and thus, when it is attempted to completely remove ZnO, the production cost tends to increase due to increase in the cost of the raw material batch. In order to suppress the increase in production cost, the lower limit of the content of ZnO is preferably 0.0001% or greater, 0.0003% or greater, and in particular, 0.0005% or greater.

In the Li₂O—Al₂O₃—SiO₂-based crystallized glass, a Li cation, a Mg cation, and a Zn cation are components that easily dissolve in a β-quartz solid solution, and these cations dissolve in the crystal while charge-compensating for the Al cation. Specifically, these cations may possibly dissolve in the form of Si⁴⁺⇔Al³⁺+(Li₂O, ½×Mg²⁺, ½×Zn²⁺), for example, and a ratio of the Al cation to the Li cation, the Mg cation, and the Zn cation affects the stability of the β-quartz solid solution. In the composition described in the present application, in order to stably obtain the crystallized glass which is brought closer to colorless and transparent and is brought closer to zero expansion, the mass ratio of Al₂O₃/(Li₂O+(½×(MgO+ZnO) is preferably from 3.0 to 8.0, from 3.2 to 7.8, from 3.4 to 7.6, from 3.5 to 7.5, from 3.7 to 7.5, from 4.0 to 7.5, from 4.3 to 7.5, from 4.5 to 7.5, from 4.8 to 7.5, from 5.0 to 7.5, from 5.5 to 7.3, from 5.5 to 7.1, from 5.5 to 7.0, from 5.5 to 6.8, from 5.5 to 6.7, from 5.5 to 6.6, and in particular, from 5.5 to 6.5.

Y₂O₃ is a component that reduces the viscosity of the glass and enhances the meltability and formability of the glass. Y₂O₃ is used also for improving the Young's modulus of the crystallized glass and adjusting the thermal expansion coefficient and the refractive index. The content of Y₂O₃ is preferably from 0 to 10%, from 0 to 8%, from 0 to 6%, from 0 to 5%, from 0 to 4.5%, from 0 to 4%, from 0 to 3.5%, from 0 to 3%, from 0 to 2.7%, from 0 to 2.4%, from 0 to 2.1%, from 0 to 1.8%, from 0 to 1.5%, and in particular, from 0 to 1%. If the content of Y₂O₃ is excessively large, crystals containing Y precipitate, and the glass is easily subject to devitrification, and the crystallized glass becomes easily breakable. An ionic radius of a Y cation is larger than a Li cation, a Mg cation, and the like, which are the constituent components of the main crystal, and the Y cation is not easily incorporated into the crystal, and thus, the Y cation after crystallization is likely to remain in the residual glass. Therefore, if the content of Y₂O₃ is excessively large, a refractive index difference between the crystal phase and the residual glass is likely to occur, and the crystallized glass tends to be cloudy. However, Y₂O₃ may be mixed as an impurity, and thus, when it is attempted to completely remove Y₂O₃, the production cost tends to increase due to increase in the cost of the raw material batch. In order to suppress the increase in production cost, the lower limit of the content of Y₂O₃ is preferably 0.0001% or greater, 0.0003% or greater, and in particular, 0.0005% or greater.

In the Li₂O—Al₂O₃—SiO₂-based crystallized glass, a Li cation, a Mg cation, and a Zn cation are components that easily dissolve in a β-quartz solid solution, and compared with the Ba cation and the like, components that may contribute slightly to an increase in refractive index of the residual glass after crystallization. Li₂O, MgO, and ZnO function as a flux when vitrifying the raw material, and thus, it can be said that these components are important for producing colorless and transparent crystallized glass at a low temperature. Li₂O is an essential component to achieve low expansion, and is preferably contained at least 1%. A sufficient amount of Li₂O should be contained in order to achieve a desired thermal expansion coefficient and the like. However, in such a case, if the contents of MgO and ZnO are also increased correspondingly, the viscosity of the glass may decrease excessively. If the low temperature viscosity is excessively low, during firing, the fluidity of the softened glass is excessively large, and thus, crystallization into a desired shape may be difficult. If the high temperature viscosity is excessively low, the thermal load on the manufacturing equipment is reduced, but the speed of convection during heating increases, and this may result in a risk that refractories and the like are easily eroded physically. Therefore, it is preferable to control a content ratio of Li₂O, MgO, and ZnO, and in particular, it is preferable to control the total amount of MgO and ZnO relative to Li₂O that functions well as a flux. Therefore, the mass ratio of (MgO+ZnO)/Li₂O is preferably 0.394 or less, 0.393 or less, 0.392 or less, 0.391 or less, and in particular, 0.390 or less, and alternatively, 0.755 or greater, 0.756 or greater, 0.757 or greater, 0.758 or greater, and in particular, 0.759 or greater.

B₂O₃ is a component that reduces the viscosity of the glass and enhances the meltability and formability of the glass. B₂O₃ component may contribute to the likelihood of phase separation during crystal nucleus formation. The content of B₂O₃ is preferably from 0 to 10%, from 0 to 8%, from 0 to 6%, from 0 to 5%, from 0 to 4.5%, from 0 to 4%, from 0 to 3.5%, from 0 to 3%, from 0 to 2.7%, from 0 to 2.4%, from 0 to 2.1%, from 0 to 1.8%, and in particular, from 0 to 1.5%. If the content of B₂O₃ is excessively large, the amount of B₂O₃ that evaporates during melting increases, and an environmental burden increases. However, B₂O₃ is easily mixed as an impurity, and thus, when it is attempted to completely remove B₂O₃, the production cost tends to increase due to increase in the cost of the raw material batch. In order to suppress the increase in production cost, the crystallized glass may contain 0.0001% or greater, 0.0003% or greater, and in particular, 0.0005% or greater of B₂O₃.

It is known that in the Li₂O—Al₂O₃—SiO₂-based crystallized glass, phase separated regions are formed within the glass prior to crystal nucleation, and then crystal nuclei including TiO₂ and ZrO₂ are formed within the phase separated region. SnO₂, ZrO₂, P₂O₅, TiO₂, and B₂O₃ serve a vital role in the phase separation formation, and thus, the content of SnO₂+ZrO₂+P₂O₅+TiO₂+B₂O₃ is preferably from 1.5 to 30%, from 1.5 to 26%, from 1.5 to 22%, from 1.5 to 20%, from 1.5 to 18%, from 1.5 to 16%, from 1.5 to 15%, from 1.8 to 15%, from 2.1 to 15%, from 2.4 to 15%, from 2.5 to 15%, from 2.8 to 15%, from 2.8 to 13%, from 2.8 to 12%, from 2.8 to 11%, from 2.8 to 10%, from 3 to 9.5%, from 3 to 9.2%, and in particular, from 3 to 9%, and the mass ratio of SnO₂/(SnO₂+ZrO₂+P₂O₅+TiO₂+B₂O₃) is preferably 0.06 or greater, 0.07 or greater, 0.08 or greater, 0.09 or greater, 0.1 or greater, 0.103 or greater, 0.106 or greater, 0.11 or greater, 0.112 or greater, 0.115 or greater, 0.118 or greater, 0.121 or greater, 0.124 or greater, 0.127 or greater, 0.128 or greater, in particular, 0.13 or greater. If the content of P₂O₅+B₂O₃+SnO₂+TiO₂+ZrO₂ is excessively small, the phase separated region is not easily formed and crystallization is difficult. On the other hand, if the content of P₂O₅+B₂O₃+SnO₂+TiO₂ +ZrO₂ is excessively large, and/or if SnO₂/(SnO₂+ZrO₂+P₂O₅+TiO₂+B₂O₃) is excessively small, the phase separated region increases in size, which may make the crystallized glass cloudy. Note that the upper limit of SnO₂/(SnO₂+ZrO₂+P₂O₅+TiO₂+B₂O₃) is not particularly limited, but realistically, 0.9 or less is preferable.

Fe₂O₃ is a component that increases the degree of coloration of the glass, and in particular, due to the interaction with TiO₂ and SnO₂, remarkably strengthens the coloration. The content of Fe₂O₃ is preferably 0.10% or less, 0.08% or less, 0.06% or less, 0.05% or less, 0.04% or less, 0.035% or less, 0.03% or less, 0.02% or less, 0.015% or less, 0.013% or less, 0.012% or less, 0.011% or less, 0.01% or less, 0.009% or less, 0.008% or less, 0.007% or less, 0.006% or less, 0.005% or less, 0.004% or less, 0.003% or less, and in particular, 0.002% or less. However, Fe₂O₃ is easily mixed as an impurity, and thus, when it is attempted to completely remove Fe₂O₃, the production cost tends to increase due to increase in the cost of the raw material batch. In order to suppress the increase in production cost, the lower limit of the content of Fe₂O₃ is preferably 0.0001% or greater, 0.0002% or greater, 0.0003% or greater, 0.0005% or greater, and in particular, 0.001% or greater.

When titanium and iron coexist, an ilmenite (FeTiO₃)-like coloration may develop. Particularly, in the Li₂O—Al₂O₃—SiO₂-based crystallized glass, titanium and iron components that do not precipitate as crystal nuclei or main crystals may remain in the residual glass after crystallization, and the development of the coloration may be promoted. It is possible to reduce the amount of such components when the composition is designed, but TiO₂ and Fe₂O₃ are easily mixed as an impurity, and thus, when it is attempted to completely remove TiO₂ and Fe₂O₃, the production cost tends to increase due to increase in the cost of the raw material batch. Therefore, in order to suppress the increase in production cost, TiO₂ and Fe₂O₃ may be contained within the above-described range, and, in the perspective of further reducing costs, both components may be contained as long as an unacceptable level of coloration does not occur. In such a case, the mass ratio of TiO₂/(TiO₂+Fe₂O₃) is preferably from 0.001 to 0.999, from 0.003 to 0.997, from 0.005 to 0.995, from 0.007 to 0.993, from 0.009 to 0.991, from 0.01 to 0.99, from 0.1 to 0.9, from 0.15 to 0.85, from 0.2 to 0.8, from 0.25 to 0.25, from 0.3 to 0.7, from 0.35 to 0.65, and in particular, from 0.4 to 0.6. This makes it easy to achieve low-cost production of crystallized glass with high level of colorless transparency.

Pt is a component that may be mixed into glass as ions, colloid, or metal, and develop coloration such as yellow to brown. Such a tendency becomes prominent after crystallization. Further, after careful consideration, it was revealed that when Pt is mixed, nucleation and crystallization behavior of crystallized glass may be affected, and as a result the glass may be cloudy. Therefore, the content of the Pt is preferably 7 ppm or less, 6 ppm or less, 5 ppm or less, 4 ppm or less, 3 ppm or less, 2 ppm or less, 1.6 ppm or less, 1.4 ppm or less, 1.2 ppm or less, 1 ppm or less, 0.9 ppm or less, 0.8 ppm or less, 0.7 ppm or less, 0.6 ppm or less, 0.5 ppm or less, 0.45 ppm or less, 0.40 ppm or less, 0.35 ppm or less, and in particular, 0.30 ppm or less. It is preferable to avoid contamination of Pt where possible, but if general melting equipment is used, the use of a Pt material may be desired to obtain homogeneous glasses. Therefore, if it is attempted to completely remove Pt, the production cost tends to increase. As long as the coloration is not adversely affected, to suppress the increase in production cost, the lower limit of the content of Pt is preferably 0.0001 ppm or greater, 0.001 ppm or greater, 0.005 ppm or greater, 0.01 ppm or greater, 0.02 ppm or greater, 0.03 ppm or greater, 0.04 ppm or greater, 0.05 ppm or greater, 0.06 ppm or greater, and in particular, 0.07 ppm or greater. In a case where coloration is permitted, similarly to ZrO₂ and TiO₂, Pt may be used as a nucleating agent that promotes precipitation of main crystals. In that case, Pt alone may be a nucleating agent, or as a complex, Pt and other components may be a nucleating agent. In a case where Pt is a nucleating agent, any form (colloid, metal crystal, and the like) may be used.

Rh is a component that may be mixed into glass as ions, colloid, or metal, and similarly to Pt, develop coloration such as yellow to brown to possibly make crystallized glass cloudy. Therefore, the content of Rh is preferably 7 ppm or less, 6 ppm or less, 5 ppm or less, 4 ppm or less, 3 ppm or less, 2 ppm or less, 1.6 ppm or less, 1.4 ppm or less, 1.2 ppm or less, 1 ppm or less, 0.9 ppm or less, 0.8 ppm or less, 0.7 ppm or less, 0.6 ppm or less, 0.5 ppm or less, 0.45 ppm or less, 0.40 ppm or less, 0.35 ppm or less, and in particular, 0.30 ppm or less. It is preferable to avoid contamination of Rh where possible, but if general melting equipment is used, the use of a Rh material may be desired to obtain homogeneous glasses. Therefore, if it is attempted to completely remove Rh, the production cost tends to increase. As long as the coloration is not adversely affected, to suppress the increase in production cost, the lower limit of the content of Rh is preferably 0.0001 ppm or greater, 0.001 ppm or greater, 0.005 ppm or greater, 0.01 ppm or greater, 0.02 ppm or greater, 0.03 ppm or greater, 0.04 ppm or greater, 0.05 ppm or greater, 0.06 ppm or greater, and in particular, 0.07 ppm or greater. In a case where coloration is permitted, similarly to ZrO₂ and TiO₂, Rh may be used as a nucleating agent. In that case, Rh alone may be a nucleating agent, or as a complex, Rh and other components may be a nucleating agent. In a case where Pt is a nucleating agent that promotes precipitation of main crystals, any form (colloid, metal crystal, and the like) may be used.

The content of Pt+Rh is preferably 9 ppm or less, 8 ppm or less, 7 ppm or less, 6 ppm or less, 5 ppm or less, 4.75 ppm or less, 4.5 ppm or less, 4.25 ppm or less, 4 ppm or less, 3.75 ppm or less, 3.5 ppm or less, 3.25 ppm or less, 3 ppm or less, 2.75 ppm or less, 2.5 ppm or less, 2.25 ppm or less, 2 ppm or less, 1.75 ppm or less, 1.5 ppm or less, 1.25 ppm or less, 1 ppm or less, 0.95 ppm or less, 0.9 ppm or less, 0.85 ppm or less, 0.8 ppm or less, 0.75 ppm or less, 0.7 ppm or less, 0.65 ppm or less, 0.60 ppm or less, 0.55 ppm or less, 0.50 ppm or less, 0.45 ppm or less, 0.40 ppm or less, 0.35 ppm or less, and in particular, 0.30 ppm or less. It is preferable to avoid contamination of Pt and Rh where possible, but if general melting equipment is used, the use of a Pt material or Rh material may be desired to obtain homogeneous glasses. Therefore, if it is attempted to completely remove Pt and Rh, the production cost tends to increase. As long as the coloration is not adversely affected, to suppress the increase in production cost, the lower limit of Pt+Rh is preferably 0.0001 ppm or greater, 0.001 ppm or greater, 0.005 ppm or greater, 0.01 ppm or greater, 0.02 ppm or greater, 0.03 ppm or greater, 0.04 ppm or greater, 0.05 ppm or greater, 0.06 ppm or greater, and in particular, 0.07 ppm or greater.

Typically, in developing glass materials, glasses having different compositions are produced using various crucibles. Therefore, there is often platinum and rhodium evaporated from the crucible inside the electric furnace used for melting. It was confirmed that the Pt and Rh present in the electric furnace are mixed into the glass. The amount of Pt and Rh to be mixed can be controlled by selecting appropriate raw materials and crucible materials. In addition, the contents of Pt and Rh in the glass can also be controlled by attaching a quartz lid to the crucible, lowering the melting temperature, shortening the time required for melting, or the like.

MoO₃ is a component that may be mixed from raw materials, melting materials, and the like, and is a component that promotes crystallization. The content of MoO₃ is preferably from 0 to 10%, from 0 to 8%, from 0 to 6%, from 0 to 5%, from 0 to 4.5%, from 0 to 4%, from 0 to 3.5%, from 0 to 3%, from 0 to 2.7%, from 0 to 2.4%, from 0 to 2.1%, from 0 to 1.8%, from 0 to 1.5%, from 0 to 1%, from 0 to 0.5%, from 0 to 0.1%, from 0 to 0.05%, from 0 to 0.01%, in particular, from 0 to 0.005%. If the content of MoO₃ is excessively large, crystals containing Mo precipitate, and the glass is easily subject to devitrification, and the crystallized glass becomes easily breakable. An ionic radius of a Mo cation is larger than a Li cation, a Mg cation, and the like, which are the constituent components of the main crystal, and the Mo cation is not easily incorporated into the crystal, and thus, the Mo cation after crystallization is likely to remain in the residual glass. Therefore, if the content of MoO₃ is excessively large, a refractive index difference between the crystal phase and the residual glass is likely to occur, and the crystallized glass tends to be cloudy. If the content of MoO₃ is excessively large, the glass may be colored in yellow. However, MoO₃ may be mixed as an impurity, and thus, when it is attempted to completely remove MoO₃, the production cost tends to increase due to increase in the cost of the raw material batch. In order to suppress the increase in production cost, the lower limit of the content of MoO₃ is preferably greater than 0%, 0.0001% or greater, 0.0003% or greater, and in particular, 0.0005% or greater.

As₂O₃ and Sb₂O₃ are highly toxic, and may pollute the environment during glass manufacturing processing, disposal of waste glass, and the like. Thus, the content of Sb₂O₃+As₂O₃ is preferably 2% or less, 1% or less, 0.7% or less, less than 0.7%, 0.65% or less, 0.6% or less, 0.55% or less, 0.5% or less, 0.45% or less, 0.4% or less, 0.35% or less, 0.3% or less, 0.25% or less, 0.2% or less, 0.15% or less, 0.1% or less, 0.05% or less, and in particular, it is preferable that substantially no Sb₂O₃+As₂O₃ is contained (specifically, the content is preferably less than 0.01 mass %). Note that if As₂O₃ and Sb₂O₃ are contained, these components may be functioned as fining agents and nucleating agents.

In addition to the above components, as long as no adverse effect is applied on the coloration, the Li₂O—Al₂O₃—SiO₂-based crystallized glass of the present invention may contain minor components, such as H₂, CO₂, CO, H₂O, He, Ne, Ar, and N₂, each of which may be contained at up to 0.1%. An intentional addition of Ag, Au, Pd, Ir, V, Cr, Sc, Ce, Pr, Pm, Sm, Eu, Gd, Tb, Dy, Ho, Er, Tm, Yb, Lu, Ac, Th, Pa, U, and the like in the glass increases raw material costs, and tends to increase production costs. On the other hand, if a glass containing Ag, Au, and the like is subjected to light irradiation or heat treatment, aggregates of such components are formed, and crystallization may be promoted from such aggregates. If Pd and the like, which have various catalytic effects, are contained, it is possible to impart unique functions to the glass or the crystallized glass. In view of these circumstances, with an aim to promote crystallization or impart other functions, the crystallized glass may contain 1% or less, 0.5% or less, 0.3% or less, and 0.1% or less of each of the above components, and otherwise, it is preferable to contain 500 ppm or less, 300 ppm or less, 100 ppm or less, and in particular 10 ppm or less of each of the above components.

As long as no adverse effect is applied on the coloration, the Li₂O—Al₂O₃—SiO₂-based crystallized glass of the present invention may contain up to 10% of SO₃, MnO, Cl₂, La₂O₃, WO₃, HfO₂, Ta₂O₅, Nd₂O₃, Nb₂O₅, RfO₂, and the like, in total. However, raw material batches of these components are costly and use of such raw material batches tends to increase production costs, and thus, unless there are special circumstances, these components may not be added. In particular, HfO₂ has a high raw material cost and Ta₂O₅ may be a conflict mineral, and thus, the total amount of these components is preferably, in mass %, 5% or less, 4% or less, 3% or less, 2% or less, 1% or less, 0.5% or less, 0.4% or less, 0.3% or less, 0.2% or less, 0.1% or less, 0.05% or less, less than 0.05%, 0.049% or less, 0.048% or less, 0.047% or less, 0.046% or less, and in particular, 0.045% or less.

That is, a preferred composition range for implementing the Li₂O—Al₂O₃—SiO₂-based crystallized glass of the present invention is: SiO₂ from 50 to 75%, Al₂O₃ from 10 to 30%, Li₂O from 1 to 8%, SnO₂ from 0 to 5%, ZrO₂ from 1 to 5%, MgO from 0 to 10%, P₂O₅ from 0 to 5%, TiO₂ from 0 to less than 1.5%, (Li₂O+Na₂O+K₂O)/ZrO₂ from 0 to 1.5, TiO₂/(TiO₂+Fe₂O₃) from 0.01 to 0.99, (MgO+ZnO)/Li₂O from 0 to 0.8, and β-OH value from 0.001 to 2/mm; preferably, SiO₂ from 50 to 75%, Al₂O₃ from 10 to 30%, Li₂O from 1 to 8%, SnO₂ from greater than 0 to 5%, ZrO₂ from 1 to 5%, MgO from 0 to 10%, P₂O₅ from 0 to 5%, TiO₂ from 0 to less than 1.5%, (Li₂O+Na₂O+K₂O)/ZrO₂ from 0 to 1.5, TiO₂/(TiO₂+Fe₂O₃) from 0.01 to 0.99, (MgO+ZnO)/Li₂O from 0 to 0.8, (MgO+CaO+SrO+BaO)/(Li₂O+Na₂O+K₂O) from 0 to 0.5, and β-OH value from 0.001 to 2/mm; more preferably, SiO₂ from 50 to 75%, Al₂O₃ from 10 to 30%, Li₂O from 1 to 8%, SnO₂ from greater than 0 to 5%, ZrO₂ from 1 to 5%, MgO from 0 to 10%, P₂O₅ from 0 to 5%, TiO₂ from 0 to less than 1.5%, (Li₂O+Na₂O+K₂O)/ZrO₂ from 0 to 1.5, TiO₂/(TiO₂+Fe₂O₃) from 0.01 to 0.99, (MgO+ZnO)/Li₂O from 0 to 0.8, (MgO+CaO+SrO+BaO)/(Li₂O+Na₂O+K₂O) from 0 to 0.5, and (MgO+CaO+SrO+BaO)/ZrO₂ from 0 to 2, and β-OH value from 0.001 to 2/mm; further preferably, SiO₂ from 50 to 75%, Al₂O₃ from 10 to 30%, Li₂O from 1 to 8%, SnO₂ from greater than 0 to 5%, ZrO₂ from 1 to 5%, MgO from 0 to 10%, P₂O₅ from 0 to 5%, TiO₂ from 0 to less than 1.5%, (Li₂O+Na₂O+K₂O)/ZrO₂ from 0 to 1.5, TiO₂/(TiO₂+Fe₂O₃) from 0.01 to 0.99, (MgO+ZnO)/Li₂O from 0 to 0.8, (MgO+CaO+SrO+BaO)/(Li₂O+Na₂O+K₂O) from 0 to 0.5, and (MgO+CaO+SrO+BaO)/ZrO₂ from 0 to 2, SnO₂/(SnO₂+ZrO₂+P₂O₅+TiO₂+B₂O₃) from 0.06 to 0.9, and β-OH value from 0.001 to 2/mm; further preferably, SiO₂ from 50 to 75%, Al₂O₃ from 10 to 30%, Li₂O from 1 to 8%, SnO₂ from greater than 0 to 5%, ZrO₂ from 1 to 5%, MgO from 0 to 10%, P₂O₅ from 0 to 5%, TiO₂ from 0 to less than 1.5%, (Li₂O+Na₂O+K₂O)/ZrO₂ from 0 to 1.5, TiO₂/(TiO₂+Fe₂O₃) from 0.01 to 0.99, (MgO+ZnO)/Li₂O from 0 to 0.8, (MgO+CaO+SrO+BaO)/(Li₂O+Na₂O+K₂O) from 0 to 0.5, (MgO+CaO+SrO+BaO)/ZrO₂ from 0 to 2, SnO₂/(SnO₂+ZrO₂+P₂O₅+TiO₂+B₂O₃) from 0.06 to 0.9, Pt+Rh from 0 to 5 ppm, and β-OH value from 0.001 to 2/mm; further preferably, SiO₂ from 50 to 75%, Al₂O₃ from 10 to 30%, Li₂O from 1 to 8%, SnO₂ from greater than 0 to 5%, ZrO₂ from 1 to 5%, MgO from 0 to 10%, P₂O₅ from 0 to 5%, TiO₂ from 0 to less than 1.5%, (Li₂O+Na₂O+K₂O)/ZrO₂ from 0 to 1.5, TiO₂/(TiO₂+Fe₂O₃) from 0.01 to 0.99, (MgO+ZnO)/Li₂O from 0 to 0.394, (MgO+CaO+SrO+BaO)/(Li₂O+Na₂O+K₂O) from 0 to 0.5, (MgO+CaO+SrO+BaO)/ZrO₂ from 0 to 2, SnO₂/(SnO₂+ZrO₂+P₂O₅+TiO₂ +B₂O₃) from 0.06 to 0.9, Pt+Rh from 0 to 5 ppm, and β-OH value from 0.001 to 2/mm, further preferably, SiO₂ from 50 to 75%, Al₂O₃ from 10 to 30%, Li₂O from 1 to 8%, SnO₂ from greater than 0 to 5%, ZrO₂ from 1 to 5%, MgO from 0 to 10%, P₂O₅ from 0 to 5%, TiO₂ from 0 to less than 1.5%, (Li₂O+Na₂O+K₂O)/ZrO₂ from 0 to 1.5, TiO₂/(TiO₂+Fe₂O₃) from 0.01 to 0.99, (MgO+ZnO)/Li₂O from 0 to 0.394, (MgO+CaO+SrO+BaO)/(Li₂O+Na₂O+K₂O) from 0 to 0.5, (MgO+CaO+SrO+BaO)/ZrO₂ from 0 to 2, SnO₂/(SnO₂+ZrO₂+P₂O₅+TiO₂+B₂O₃) from 0.06 to 0.9, Pt+Rh from 0 to 5 ppm, HfO₂+Ta₂O₅ from 0 to less than 0.05%, β-OH value from 0.001 to 2/mm, and Sb₂O₃+As₂O₃ from less than 0.7%; and most preferably, SiO₂ from 50 to 75%, Al₂O₃ from 10 to 30%, Li₂O from 1 to 8%, SnO₂ from greater than 0 to 5%, ZrO₂ from 1 to 5%, MgO from 0 to 10%, P₂O₅ from 0 to 5%, TiO₂ from 0 to less than 1.5%, (Li₂O+Na₂O+K₂O)/ZrO₂ from 0 to 1.5, TiO₂/(TiO₂+Fe₂O₃) from 0.01 to 0.99, (MgO+ZnO)/Li₂O from 0 to 0.394, (MgO+CaO+SrO+BaO)/(Li₂O+Na₂O+K₂O) from 0 to 0.5, and (MgO+CaO+SrO+BaO)/ZrO₂ from 0 to 2, SnO₂/(SnO₂+ZrO₂+P₂O₅+TiO₂+B₂O₃) from 0.06 to 0.9, Pt+Rh from 0 to 5 ppm, HfO₂+Ta₂O₅ from 0 to less than 0.05%, β-OH value from 0.001 to 2/mm, Sb₂O₃+As₂O₃ from less than 0.7%, and Al₂O₃/(Li₂O+(½×(MgO+ZnO))) from 5.0 to 7.5.

The Li₂O—Al₂O₃—SiO₂-based crystallized glass of the present invention having the above-described composition is likely to have colorless and transparent appearance.

The Li₂O—Al₂O₃—SiO₂-based crystallized glass of the present invention preferably has a β-OH value from 0.001 to 2/mm, from 0.01 to 1.5/mm, from 0.02 to 1.5/mm, from 0.03 to 1.2/mm, from 0.04 to 1.5/mm, from 0.05 to 1/mm, from 0.06 to 1/mm, from 0.07 to 1/mm, from 0.08 to 0.9/mm, from 0.08 to 0.85/mm, from 0.08 to 0.8/mm, from 0.08 to 0.75/mm, from 0.08 to 0.7/mm, from 0.08 to 0.65/mm, from 0.08 to 0.6/mm, from 0.08 to 0.55/mm, from 0.08 to 0.54/mm, from 0.08 to 0.53/mm, from 0.08 to 0.52/mm, from 0.08 to 0.51/mm, and in particular, from 0.08 to 0.5/mm If the β-OH value is excessively small, a crystal nucleus formation rate in the crystallization step is decreased, and a smaller number of crystal nuclei may be generated. As a result, the number of coarse crystals increases, making the crystallized glass cloudy and easily impairing transparency of the glass. The reasons why a high β-OH value promotes crystallization is not completely known, but it is assumed that one of the reasons is that the β-OH groups weaken the bond of the glass skeleton and lower the viscosity of the glass. It is assumed that another reason is that the presence of the β-OH groups in the glass leads to increasing the mobility of components that can function as a crystal nucleus, such as Zr. On the other hand, if the β-OH value is excessively large, bubbles are likely to be generated at interface between the glass and a glass manufacturing furnace member made of metal containing Pt and the like, and a glass manufacturing furnace members made of refractories, and the like, and thus, the quality of a glass product may be deteriorated. Further, a β-quartz solid solution crystal easily transitions to a β-spodumene solid solution crystal and the like, and thus, the crystal grain may increase in size, and in addition, a refractive index difference is likely to occur inside the crystallized glass, and as a result, the crystallized glass is more likely to be cloudy. Note that the β-OH value is changed depending on the raw material, the melting atmosphere, the melting temperature, the melting time, and the like, and as necessary, these conditions can be changed to adjust the β-OH value.

In the Li₂O—Al₂O₃—SiO₂-based crystallized glass of the present invention, a transmittance at a thickness of 3 mm and a wavelength of 200 nm is preferably 0% or greater, 2.5% or greater, 5% or greater, 10% or greater, 12% or greater, 14% or greater, 16% or greater, 18% or greater, 20% or greater, 22% or greater, 24% or greater, 26% or greater, 28% or greater, 30% or greater, 32% or greater, 34% or greater, 36% or greater, 38% or greater, 40% or greater, 40.5% or greater, 41% or greater, 41.5% or greater, 42% or greater, 42.5% or greater, 43% or greater, 43.5% or greater, 44% or greater, 44.5% or greater, and in particular, 45% or greater. For applications in which the crystallized glass needs to transmit ultraviolet light, if the transmittance at a wavelength of 200 nm is excessively low, the desired transmission performance may not be obtained. In particular, in use of optical cleaning employing an ozone lamps and the like, a medical application using an excimer laser, and an exposure application, for example, a higher transmittance at a wavelength of 200 nm is preferable.

In the Li₂O—Al₂O₃—SiO₂-based crystallized glass of the present invention, a transmittance at a thickness of 3 mm and a wavelength of 250 nm is preferably 0% or greater, 1% or greater, 2% or greater, 3% or greater, 4% or greater, 5% or greater, 6% or greater, 7% or greater, 8% or greater, 9% or greater, 10% or greater, 10.5% or greater, 11% or greater, 11.5% or greater, 12% or greater, 12.5% or greater, 13% or greater, 13.5% or greater, 14% or greater, 14.5% or greater, 15% or greater, 15.5% or greater, and in particular, 16% or greater. For applications in which the crystallized glass needs to transmit ultraviolet light, if the transmittance at a wavelength of 250 nm is excessively low, the desired transmission performance may not be obtained. In particular, in use of a sterilization application using a low-pressure mercury lamps and the like and a processing application using a YAG laser and the like, for example, a higher transmittance at a wavelength of 250 nm is preferable.

The Li₂O—Al₂O₃—SiO₂-based crystallized glass of the present invention preferably has a transmittance at a thickness of 3 mm and a wavelength of 300 nm of 0% or greater, 2.5% or greater, 5% or greater, 10% or greater, 12% or greater, 14% or greater, 16% or greater, 18% or greater, 20% or greater, 22% or greater, 24% or greater, 26% or greater, 28% or greater, 30% or greater, 32% or greater, 34% or greater, 36% or greater, 38% or greater, 40% or greater, 40.5% or greater, 41% or greater, 41.5% or greater, 42% or greater, 42.5% or greater, 43% or greater, 43.5% or greater, 44% or greater, 44.5% or greater, and in particular, 45% or greater. In particular, in use of UV curing, adhesion, drying (UV curing), fluorescence detection of printed matter, and an application for attracting an insect, for example, a higher transmittance at a wavelength of 300 nm is preferable.

In the Li₂O—Al₂O₃—SiO₂-based crystallized glass of the present invention, a transmittance at a thickness of 3 mm and a wavelength of 325 nm is preferably 0% or greater, 2.5% or greater, 5% or greater, 10% or greater, 12% or greater, 14% or greater, 16% or greater, 18% or greater, 20% or greater, 22% or greater, 24% or greater, 26% or greater, 28% or greater, 30% or greater, 32% or greater, 34% or greater, 36% or greater, 38% or greater, 40% or greater, 42% or greater, 44% or greater, 46% or greater, 48% or greater, 50% or greater, 52% or greater, 54% or greater, 56% or greater, 57% or greater, 58% or greater, 59% or greater, 60% or greater, 61% or greater, 62% or greater, 63% or greater, 64% or greater, and in particular, 65% or greater. In particular, in use of UV curing, adhesion, drying (UV curing), fluorescence detection of printed matter, and an application for attracting an insect, for example, a higher transmittance at a wavelength of 325 nm is preferable.

In the Li₂O—Al₂O₃—SiO₂-based crystallized glass of the present invention, a transmittance at a thickness of 3 mm and a wavelength of 350 nm is preferably 0% or greater, 5% or greater, 10% or greater, 15% or greater, 20% or greater, 25% or greater, 30% or greater, 35% or greater, 40% or greater, 45% or greater, 50% or greater, 55% or greater, 60% or greater, 65% or greater, 70% or greater, 71% or greater, 72% or greater, 73% or greater, 74% or greater, 75% or greater, 76% or greater, 77% or greater, 78% or greater, 80% or greater, 81% or greater, 82% or greater, 83% or greater, and in particular, 84% or greater. In particular, in use of processing using a YAG laser and the like, a higher transmittance at a wavelength of 350 nm is preferable.

The Li₂O—Al₂O₃—SiO₂-based crystallized glass of the present invention preferably has a transmittance at a thickness of 3 mm and a wavelength of 380 nm of 50% or greater, 55% or greater, 60% or greater, 65% or greater, 70% or greater, 75% or greater, 78% or greater, 80% or greater, 81% or greater, 82% or greater, 83% or greater, and in particular, 84% or greater. If the transmittance at a wavelength of 380 nm is excessively low, the glass develops a strong yellow color and the transparency of the crystallized glass decreased, and as a result, the desired transmission performance may not be obtained.

In the Li₂O—Al₂O₃—SiO₂-based crystallized glass of the present invention, a transmittance at a thickness of 3 mm and a wavelength of 800 nm is preferably 50% or greater, 55% or greater, 60% or greater, 65% or greater, 70% or greater, 75% or greater, 78% or greater, 80% or greater, 81% or greater, 82% or greater, 83% or greater, 84% or greater, 85% or greater, 86% or greater, 87% or greater, and in particular, 88% or greater. If the transmittance at a wavelength of 800 nm is excessively low, the glass is easily colored in green. In particular, in use of a medical application such as vein authentication, a higher transmittance at a wavelength of 800 nm is preferable.

In the Li₂O—Al₂O₃—SiO₂-based crystallized glass of the present invention, a transmittance at a thickness of 3 mm and a wavelength of 1200 nm is preferably 50% or greater, 55% or greater, 60% or greater, 65% or greater, 70% or greater, 72% or greater, 74% or greater, 76% or greater, 78% or greater, 80% or greater, 81% or greater, 82% or greater, 83% or greater, 84% or greater, 85% or greater, 86% or greater, 87% or greater, 88% or greater, and in particular, 89% or greater. If the transmittance at a wavelength of 1200 nm is excessively low, the glass is easily colored in green. In particular, in use in an infrared camera or in use of an infrared communication application such as a remote control, a higher transmittance at a wavelength of 1200 nm is preferable.

In the Li₂O—Al₂O₃—SiO₂-based crystallized glass of the present invention, a rate of transmittance change before and after crystallization at a thickness of 3 mm and at a wavelength of 300 nm is preferably 50% or less, 48% or less, 46% or less, 44% or less, 42% or less, 40% or less, 38% or less, 37.5% or less, 37% or less, 36.5% or less, 36% or less, 35.5% or less, and in particular, 35% or less. If the rate of transmittance change before and after crystallization is reduced, it is possible to predict and control, before the crystallization, the transmittance after crystallization, and it is easier to obtain the desired transmission performance after crystallization. It is preferable that the rate of transmittance change before and after crystallization is small not only at a wavelength of 300 nm but also over the entire wavelength range.

The Li₂O—Al₂O₃—SiO₂-based crystallized glass of the present invention preferably has a lightness L* at a thickness of 3 mm of 50 or greater, 60 or greater, 65 or greater, 70% or greater, 75 or greater, 80 or greater, 85 or greater, 90 or greater, 91 or greater, 92 or greater, 93 or greater, 94 or greater, 95 or greater, 96 or greater, 96.1 or greater, 96.3 or greater, and in particular, 96.5 or greater. If the lightness L* is excessively small, the glass may appear gray and darker regardless of the magnitude of chromaticity.

In the Li₂O—Al₂O₃—SiO₂-based crystallized glass of the present invention, a chromaticity a* at a thickness of 3 mm is preferably within ±5.0, within ±4.5, within ±4, within ±3.6, within ±3.2, within ±2.8, within ±2.4, within ±2, within ±1.8, within ±1.6, within ±1.4, within ±1.2, within ±1, within ±0.9, within ±0.8, within ±0.7, within ±0.6, and in particular, within ±0.5. If the lightness a* is a negative value with an excessively large absolute value, the glass tends to be green, and if the lightness a* is a positive value with an excessively large absolute value, the glass tends to be red.

In the Li₂O—Al₂O₃—SiO₂-based crystallized glass of the present invention, a chromaticity b* at a thickness of 3 mm is preferably within ±5.0, within ±4.5, within ±4, within ±3.6, within ±3.2, within ±2.8, within ±2.4, within ±2, within ±1.8, within ±1.6, within ±1.4, within ±1.2, within ±1, within ±0.9, within ±0.8, within ±0.7, within ±0.6, and in particular, within ±0.5. If the lightness b* is a negative value with an excessively large absolute value, the glass tends to be blue, and if the lightness b* is a positive value with an excessively large absolute value, the glass tends to be yellow.

In the Li₂O—Al₂O₃—SiO₂-based crystallized glass of the present invention, in a state of the glass before crystallization, a strain point (temperature corresponding to the viscosity of the glass of about 10^{14.5} dPa·s) is preferably 600° C. or higher, 605° C. or higher, 610° C. or higher, 615° C. or higher, 620° C. or higher, 630° C. or higher, 635° C. or higher, 640° C. or higher, 645° C. or higher, 650° C. or higher, and in particular, 655° C. or higher. If the strain point is excessively low, the pre-crystallized glass becomes easily breakable when formed.

In the Li₂O—Al₂O₃—SiO₂-based crystallized glass of the present invention, in a state of the glass before crystallization, an annealing point (temperature corresponding to the viscosity of the glass of about 10¹³ dPa·s) is preferably 680° C. or higher, 685° C. or higher, 690° C. or higher, 695° C. or higher, 700° C. or higher, 705° C. or higher, 710° C. or higher, 715° C. or higher, 720° C. or higher, and in particular, 725° C. or higher. If the annealing point is excessively low, the pre-crystallized glass becomes easily breakable when formed.

The Li₂O—Al₂O₃—SiO₂-based crystallized glass of the present invention is easily crystallized by heat treatment, and thus, unlike general glass such soda lime glass, it is not easy to measure a softening point (temperature corresponding to the viscosity of the glass of about 10^{7.6} dPa·s). Therefore, in the Li₂O—Al₂O₃—SiO₂-based crystallized glass of the present invention, a temperature at which the slope of the thermal expansion curve of the glass before crystallization changes is used as a glass transition temperature, and is regarded as an alternative to the softening point. In the Li₂O—Al₂O₃—SiO₂-based crystallized glass of the present invention, in a glass state before crystallization, the glass transition temperature is preferably 680° C. or higher, 685° C. or higher, 690° C. or higher, 695° C. or higher, 700° C. or higher, 705° C. or higher, 710° C. or higher, 715° C. or higher, 720° C. or higher, and in particular, 725° C. or higher. An excessively low glass transition temperature results in excessively high fluidity of the glass during crystallization, which makes it difficult to form the glass into a desired shape.

In the Li₂O—Al₂O₃—SiO₂-based crystallized glass of the present invention, a liquidus temperature is preferably 1540° C. or less, 1535° C. or less, 1530° C. or less, 1525° C. or less, 1520° C. or less, 1515° C. or less, 1510° C. or less, 1505° C. or less, 1500° C. or less, 1495° C. or less, 1490° C. or less, 1485° C. or less, 1480° C. or less, 1475° C. or less, 1470° C. or less, 1465° C. or less, 1460° C. or less, 1455° C. or less, 1450° C. or less, 1445° C. or less, 1440° C. or less, 1435° C. or less, 1430° C. or less, 1425° C. or less, 1420° C. or less, 1415° C. or less, and in particular, 1410° C. or less. If the liquidus temperature is excessively high, the glass is easily subject to devitrification during production. On the other hand, if the liquidus temperature is 1480° C. or less, it is easy to manufacture the glass by a roll method and the like, if the liquidus temperature is 1450° C. or less, it is easy to manufacture the glass by a casting method, and the like, and If the liquidus temperature is 1410° C. or less, it is easy to manufacture the glass by a fusion method and the like.

In the Li₂O—Al₂O₃—SiO₂-based crystallized glass of the present invention, a liquidus viscosity (logarithm of the viscosity corresponding to the liquidus temperature) is preferably 2.70 or greater, 2.75 or greater, 2.80 or greater, 2.85 or greater, 2.90 or greater, 2.95 or greater, 3.00 or greater, 3.05 or greater, 3.10 or greater, 3.15 or greater, 3.20 or greater, 3.25 or greater, 3.30 or greater, 3.35 or greater, 3.40 or greater, 3.45 or greater, 3.50 or greater, 3.55 or greater, 3.60 or greater, 3.65 or greater, and in particular, 3.70 or greater. If the liquidus viscosity is excessively low, the glass is easily subject to devitrification during production. On the other hand, if the liquidus viscosity is 3.40 or greater, it is easy to manufacture the glass by a roll method and the like, if the liquidus viscosity is 3.50 or greater, it is easy to manufacture the glass by a casting method, and the like, and if the liquidus viscosity is 3.70 or greater, it is easy to manufacture the glass by a fusion method and the like.

In the Li₂O—Al₂O₃—SiO₂-based crystallized glass of the present invention, a β-quartz solid solution preferably precipitates as a main crystal. If the β-quartz solid solution precipitates as the main crystal, the crystal grain easily decreases in size, and thus, crystallized glass easily transmits visible light, and transparency easily increases. It is also possible to easily bring the thermal expansion coefficient of the glass close to zero. Note that if the Li₂O—Al₂O₃—SiO₂-based crystallized glass of the present invention is subjected to heat treatment at a temperature higher than the crystallization conditions for precipitating the β-quartz solid solution, a β-spodumene solid solution precipitates. The crystal grain size of β-spodumene solid solution tends to be larger than that of β-quartz solid solution, and thus, generally, precipitation of β-spodumene solid solution tends to result in a cloudy appearance of the crystallized glass. However, when the glass composition and firing conditions are suitably adjusted, a refractive index difference between the crystalline phase containing β-spodumene solid solution and the residual glass phase may be small, and in such a case, the crystallized glass is less cloudy. In the Li₂O—Al₂O₃—SiO₂-based crystallized glass of the present invention, crystals such as β-spodumene solid solution may be contained as long as there is no adverse effect on coloration and the like.

The Li₂O—Al₂O₃—SiO₂-based crystallized glass of the present invention preferably has a thermal expansion coefficient at from 30 to 380° C. of 30×10⁻⁷/° C. or less, 25×10⁻⁷/° C. or less, 20×10⁻⁷/° C. or less, 18×10⁻⁷/° C. or less, 16×10⁻⁷/° C. or less, 14×10⁻⁷/° C. or less, 13×10⁻⁷/° C. or less, 12×10⁻⁷/° C. or less, 11×10⁻⁷/° C. or less, 10×10⁻⁷/° C. or less, 9×10⁻⁷/° C. or less, 8×10⁻⁷/° C. or less, 7×10⁻⁷/° C. or less, 6×10⁻⁷/° C. or less, 5×10⁻⁷/° C. or less, 4×10⁻⁷/° C. or less, 3×10⁻⁷/° C. or less, and in particular, 2×10⁻⁷/° C. or less. Note that if dimensional stability and/or thermal shock resistance are particularly desired, the thermal expansion coefficient is preferably from −5×10⁻⁷/° C. to 5×10⁻⁷/° C., from −3×10⁻⁷/° C. to 3×10⁻⁷/° C., from −2.5×10⁻⁷/° C. to 2.5×10⁻⁷/° C., from −2×10⁻⁷/° C. to 2×10⁻⁷/° C., from −1.5×10⁻⁷/° C. to 1.5×10⁻⁷/° C., from −1×10⁻⁷/° C. to 1×10⁻⁷/° C., and in particular, from −0.5×10⁻⁷/° C. to 0.5×10⁻⁷/° C.

The Li₂O—Al₂O₃—SiO₂-based crystallized glass of the present invention preferably has a thermal expansion coefficient at from 30 to 750° C. of 30×10⁻⁷/° C. or less, 25×10⁻⁷/° C. or less, 20×10⁻⁷/° C. or less, 18×10⁻⁷/° C. or less, 16×10⁻⁷/° C. or less, 14×10⁻⁷/° C. or less, 13×10⁻⁷/° C. or less, 12×10⁻⁷/° C. or less, 11×10⁻⁷/° C. or less, 10×10⁻⁷/° C. or less, 9×10⁻⁷/° C. or less, 8×10⁻⁷/° C. or less, 7×10⁻⁷/° C. or less, 6×10⁻⁷/° C. or less, 5×10⁻⁷/° C. or less, 4×10⁻⁷/° C. or less, and in particular, 3×10⁻⁷/° C. or less. Note that if dimensional stability and/or thermal shock resistance are particularly desired, the thermal expansion coefficient is preferably from −15×10⁻⁷/° C. to 15×10⁻⁷/° C., from −12×10⁻⁷/° C. to 12×10⁻⁷/° C., from −10×10⁻⁷/° C. to 10×10⁻⁷/° C., from −8×10⁻⁷/° C. to 8×10⁻⁷/° C., from −6×10⁻⁷/° C. to 6×10⁻⁷/° C., from −5×10⁻⁷/° C. to 5×10⁻⁷/° C., from −4.5×10⁻⁷/° C. to 4.5×10⁻⁷/° C., from −4×10⁻⁷/° C. to 4×10⁻⁷/° C., from −3.5×10⁻⁷/° C. to 3.5×10⁻⁷/° C., from −3×10⁻⁷/° C. to 3×10⁻⁷/° C., from −2.5×10⁻⁷/° C. to 2.5×10⁻⁷/° C., from −2×10⁻⁷/° C. to 2×10⁻⁷/° C., from −1.5×10⁻⁷/° C. to 1.5×10⁻⁷/° C., from −1×10⁻⁷/° C. to 1×10⁻⁷/° C., and in particular, from −0.5×10⁻⁷/° C. to 0.5×10⁻⁷/° C.

The Li₂O—Al₂O₃—SiO₂-based crystallized glass of the present invention preferably has a Young's modulus from 60 to 120 GPa, from 70 to 110 GPa, from 75 to 110 GPa, from 75 to 105 GPa, from 80 to 105 GPa, and in particular, from 80 to 100 GPa. When the Young's modulus is either excessively low or excessively high, the crystallized glass becomes easily breakable.

The Li₂O—Al₂O₃—SiO₂-based crystallized glass of the present invention preferably has a modulus of rigidity from 25 to 50 GPa, from 27 to 48 GPa, from 29 to 46 GPa, and in particular, from 30 to 45 GPa. When the modulus of rigidity is either excessively low or excessively high, the crystallized glass becomes easily breakable.

The Li₂O—Al₂O₃—SiO₂-based crystallized glass of the present invention preferably has a Poisson's ratio of 0.35 or less, 0.32 or less, 0.3 or less, 0.28 or less, 0.26 or less, and in particular, 0.25 or less. If the Poisson's ratio is excessively large, the crystallized glass becomes easily breakable.

The crystallizable glass before crystallization of the Li₂O—Al₂O₃—SiO₂-based crystallized glass of the present invention preferably has a density from 2.30 to 2.60 g/cm³, from 2.32 to 2.58 g/cm³, from 2.34 to 2.56 g/cm³, from 2.36 to 2.54 g/cm³, from 2.38 to 2.52 g/cm³, from 2.39 to 2.51 g/cm³, and in particular, from 2.40 to 2.50 g/cm³. If the density of the crystallizable glass is excessively small, the gas permeability before crystallization deteriorates, and the glass may be contaminated during storage. On the other hand, if the density of the crystallizable glass is excessively large, the weight per unit area increases, and this makes it difficult to handle such glass.

The Li₂O—Al₂O₃—SiO₂-based crystallized glass (after crystallization) of the present invention preferably has a density from 2.40 to 2.80 g/cm³, from 2.42 to 2.78 g/cm³, from 2.44 to 2.76 g/cm³, from 2.46 to 2.74 g/cm³, and in particular, from 2.47 to 2.73 g/cm³. If the density of crystallized glass is excessively small, the gas permeability of the crystallized glass may deteriorate. On the other hand, if the density of the crystallized glass is excessively large, the weight per unit area increases, which makes it difficult to handle the crystallized glass. The density of crystallized glass (after crystallization) is an index for determining whether the glass is sufficiently crystallized. Specifically, if the same glasses are compared, a higher density (larger difference in density between raw glass and the crystallized glass) indicates that crystallization is further advanced.

A rate of density change of the Li₂O—Al₂O₃—SiO₂-based crystallized glass of the present invention is defined by {(density after crystallization (g/cm³)−density before crystallization (g/cm³))/density before crystallization (g/cm³)}×100 (%), where the density before crystallization is a density obtained after holding a melted glass at 700° C. for 30 minutes and cooling the glass to room temperature at 3° C./min, and the density after crystallization is a density obtained after crystallization treatment under a predetermined condition. The rate of density change is preferably from 0.01 to 10%, from 0.05 to 8%, from 0.1 to 8%, from 0.3 to 8%, from 0.5 to 8%, from 0.9 to 8%, from 1 to 7.8%, from 1 to 7.4%, from 1 to 7%, from 1.2 to 7%, from 1.6 to 7%, from 2 to 7%, from 2 to 6.8%, from 2 to 6.5%, from 2 to 6.3%, from 2 to 6.2%, from 2 to 6.1%, from 2 to 6%, from 2.5 to 5%, from 2.6 to 4.5%, and from 2.8 to 3.8%. If the rate of density change before and after crystallization is reduced, it is possible to reduce a breakage rate after crystallization, and it is possible to reduce scattering of glass and a glass matrix, and as a result it is possible to obtain crystallized glass with high transmittance. In particular, in a region where the content of TiO₂ is less than 0.5% (in particular, 0.05% or less), in order to reduce a coloration factor other than absorption of TiO₂ and the like, it is possible to significantly reduce scattering and possible to contribute to improving the transmittance.

The Li₂O—Al₂O₃—SiO₂-based crystallized glass of the present invention may be subject to chemical strengthening and the like. As a treatment condition of the chemical strengthening treatment, an appropriate treatment time and an appropriate treatment temperature may be chosen in consideration of the glass composition, the crystallinity, the type of the molten salt, and the like. For example, in order to facilitate chemical strengthening after crystallization, a glass composition containing a large amount of Na₂O that may be contained in the residual glass may be selected, and the crystallinity may be intentionally lowered. A molten salt may include an alkali metal such as Li, Na, K alone or in combination thereof. In addition, instead of normal one-step strengthening, multistep chemical strengthening may be selected. Besides, if the Li₂O—Al₂O₃—SiO₂-based crystallized glass of the present invention is subject to chemical strengthening and the like before crystallization, it is possible to reduce the content of Li₂O on a surface of a sample compared to the content of LiO₂ inside the sample. When such glass is crystallized, the crystallinity of the surface of the sample is lower than that inside the sample and the thermal expansion coefficient of the surface of the sample is relatively high, it is possible to introduce compressive stress resulting from a difference in thermal expansion into the surface of the sample. If the crystallinity of the surface of the sample is low, the glass phase increases at the surface, and depending on the selection of glass composition, it is possible to improve chemical resistance and gas barrier properties.

Next, a method of manufacturing the Li₂O—Al₂O₃—SiO₂-based crystallized glass of the present invention will be described.

Firstly, a raw material batch prepared to be glass having the composition described above is charged into a glass melting furnace, melted at from 1500 to 1750° C., and then, formed. Note that a flame melting method using a burner and the like, an electric melting method by electric heating, and the like may be used during the glass melting. In addition, melting by laser irradiation and melting by plasma may also be used. The sample may take any shape such as a plate-like shape, a fiber-like shape, a film-like shape, a powder-like shape, a spherical shape, and hollow shape, and not particularly limited.

Next, the obtained crystallizable glass (glass that can be crystallized but not yet crystallized) is heat-treated to crystallize. As the crystallization condition, firstly, nucleation is performed at from 700 to 950° C. (preferably from 750 to 900° C.) for 0.1 to 100 hours (preferably from 1 to 60 hours), and subsequently, crystal growth is performed at from 800 to 1050° C. (preferably from 800 to 1000° C.) for 0.1 to 50 hours (preferably from 0.2 to 10 hours). As a result, it is possible to obtain a transparent Li₂O—Al₂O₃—SiO₂-based crystallized glass in which β-quartz solid solution crystals were precipitated as main crystals. Note that heat treatment may be performed only at a certain temperature, stepwise heat treatment including holding the glass at two or more temperature levels may be performed, and heating may be performed while providing a temperature gradient.

A sound wave or electromagnetic wave may be applied to promote the crystallization. Further, the crystallized glass at a high-temperature may be cooled at a rate according to a certain temperature gradient, or may be cooled according to a temperature gradient of two or more levels. If it is preferable to obtain sufficient thermal shock resistance, it is desired to sufficiently relax the structure of the residual glass phase by controlling the cooling rate. In an inner portion of the crystallized glass in the thickness direction, which is farthest from the surface, an average cooling rate from 800° C. to 25° C. is preferably 3000° C./min, 1000° C./min or less, 500° C./min or less, 400° C./min or less, 300° C./min or less, 200° C./min or less, 100° C./min or less, 50° C./min or less, 25° C./min or less, 10° C./min or less, and in particular, 5° C./min or less. If it is desired to obtain a long-term dimensional stability, the average cooling rate is further preferably 2.5° C./min or less, 1° C./min or less, 0.5° C./min or less, 0.1° C./min or less, 0.05° C./min or less, 0.01° C./min or less, 0.005° C./min or less, 0.001° C./min or less, 0.0005° C./min or less, and in particular, 0.0001° C./min or less. Except for a case of physical strengthening treatment by air cooling, water cooling, and the like, as to the cooling rate of the crystallized glass, it is desirable to minimize a difference between the cooling rate at the surface of the glass and the cooling rate in the inner portion in the thickness direction, which is furthest from the surface of the glass. A value obtained by dividing the cooling rate in the inner portion in the thickness direction, which is furthest from the surface, by the cooling rate at the surface is preferably from 0.0001 to 1, from 0.001 to 1, from 0.01 to 1, from 0.1 to 1, from 0.5 to 1, from 0.8 to 1, from 0.9 to 1, and in particular, 1. When the value is close to 1, in all positions of the crystallized glass sample, residual strain is difficult to occur, and it is easy to obtain a long-term dimensional stability. Note that it is possible to estimate the cooling rate at the surface by using a contact temperature measurement or a radiation thermometer. The internal temperature can be estimated by placing the crystallized glass at a high temperature in a cooling medium, measuring a heat quantity and a heat quantity change rate of the cooling medium, estimating the internal temperature based on numerical data obtained in the measurement, specific heat and thermal conductivity of the crystallized glass and the cooling medium, and the like.

### EXAMPLE 1

The present invention will now be described based on Examples below, but the present invention is not limited to Examples. Tables 1 to 42 list Examples (Sample Nos. 1 to 131) of the present invention.

TABLE 1

| | | No. 1 | No. 2 | No. 3 | No. 4 | No. 5 |
|---|---|---|---|---|---|---|
| Composition | SiO₂ | 65.9 | 64.7 | 65.6 | 65.6 | 65.1 |
| [wt %] | Al₂O₃ | 22.3 | 21.9 | 22.2 | 22.2 | 22.0 |
| | B₂O₃ | 0.00 | 0.00 | 0.00 | 0.00 | 0.01 |
| | P₂O₅ | 1.40 | 1.38 | 1.38 | 1.38 | 1.38 |
| | Li₂O | 3.71 | 3.64 | 3.70 | 3.70 | 4.10 |
| | Na₂O | 0.40 | 0.39 | 0.39 | 0.39 | 0.39 |
| | K₂O | 0.30 | 0.30 | 0.30 | 0.30 | 0.30 |
| | MgO | 0.70 | 0.69 | 0.20 | 0.20 | 0.40 |
| | CaO | 0.00 | 0.00 | 0.00 | 0.00 | 0.00 |
| | SrO | 0.00 | 0.00 | 0.00 | 0.00 | 0.00 |
| | BaO | 1.20 | 1.18 | 1.18 | 1.18 | 1.18 |
| | ZnO | 0.00 | 0.00 | 0.00 | 0.00 | 0.00 |
| | TiO₂ | 0.0023 | 0.0044 | 0.0009 | 0.0015 | 0.0030 |
| | SnO₂ | 0.69 | 1.81 | 1.40 | 1.40 | 1.40 |
| | ZrO₂ | 3.39 | 4.06 | 3.70 | 3.70 | 3.70 |
| | Fe₂O₃ | 0.0153 | 0.0149 | 0.0154 | 0.0152 | 0.0151 |
| | Y₂O₃ | 0.00 | 0.00 | 0.00 | 0.00 | 0.00 |
| | MoO₃ | 0.0000 | 0.0000 | 0.0000 | 0.0000 | 0.0000 |
| | Sb₂O₃ | 0.00 | 0.00 | 0.00 | 0.00 | 0.00 |
| | As₂O₃ | 0.00 | 0.00 | 0.00 | 0.00 | 0.00 |
| Composition | Pt | 0.03 | 0.03 | 0.03 | 0.03 | 0.03 |
| [ppm] | Rh | 0.02 | 0.02 | 0.02 | 0.02 | 0.02 |
| | Pt + Rh | 0.05 | 0.05 | 0.05 | 0.05 | 0.05 |

| | | | | | |
|---|---|---|---|---|---|
| Sn/(P + B + Zr + Ti + Sn) | 0.126 | 0.249 | 0.216 | 0.216 | 0.216 |
| Al/(Zr + Sn) | 5.46 | 3.72 | 4.35 | 4.35 | 4.31 |
| (Mg + Zn)/Li | 0.189 | 0.189 | 0.054 | 0.054 | 0.098 |
| Sn/(Zr + Sn) | 0.17 | 0.31 | 0.27 | 0.27 | 0.27 |
| (Si + Al)/Li | 23.76 | 23.76 | 23.73 | 23.73 | 21.24 |
| (Si + Al)/Sn | 127.74 | 47.90 | 62.71 | 62.71 | 62.21 |
| (Li + Na + K)/Zr | 1.30 | 1.07 | 1.19 | 1.19 | 1.29 |
| Ti/Zr | 0.0007 | 0.0011 | 0.0002 | 0.0004 | 0.0008 |
| Ti/(Ti + Fe) | 0.131 | 0.228 | 0.055 | 0.090 | 0.166 |
| Na + K + Ca + Sr + Ba | 1.91 | 1.87 | 1.87 | 1.87 | 1.87 |
| (Mg + Ca + Sr + Ba)/Zr | 0.56 | 0.46 | 0.37 | 0.37 | 0.43 |
| (Mg + Ca + Sr + Ba)/(Li + Na + K) | 0.43 | 0.43 | 0.31 | 0.31 | 0.33 |
| Al/(Li + (1/2 * (Mg + Zn)) | 6.35 | 6.34 | 6.10 | 6.10 | 5.57 |
| Sb + As | 0.00 | 0.00 | 0.00 | 0.00 | 0.00 |

Before crystallization

| Transmittance[%] | 200 nm | Not measured | 44.9 | 54.1 | 54.1 | 53.9 |
|---|---|---|---|---|---|---|
| 3 mm thickness | 250 nm | Not measured | 17.0 | 19.5 | 19.5 | 19.8 |
| | 300 nm | Not measured | 24.1 | 29.9 | 29.9 | 32.3 |
| | 325 nm | Not measured | 65.6 | 69.6 | 69.6 | 70.9 |
| | 350 nm | Not measured | 84.4 | 86.1 | 86.1 | 86.2 |
| | 380 nm | Not measured | 89.5 | 90.3 | 90.3 | 90.2 |
| | 800 nm | Not measured | 91.5 | 91.8 | 91.8 | 91.7 |
| | 1200 nm | Not measured | 91.7 | 91.9 | 91.9 | 91.7 |
| L* | | Not measured | 96.6 | 96.7 | 96.7 | 96.6 |
| a* | | Not measured | −0.1 | −0.1 | −0.1 | −0.1 |
| b* | | Not measured | 0.2 | 0.2 | 0.2 | 0.2 |
| Low temperature | Strain point[° C.] | Not measured | Not measured | Not measured | Not measured | Not measured |
| viscosity | Annealing point[° C.] | Not measured | Not measured | Not measured | Not measured | Not measured |
| | Glass transition point | Not measured | Not measured | Not measured | Not measured | Not measured |
| | [° C.] | | | | | |
| High temperature | 10\hat{ }4[° C.] | Not measured | Not measured | Not measured | Not measured | Not measured |
| viscosity | 10\hat{ }3[° C.] | Not measured | Not measured | Not measured | Not measured | Not measured |
| | 10\hat{ }2.5[° C.] | Not measured | Not measured | Not measured | Not measured | Not measured |
| | 10\hat{ }2[° C.] | Not measured | Not measured | Not measured | Not measured | Not measured |
| Liquidus temperature[° C.] | | Not measured | Not measured | Not measured | Not measured | Not measured |
| Liquidus viscosity[—] | | Not measured | Not measured | Not measured | Not measured | Not measured |
| α[×10⁻⁷/° C.] | 30-380° C. | Not measured | 39.6 | Not measured | Not measured | Not measured |

| | | | | | |
|---|---|---|---|---|---|
| Density[g/cm3] | Not measured | Not measured | Not measured | Not measured | Not measured |
| β-OH[/mm] | 0.12 | 0.12 | 0.12 | 0.12 | 0.12 |

TABLE 2

| | | | | |
|---|---|---|---|---|
| No. 1 | No. 2 | No. 3 | No. 4 | No. 5 |

After crystallization

| Crystallization condition | | 810° C.-60 h | 810° C.-60 h | 810° C.-10 h | 810° C.-20 h | 810° C.-20 h |
|---|---|---|---|---|---|---|
| | | 920° C.-3 h | 920° C.-3 h | 920° C.-3 h | 920° C.-3 h | 920° C.-3 h |
| Transmittance[%] | 200 nm | 26.0 | 27.0 | 29.9 | 35.0 | 27.0 |
| 3 mm thickness | 250 nm | 26.0 | 14.0 | 17.3 | 20.0 | 14.0 |
| | 300 nm | 36.5 | 15.9 | 20.8 | 22.8 | 17.1 |
| | 325 nm | 55.1 | 53.5 | 62.0 | 63.7 | 58.3 |
| | 350 nm | 55.1 | 77.6 | 80.6 | 81.7 | 78.3 |
| | 380 nm | 69.7 | 84.4 | 85.7 | 86.4 | 84.2 |
| | 800 nm | 89.0 | 91.1 | 91.3 | 91.4 | 91.1 |
| | 1200 nm | 90.9 | 91.1 | 91.6 | 91.4 | 91.2 |
| L* | | 94.4 | 95.8 | 95.8 | 96.1 | 95.8 |
| a* | | −0.1 | −0.1 | −0.1 | 0.0 | −0.1 |
| b* | | 3.4 | 1.3 | 1.4 | 1.0 | 1.3 |
| Precipitated crystal | | β-Q | β-Q | β-Q | β-Q | β-Q |
| Average crystallite size[nm] | | Not measured | Not measured | Not measured | 45 | Not measured |
| α[×10⁻⁷/° C.] | 30-380° C. | −0.9 | −0.4 | Not measured | Not measured | Not measured |
| α[×10⁻⁷/° C.] | 30-750° C. | 0.9 | 0.9 | Not measured | Not measured | Not measured |

| | | | | | |
|---|---|---|---|---|---|
| Density[g/cm3] | Not measured | Not measured | Not measured | Not measured | Not measured |
| Young's Modulus [GPa] | 92 | 93 | Not measured | Not measured | Not measured |
| Modulus of rigidity [GPa] | 37 | 38 | Not measured | Not measured | Not measured |
| Poisson's ratio | 0.23 | 0.22 | Not measured | Not measured | Not measured |
| Appearance | Colorless and | Colorless and | Colorless and | Colorless and | Colorless and |
| | transparent | transparent | transparent | transparent | transparent |

Rate of change before and after crystallization[%]

| | | | | | |
|---|---|---|---|---|---|
| 200 nm | Not measured | 39.8 | 44.7 | 35.4 | 49.9 |
| 250 nm | Not measured | 17.6 | 11.3 | −3.0 | 29.4 |
| 300 nm | Not measured | 34.2 | 30.3 | 23.7 | 47.1 |
| 325 nm | Not measured | 18.6 | 11.0 | 8.4 | 17.8 |
| 350 nm | Not measured | 8.0 | 6.3 | 5.1 | 9.2 |
| 380 nm | Not measured | 5.8 | 5.0 | 4.2 | 6.6 |
| 800 nm | Not measured | 0.4 | 0.5 | 0.4 | 0.6 |
| 1200 nm | Not measured | 0.4 | 0.5 | 0.4 | 0.6 |

TABLE 3

| | | No. 6 | No. 7 | No. 8 | No. 9 | No. 10 | No. 11 | No. 12 |
|---|---|---|---|---|---|---|---|---|
| Composition | SiO₂ | 66.0 | 66.1 | 66.2 | 66.7 | 63.5 | 66.6 | 66.8 |
| [wt %] | Al₂O₃ | 22.4 | 22.4 | 22.4 | 22.2 | 23.5 | 22.3 | 21.8 |
| | B₂O₃ | 0.00 | 0.00 | 0.00 | 0.82 | 0.00 | 0.00 | 0.00 |
| | P₂O₅ | 1.42 | 1.42 | 1.39 | 0.00 | 2.51 | 1.40 | 1.37 |
| | Li₂O | 3.73 | 3.73 | 3.74 | 2.20 | 2.92 | 3.74 | 3.54 |
| | Na₂O | 0.08 | 0.36 | 0.38 | 0.01 | 0.80 | 0.00 | 0.39 |
| | K₂O | 0.30 | 0.00 | 0.00 | 0.01 | 0.05 | 0.00 | 0.00 |
| | MgO | 0.69 | 0.69 | 0.69 | 0.00 | 1.14 | 0.69 | 0.77 |
| | CaO | 0.01 | 0.01 | 0.00 | 0.02 | 0.01 | 0.01 | 0.01 |
| | SrO | 0.00 | 0.00 | 0.01 | 0.34 | 0.00 | 0.00 | 0.00 |
| | BaO | 0.00 | 0.00 | 0.00 | 0.48 | 0.12 | 0.01 | 0.00 |
| | ZnO | 0.00 | 0.00 | 0.00 | 1.66 | 0.00 | 0.01 | 0.00 |
| | TiO₂ | 0.0065 | 0.0042 | 0.0031 | 0.0000 | 0.1990 | 0.0055 | 0.0049 |
| | SnO₂ | 1.42 | 1.43 | 1.34 | 1.63 | 1.75 | 1.40 | 1.27 |
| | ZrO₂ | 3.85 | 3.83 | 3.84 | 3.90 | 3.72 | 3.81 | 2.96 |
| | Fe₂O₃ | 0.0068 | 0.0087 | 0.0099 | 0.0284 | 0.0081 | 0.0084 | 0.0075 |
| | Y₂O₃ | 0.00 | 0.00 | 0.00 | 0.00 | 0.00 | 0.00 | 0.00 |
| | MoO₃ | 0.0000 | 0.0000 | 0.0000 | 0.0000 | 0.0000 | 0.0000 | 0.0000 |
| | Sb₂O₃ | 0.00 | 0.00 | 0.00 | 0.00 | 0.00 | 0.00 | 0.00 |
| | As₂O₃ | 0.00 | 0.00 | 0.00 | 0.00 | 0.00 | 0.00 | 0.00 |
| Composition | Pt | 1.5 | 1.5 | 1.5 | Not measured | 1.5 | 1.5 | 1.5 |
| [ppm] | Rh | 0.02 | 0.02 | 0.02 | Not measured | 0.02 | 0.02 | 0.02 |
| | Pt + Rh | 1.52 | 1.52 | 1.52 | Not measured | 1.52 | 1.52 | 1.52 |

| | | | | | | | |
|---|---|---|---|---|---|---|---|
| Sn/(P + B + Zr + Ti + Sn) | 0.212 | 0.214 | 0.204 | 0.257 | 0.214 | 0.212 | 0.227 |
| Al/(Zr + Sn) | 4.25 | 4.26 | 4.32 | 4.01 | 4.30 | 4.28 | 5.15 |
| (Mg + Zn)/Li | 0.185 | 0.185 | 0.184 | 0.755 | 0.390 | 0.187 | 0.218 |
| Sn/(Zr + Sn) | 0.27 | 0.27 | 0.26 | 0.29 | 0.32 | 0.27 | 0.30 |
| (Si + Al)/Li | 23.70 | 23.73 | 23.69 | 40.41 | 29.79 | 23.77 | 25.03 |
| (Si + Al)/Sn | 62.25 | 61.89 | 66.12 | 54.54 | 49.71 | 63.50 | 69.76 |
| (Li + Na + K)/Zr | 1.07 | 1.07 | 1.07 | 0.57 | 1.01 | 0.98 | 1.33 |
| Ti/Zr | 0.0017 | 0.0011 | 0.0008 | 0.0000 | 0.0535 | 0.0014 | 0.0017 |
| Ti/(Ti + Fe) | 0.489 | 0.326 | 0.238 | 0.000 | 0.961 | 0.396 | 0.395 |
| Na + K + Ca + Sr + Ba | 0.39 | 0.37 | 0.39 | 0.86 | 0.98 | 0.02 | 0.40 |
| (Mg + Ca + Sr + Ba)/Zr | 0.18 | 0.18 | 0.18 | 0.21 | 0.34 | 0.19 | 0.26 |
| (Mg + Ca + Sr + Ba)/(Li + Na + K) | 0.17 | 0.17 | 0.17 | 0.38 | 0.34 | 0.19 | 0.20 |
| Al/(Li + (1/2 * (Mg + Zn)) | 6.35 | 6.35 | 6.33 | 10.92 | 8.62 | 6.31 | 6.54 |
| Sb + As | 0.00 | 0.00 | 0.00 | 0.00 | 0.00 | 0.00 | 0.00 |

Before crystallization

| Transmittance[%] | 200 nm | 65.9 | 67.4 | 65.7 | Not measured | Not measured | 77.2 | 80.7 |
|---|---|---|---|---|---|---|---|---|
| 3 mm thickness | 250 nm | 21.2 | 21.3 | 21.3 | Not measured | Not measured | 22.3 | 22.8 |
| | 300 nm | 30.4 | 30.1 | 30.3 | Not measured | Not measured | 29.1 | 32.0 |
| | 325 nm | 69.0 | 68.8 | 69.0 | Not measured | Not measured | 67.8 | 69.2 |
| | 350 nm | 85.4 | 85.2 | 85.3 | Not measured | Not measured | 85.0 | 85.2 |
| | 380 nm | 89.8 | 89.7 | 89.8 | Not measured | Not measured | 89.7 | 89.8 |
| | 800 nm | 91.6 | 91.6 | 91.6 | Not measured | Not measured | 91.6 | 91.6 |
| | 1200 nm | 91.6 | 91.6 | 91.6 | Not measured | Not measured | 91.5 | 91.6 |
| L* | | 96.6 | 96.6 | 96.6 | Not measured | Not measured | 96.6 | 96.7 |
| a* | | −0.1 | −0.1 | −0.1 | Not measured | Not measured | −0.1 | −0.1 |
| b* | | 0.3 | 0.3 | 0.3 | Not measured | Not measured | 0.3 | 0.4 |
| Low temperature | Strain point[° C.] | 687 | 683 | 684 | Not measured | Not measured | Not measured | Not measured |
| viscosity | Annealing point[° C.] | 745 | 741 | 742 | Not measured | Not measured | Not measured | Not measured |
| | Glass transition point | 728 | 730 | 728 | Not measured | Not measured | 745 | 740 |
| | [° C.] | | | | | | | |
| High temperature | 10\hat{ }4[° C.] | 1353 | 1351 | 1352 | Not measured | Not measured | 1358 | 1368 |
| viscosity | 10\hat{ }3[° C.] | 1530 | 1528 | 1531 | Not measured | Not measured | 1537 | 1549 |
| | 10\hat{ }2.5[° C.] | 1643 | 1641 | 1644 | Not measured | Not measured | 1650 | 1662 |
| | 10\hat{ }2[° C.] | 1780 | 1777 | 1780 | Not measured | Not measured | 1786 | 1795 |
| Liquidus temperature[° C.] | | 1489 | 1486 | 1489 | Not measured | Not measured | Not measured | Not measured |
| Liquidus viscosity[—] | | 3.20 | 3.21 | 3.21 | Not measured | Not measured | Not measured | Not measured |
| α[×10⁻⁷/° C.] | 30-380° C. | 38.2 | 38.7 | 38.6 | Not measured | Not measured | 36.4 | 37.5 |

| | | | | | | | |
|---|---|---|---|---|---|---|---|
| Density[g/cm3] | 2.442 | 2.442 | 2.441 | Not measured | Not measured | 2.441 | 2.444 |
| β-OH[/mm] | 0.15 | 0.15 | 0.15 | 0.15 | 0.15 | 0.15 | 0.15 |

TABLE 4

| | | | | | | |
|---|---|---|---|---|---|---|
| No. 6 | No. 7 | No. 8 | No. 9 | No. 10 | No. 11 | No. 12 |

After crystallization

| Crystallization condition | | 840° C.-3 h | 840° C.-3 h | 840° C.-3 h | 810° C.-30h | 825° C.-30h | 840° C.-3 h | 810° C.-3 h |
|---|---|---|---|---|---|---|---|---|
| | | 890° C.-1 h | 890° C.-1 h | 890° C.-1 h | 890° C.-3 h | 905° C.-3 h | 890° C.-1 h | 920° C.-1 h |
| Transmittance[%] | 200 nm | 26.8 | 25.4 | 22.7 | Not measured | Not measured | 26.5 | 35.3 |
| 3 mm thickness | 250 nm | 12.1 | 11.5 | 11.7 | Not measured | Not measured | 12.1 | 16.1 |
| | 300 nm | 26.8 | 25.4 | 22.7 | Not measured | Not measured | 26.5 | 35.3 |
| | 325 nm | 56.4 | 54.1 | 55.7 | Not measured | Not measured | 52.7 | 59.2 |
| | 350 nm | 77.2 | 75.5 | 76.7 | Not measured | Not measured | 75.3 | 74.4 |
| | 380 nm | 83.2 | 81.8 | 82.9 | Not measured | Not measured | 82.1 | 79.6 |
| | 800 nm | 90.7 | 90.5 | 90.6 | Not measured | Not measured | 90.5 | 89.9 |
| | 1200 nm | 90.8 | 90.7 | 90.9 | Not measured | Not measured | 90.6 | 90.7 |
| L* | | 95.5 | 95.2 | 95.4 | Not measured | Not measured | 95.3 | 94.7 |
| a* | | 0.1 | 0.1 | 0.1 | Not measured | Not measured | 0.1 | 0.1 |
| b* | | 1.6 | 1.9 | 1.7 | Not measured | Not measured | 1.7 | 2.3 |
| Precipitated crystal | | β-Q | β-Q | β-Q | β-Q | β-Q | β-Q | β-Q |
| Average crystallite size[nm] | | Not measured | Not measured | 45 | Not measured | Not measured | Not measured | Not measured |
| α[×10⁻⁷/° C.] | 30-380° C. | −5.2 | −5.1 | −5.0 | Not measured | Not measured | −4.0 | −2.5 |
| α[×10⁻⁷/° C.] | 30-750° C. | −3.7 | −3.6 | −3.6 | Not measured | Not measured | −3.7 | −1.7 |

| | | | | | | | |
|---|---|---|---|---|---|---|---|
| Density[g/cm3] | 2.531 | 2.534 | 2.534 | Not measured | Not measured | 2.542 | 2.535 |
| Young's Modulus [GPa] | Not measured | Not measured | Not measured | Not measured | Not measured | Not measured | Not measured |
| Modulus of rigidity [GPa] | Not measured | Not measured | Not measured | Not measured | Not measured | Not measured | Not measured |
| Poisson's ratio | Not measured | Not measured | Not measured | Not measured | Not measured | Not measured | Not measured |
| Appearance | Colorless and | Colorless and | Colorless and | Colorless and | Colorless and | Colorless and | Colorless and |
| | transparent | transparent | transparent | transparent | transparent | transparent | transparent |

Rate of change before and after crystallization[%]

| | | | | | | | |
|---|---|---|---|---|---|---|---|
| 200 nm | 59.3 | 62.3 | 65.5 | Not measured | Not measured | 65.7 | 56.2 |
| 250 nm | 43.0 | 46.1 | 44.8 | Not measured | Not measured | 45.5 | 29.4 |
| 300 nm | 11.7 | 15.7 | 25.1 | Not measured | Not measured | 8.9 | −10.5 |
| 325 nm | 18.3 | 21.3 | 19.3 | Not measured | Not measured | 22.3 | 14.4 |
| 350 nm | 9.6 | 11.4 | 10.0 | Not measured | Not measured | 11.3 | 12.6 |
| 380 nm | 7.3 | 8.8 | 7.7 | Not measured | Not measured | 8.5 | 11.4 |
| 800 nm | 1.0 | 1.2 | 1.1 | Not measured | Not measured | 1.2 | 1.9 |
| 1200 nm | 0.9 | 1.0 | 0.7 | Not measured | Not measured | 0.9 | 1.0 |

TABLE 5

| | | No. 13 | No. 14 | No. 15 | No. 16 | No. 17 | No. 18 | No. 19 |
|---|---|---|---|---|---|---|---|---|
| Composition | SiO₂ | 65.7 | 65.9 | 67.2 | 65.5 | 65.5 | 66.0 | 65.8 |
| [wt %] | Al₂O₃ | 21.7 | 22.2 | 21.6 | 22.0 | 22.0 | 22.3 | 22.1 |
| | B₂O₃ | 0.001 | 0.00 | 0.00 | 0.00 | 0.00 | 0.00 | 0.00 |
| | P₂O₅ | 1.37 | 1.40 | 1.41 | 1.39 | 1.42 | 1.42 | 1.38 |
| | Li₂O | 3.63 | 4.02 | 3.30 | 3.67 | 3.67 | 3.70 | 3.70 |
| | Na₂O | 0.87 | 0.37 | 0.37 | 0.01 | 0.37 | 0.39 | 0.09 |
| | K₂O | 0.10 | 0.00 | 0.00 | 0.30 | 0.00 | 0.30 | 0.001 |
| | MgO | 0.68 | 1.52 | 1.23 | 0.65 | 0.68 | 0.68 | 0.68 |
| | CaO | 0.00 | 0.35 | 0.00 | 0.01 | 0.01 | 0.01 | 0.01 |
| | SrO | 0.01 | 0.001 | 0.00 | 0.00 | 0.00 | 0.00 | 0.00 |
| | BaO | 1.18 | 0.00 | 0.30 | 1.18 | 1.18 | 0.001 | 1.17 |
| | ZnO | 0.00 | 0.01 | 0.01 | 0.001 | 0.00 | 0.00 | 0.00 |
| | TiO₂ | 0.0175 | 0.0080 | 0.1560 | 0.0782 | 0.0095 | 0.0014 | 0.0147 |
| | SnO₂ | 1.17 | 0.45 | 1.18 | 1.39 | 1.39 | 1.41 | 1.31 |
| | ZrO₂ | 2.93 | 3.90 | 1.89 | 3.75 | 3.73 | 3.80 | 3.77 |
| | Fe₂O₃ | 0.0045 | 0.0033 | 0.0021 | 0.0005 | 0.0072 | 0.0085 | 0.0093 |
| | Y₂O₃ | 0.00 | 0.00 | 0.00 | 0.00 | 0.00 | 0.00 | 0.00 |
| | MoO₃ | 0.0000 | 0.0000 | 0.0000 | 0.0000 | 0.0000 | 0.0000 | 0.0000 |
| | Sb₂O₃ | 0.00 | 0.00 | 0.00 | 0.00 | 0.00 | 0.00 | 0.00 |
| | As₂O₃ | 0.00 | 0.00 | 0.00 | 0.00 | 0.00 | 0.00 | 0.00 |
| Composition | Pt | 1.4 | 0.2 | 1.4 | 1.5 | 1.5 | 1.5 | 1.5 |
| [ppm] | Rh | 0.03 | 0.03 | 0.03 | 0.02 | 0.02 | 0.02 | 0.02 |
| | Pt + Rh | 1.43 | 0.23 | 1.43 | 1.52 | 1.52 | 1.52 | 1.52 |

| | | | | | | | |
|---|---|---|---|---|---|---|---|
| Sn/(P + B + Zr + Ti + Sn) | 0.213 | 0.078 | 0.255 | 0.210 | 0.212 | 0.213 | 0.202 |
| Al/(Zr + Sn) | 5.29 | 5.10 | 7.04 | 4.28 | 4.30 | 4.28 | 4.35 |
| (Mg + Zn)/Li | 0.187 | 0.381 | 0.377 | 0.177 | 0.185 | 0.184 | 0.184 |
| Sn/(Zr + Sn) | 0.29 | 0.10 | 0.38 | 0.27 | 0.27 | 0.27 | 0.26 |
| (Si + Al)/Li | 24.08 | 21.92 | 26.91 | 23.84 | 23.84 | 23.86 | 23.76 |
| (Si + Al)/Sn | 74.70 | 195.78 | 75.25 | 62.95 | 62.95 | 62.62 | 67.10 |
| (Li + Na + K)/Zr | 1.57 | 1.13 | 1.94 | 1.06 | 1.08 | 1.16 | 1.01 |
| Ti/Zr | 0.0060 | 0.0021 | 0.0825 | 0.0209 | 0.0025 | 0.0004 | 0.0039 |
| Ti/(Ti + Fe) | 0.795 | 0.708 | 0.987 | 0.994 | 0.569 | 0.141 | 0.613 |
| Na + K + Ca + Sr + Ba | 2.16 | 0.72 | 0.67 | 1.50 | 1.56 | 0.70 | 1.27 |
| (Mg + Ca + Sr + Ba)/Zr | 0.64 | 0.48 | 0.81 | 0.49 | 0.50 | 0.18 | 0.49 |
| (Mg + Ca + Sr + Ba)/(Li + Na + K) | 0.41 | 0.43 | 0.42 | 0.46 | 0.46 | 0.16 | 0.49 |
| Al/(Li + (1/2 * (Mg + Zn)) | 6.32 | 6.29 | 7.17 | 6.32 | 6.33 | 6.37 | 6.31 |
| Sb + As | 0.00 | 0.00 | 0.00 | 0.00 | 0.00 | 0.00 | 0.00 |

Before crystallization

| Transmittance | 200 nm | 79.6 | Not measured | Not measured | 62.3 | 61.1 | 62.8 | 69.0 |
|---|---|---|---|---|---|---|---|---|
| [%] 3 mm | 250 nm | 22.9 | Not measured | Not measured | 20.7 | 20.6 | 20.9 | 21.7 |
| thickness | 300 nm | 33.5 | Not measured | Not measured | 30.7 | 30.0 | 30.3 | 30.4 |
| | 325 nm | 71.2 | Not measured | Not measured | 68.9 | 68.7 | 69.2 | 67.9 |
| | 350 nm | 86.1 | Not measured | Not measured | 85.0 | 85.1 | 85.4 | 84.5 |
| | 380 nm | 90.2 | Not measured | Not measured | 89.5 | 89.6 | 89.8 | 89.3 |
| | 800 nm | 91.7 | Not measured | Not measured | 91.6 | 91.5 | 91.5 | 91.5 |
| | 1200 nm | 91.7 | Not measured | Not measured | 91.6 | 91.5 | 91.6 | 91.6 |
| L* | | 96.7 | Not measured | Not measured | 96.6 | 96.6 | 96.6 | 96.5 |
| a* | | −0.1 | Not measured | Not measured | −0.1 | −0.1 | −0.1 | −0.1 |
| b* | | 0.3 | Not measured | Not measured | 0.4 | 0.4 | 0.3 | 0.4 |
| Low temperature | Strain point[° C.] | Not measured | Not measured | \|Not measured | 679 | 682 | 682 | 687 |
| viscosity | Annealing point | Not measured | Not measured | Not measured | 738 | 741 | 740 | 745 |
| | [° C.] | | | | | | | |
| | Glass transition | Not measured | Not measured | Not measured | 727 | 728 | 726 | 730 |
| | point[° C.] | | | | | | | |
| High temperature | 10\hat{ }4[° C.] | Not measured | Not measured | Not measured | 1350 | 1348 | 1351 | 1350 |
| viscosity | 10\hat{ }3[° C.] | Not measured | Not measured | Not measured | 1528 | 1525 | 1531 | 1527 |
| | 10\hat{ }2.5[° C.] | Not measured | Not measured | Not measured | 1639 | 1636 | 1642 | 1640 |
| | 10\hat{ }2[° C.] | Not measured | Not measured | Not measured | 1772 | 1769 | 1773 | 1774 |
| Liquidus temperature[° C.] | | Not measured | Not measured | 1378 | 1492 | 1488 | 1491 | 1479 |
| Liquidus viscosity[—] | | Not measured | Not measured | Not measured | 3.18 | 3.19 | 3.20 | 3.24 |
| α[×10⁻⁷/° C.] | 30-380° C. | Not measured | Not measured | Not measured | 39.2 | 39.7 | 39.4 | 38.4 |

| | | | | | | | |
|---|---|---|---|---|---|---|---|
| Density[g/cm3] | 2.443 | Not measured | Not measured | 2.462 | 2.461 | 2.440 | 2.461 |
| β-OH[/mm] | 0.13 | 0.13 | 0.13 | 0.13 | 0.13 | 0.13 | 0.13 |

TABLE 6

| | | | | | | |
|---|---|---|---|---|---|---|
| No. 13 | No. 14 | No. 15 | No. 16 | No. 17 | No. 18 | No. 19 |

After crystallization

| Crystallization condition | | 780° C.-3 h | 780° C.-3 h | 780° C.-12h | 855° C.-3 h | 840° C.-3 h | 855° C.-3 h | 840° C.-3 h |
|---|---|---|---|---|---|---|---|---|
| | | 905° C.-1 h | 890° C.-1 h | 890° C.-1 h | 920° C.-1 h | 890° C.-1 h | 920° C.-1 h | 890° C.-1 h |
| Transmittance[%] | 200 nm | 37.2 | Not measured | Not measured | 28.9 | 23.5 | 30.0 | 26.1 |
| 3 mm thickness | 250 nm | 19.0 | Not measured | Not measured | 15.2 | 13.8 | 15.3 | 13.9 |
| | 300 nm | 37.2 | Not measured | Not measured | 28.9 | 23.5 | 30.0 | 26.1 |
| | 325 nm | 64.4 | Not measured | Not measured | 59.8 | 58.1 | 49.8 | 53.3 |
| | 350 nm | 80.2 | Not measured | Not measured | 77.0 | 76.8 | 67.1 | 74.3 |
| | 380 nm | 85.1 | Not measured | Not measured | 82.3 | 82.5 | 74.3 | 80.8 |
| | 800 nm | 90.9 | Not measured | Not measured | 90.4 | 90.5 | 90.2 | 90.2 |
| | 1200 nm | 91.2 | Not measured | Not measured | 90.6 | 90.9 | 90.8 | 90.6 |
| L* | | 95.8 | Not measured | Not measured | 95.3 | 95.3 | 95.3 | 95.4 |
| a* | | 0.0 | Not measured | Not measured | 0.1 | 0.1 | 0.1 | 0.0 |
| b* | | 1.2 | Not measured | Not measured | 1.8 | 1.8 | 1.8 | 1.9 |
| Precipitated crystal | | β-Q | β-Q | β-Q | β-Q | β-Q | β-Q | β-Q |
| Average crystallite size[nm] | | Not measured | Not measured | Not measured | Not measured | Not measured | Not measured | Not measured |
| α[×10⁻⁷/° C.] | 30-380° C. | −3.0 | −1.3 | −0.8 | −3.4 | −3.5 | −3.7 | −5.0 |
| α[×10⁻⁷/° C.] | 30-750° C. | −2.7 | −0.8 | −0.5 | −1.8 | −1.9 | −2.0 | −3.5 |
| Density[g/cm3] | | 2.530 | Not measured | 2.521 | 2.544 | 2.544 | 2.521 | 2.551 |
| Young's Modulus [GPa] | | Not measured | Not measured | Not measured | Not measured | Not measured | Not measured | Not measured |
| Modulus of rigidity [GPa] | | Not measured | Not measured | Not measured | Not measured | Not measured | Not measured | Not measured |
| Poisson's ratio | | Not measured | Not measured | Not measured | Not measured | Not measured | Not measured | Not measured |
| Appearance | | Colorless and | Colorless and | Colorless and | Colorless and | Colorless and | Colorless and | Colorless and |
| | | transparent | transparent | transparent | transparent | transparent | transparent | transparent |

Rate of change before and after crystallization[%]

| | | | | | | | |
|---|---|---|---|---|---|---|---|
| 200 nm | 53.2 | Not measured | Not measured | 53.7 | 61.5 | 52.2 | 62.2 |
| 250 nm | 16.8 | Not measured | Not measured | 26.7 | 33.3 | 26.4 | 36.0 |
| 300 nm | −11.2 | Not measured | Not measured | 6.1 | 21.5 | 0.8 | 14.3 |
| 325 nm | 9.5 | Not measured | Not measured | 13.3 | 15.4 | 28.0 | 21.5 |
| 350 nm | 6.9 | Not measured | Not measured | 9.5 | 9.7 | 21.4 | 12.0 |
| 380 nm | 5.6 | Not measured | Not measured | 8.1 | 8.0 | 17.3 | 9.5 |
| 800 nm | 0.8 | Not measured | Not measured | 1.3 | 1.1 | 1.5 | 1.3 |
| 1200 nm | 0.6 | Not measured | Not measured | 1.1 | 0.7 | 0.8 | 1.0 |

TABLE 7

| | | No. 20 | No. 21 | No. 22 | No. 23 | No. 24 | No. 25 | No. 26 |
|---|---|---|---|---|---|---|---|---|
| Composition | SiO₂ | 66.6 | 65.0 | 66.1 | 67.1 | 68.0 | 65.7 | 67.0 |
| [wt %] | Al₂O₃ | 21.9 | 22.0 | 21.7 | 22.2 | 22.6 | 21.9 | 22.1 |
| | B₂O₃ | 0.00 | 0.00 | 0.00 | 0.00 | 0.00 | 0.60 | 0.00 |
| | P₂O₅ | 1.39 | 1.38 | 1.36 | 1.41 | 0.00 | 2.55 | 1.40 |
| | Li₂O | 3.66 | 3.67 | 3.63 | 3.69 | 3.74 | 3.64 | 3.62 |
| | Na₂O | 0.40 | 0.40 | 0.41 | 0.07 | 0.09 | 0.07 | 0.37 |
| | K₂O | 0.00 | 0.30 | 0.02 | 0.00 | 0.00 | 0.00 | 0.00 |
| | MgO | 0.68 | 0.69 | 0.68 | 1.23 | 0.40 | 1.23 | 1.23 |
| | CaO | 0.01 | 0.00 | 0.03 | 0.01 | 0.02 | 0.01 | 0.00 |
| | SrO | 0.00 | 0.00 | 0.43 | 0.00 | 0.00 | 0.00 | 0.01 |
| | BaO | 1.17 | 1.19 | 1.16 | 0.00 | 0.00 | 0.00 | 0.00 |
| | ZnO | 0.00 | 0.00 | 0.00 | 0.00 | 0.90 | 0.00 | 0.00 |
| | TiO₂ | 0.0210 | 0.3630 | 0.0235 | 0.0001 | 0.0141 | 0.0385 | 0.0720 |
| | SnO₂ | 1.23 | 1.36 | 1.21 | 1.41 | 1.22 | 1.25 | 1.29 |
| | ZrO₂ | 2.81 | 3.71 | 3.01 | 3.02 | 3.06 | 3.06 | 3.01 |
| | Fe₂O₃ | 0.0039 | 0.0000 | 0.0131 | 0.0088 | 0.0003 | 0.0091 | 0.0029 |
| | Y₂O₃ | 0.00 | 0.00 | 0.00 | 0.00 | 0.00 | 0.00 | 0.00 |
| | MoO₃ | 0.0000 | 0.0000 | 0.0000 | 0.0000 | 0.0000 | 0.0000 | 0.0000 |
| | Sb₂O₃ | 0.00 | 0.00 | 0.00 | 0.00 | 0.00 | 0.00 | 0.00 |
| | As₂O₃ | 0.00 | 0.00 | 0.00 | 0.00 | 0.00 | 0.00 | 0.00 |
| Composition | Pt | 1.5 | 0.01 | 1.5 | 1.4 | 1.4 | 1.4 | 1.4 |
| [ppm] | Rh | 0.02 | 0.01 | 0.02 | 0.02 | 0.03 | 0.03 | 0.03 |
| | Pt + Rh | 1.52 | 0.02 | 1.52 | 1.42 | 1.43 | 1.43 | 1.43 |

| | | | | | | | |
|---|---|---|---|---|---|---|---|
| Sn/(P + B + Zr + Ti + Sn) | 0.226 | 0.200 | 0.216 | 0.241 | 0.284 | 0.167 | 0.223 |
| Al/(Zr + Sn) | 5.42 | 4.33 | 5.14 | 5.01 | 5.28 | 5.08 | 5.14 |
| (Mg + Zn)/Li | 0.186 | 0.188 | 0.187 | 0.333 | 0.348 | 0.338 | 0.340 |
| Sn/(Zr + Sn) | 0.30 | 0.27 | 0.29 | 0.32 | 0.29 | 0.29 | 0.30 |
| (Si + Al)/Li | 24.18 | 23.69 | 24.19 | 24.20 | 24.22 | 24.07 | 24.61 |
| (Si + Al)/Sn | 71.95 | 63.93 | 72.56 | 63.33 | 74.26 | 70.08 | 69.07 |
| (Li + Na + K)/Zr | 1.44 | 1.18 | 1.35 | 1.25 | 1.25 | 1.21 | 1.33 |
| Ti/Zr | 0.0075 | 0.0978 | 0.0078 | 0.0000 | 0.0046 | 0.0126 | 0.0239 |
| Ti/(Ti + Fe) | 0.843 | 1.000 | 0.642 | 0.011 | 0.979 | 0.809 | 0.961 |
| Na + K + Ca + Sr + Ba | 4.75 | 4.76 | 5.18 | 5.00 | 4.25 | 4.95 | 5.23 |
| (Mg + Ca + Sr + Ba)/Zr | 0.66 | 0.51 | 0.76 | 0.41 | 0.14 | 0.41 | 0.41 |
| (Mg + Ca + Sr + Ba)/(Li + Na + K) | 0.46 | 0.43 | 0.57 | 0.33 | 0.11 | 0.34 | 0.31 |
| Al/(Li + (1/2 * (Mg + Zn)) | 6.32 | 6.33 | 6.32 | 6.63 | 6.69 | 6.63 | 6.72 |
| Sb + As | 0.00 | 0.00 | 0.00 | 0.00 | 0.00 | 0.00 | 0.00 |

Before crystallization

| Transmittance[%] | 200 nm | 80 | Not measured | 70 | 81 | 78 | 80 | 82 |
|---|---|---|---|---|---|---|---|---|
| 3 mm thickness | 250 nm | 23 | Not measured | 19 | 24 | 23 | 24 | 24 |
| | 300 nm | 35 | Not measured | 19 | 34 | 33 | 30 | 34 |
| | 325 nm | 71 | Not measured | 56 | 72 | 71 | 67 | 71 |
| | 350 nm | 86 | Not measured | 80 | 86 | 86 | 85 | 86 |
| | 380 nm | 90 | Not measured | 88 | 90 | 90 | 90 | 90 |
| | 800 nm | 92 | Not measured | 91 | 92 | 92 | 91 | 92 |
| | 1200 nm | 92 | Not measured | 91 | 92 | 92 | 92 | 92 |
| L* | | 96.7 | Not measured | 96.6 | 96.7 | 96.7 | 96.6 | 96.6 |
| a* | | −0.1 | Not measured | −0.1 | 0.0 | 0.0 | 0.0 | 0.0 |
| b* | | 0.3 | Not measured | 0.4 | 0.3 | 0.3 | 0.3 | 0.3 |
| Low temperature | Strain point[° C.] | 683 | Not measured | 683 | Not measured | Not measured | Not measured | Not measured |
| viscosity | Annealing point | 742 | Not measured | 742 | Not measured | Not measured | Not measured | Not measured |
| | [° C.] | | | | | | | |
| | Glass transition | 737 | Not measured | 731 | 738 | 743 | 731 | Not measured |
| | point[° C.] | | | | | | | |
| High temperature | 10\hat{ }4[° C.] | 1362 | Not measured | 1362 | 1356 | 1352 | 1357 | 1358 |
| viscosity | 10\hat{ }3[° C.] | 1544 | Not measured | 1544 | 1537 | 1532 | 1538 | 1538 |
| | 10\hat{ }2.5[° C.] | 1658 | Not measured | 1656 | 1649 | 1645 | 1650 | 1653 |
| | 10\hat{ }2[° C.] | 1793 | Not measured | 1789 | 1778 | 1778 | 1780 | 1790 |
| Liquidus temperature[° C.] | | 1423 | Not measured | 1442 | Not measured | Not measured | Not measured | Not measured |
| Liquidus viscosity[—] | | 3.63 | Not measured | 3.53 | Not measured | Not measured | Not measured | Not measured |
| α[×10⁻⁷/° C.] | 30-380° C. | 39.2 | Not measured | 39.3 | 36.6 | 36.9 | 36.5 | 36.9 |

| | | | | | | | |
|---|---|---|---|---|---|---|---|
| Density[g/cm3] | 2.441 | Not measured | 2.445 | 2.431 | 2.438 | 2.420 | 2.430 |
| β-OH[/mm] | 0.18 | 0.18 | 0.18 | 0.18 | 0.18 | 0.18 | 0.18 |

TABLE 8

| | | | | | | |
|---|---|---|---|---|---|---|
| No. 20 | No. 21 | No. 22 | No. 23 | No. 24 | No. 25 | No. 26 |

After crystallization

| Crystallization condition | | 840° C.-3 h | 810° C.-20h | 810° C.-3 h | 780° C.-3 h | 780° C.-3 h | 780° C.-3 h | 780° C.-3 h |
|---|---|---|---|---|---|---|---|---|
| | | 890° C.-1 h | 920° C.-3 h | 920° C.-1 h | 890° C.-1 h | 890° C.-1 h | 890° C.-1 h | 890° C.-1 h |
| Transmittance[%] | 200 nm | 41 | Not measured | 34 | 30 | 26 | 29 | 33 |
| 3 mm thickness | 250 nm | 17 | Not measured | 10 | 14 | 13 | 11 | 13 |
| | 300 nm | 41 | Not measured | 34 | 30 | 26 | 29 | 33 |
| | 325 nm | 54 | Not measured | 44 | 56 | 55 | 55 | 61 |
| | 350 nm | 69 | Not measured | 66 | 76 | 75 | 76 | 79 |
| | 380 nm | 74 | 0 | 76 | 82 | 81 | 83 | 84 |
| | 800 nm | 90 | 0 | 90 | 91 | 91 | 91 | 91 |
| | 1200 nm | 91 | Not measured | 90 | 91 | 91 | 91 | 91 |
| L* | | 93.9 | Not measured | 94.8 | 95.4 | 95.3 | 95.6 | 95.6 |
| a* | | 0.2 | Not measured | 0.0 | 0.1 | 0.0 | 0.0 | 0.1 |
| b* | | 3.4 | Not measured | 2.7 | 1.7 | 1.9 | 1.5 | 1.4 |
| Precipitated crystal | | β-Q | β-Q | β-Q | β-Q | β-Q | β-Q | β-Q |
| Average crystallite size[nm] | | Not measured | Not measured | Not measured | Not measured | Not measured | Not measured | Not measured |
| α[×10⁻⁷/° C.] | 30-380° C. | −5.4 | −0.2 | −5.0 | −2.8 | −2.5 | −2.4 | −1.1 |
| α[×10⁻⁷/° C.] | 30-750° C. | −4.0 | 0.9 | −3.4 | −2.6 | −1.9 | −2.5 | −0.8 |
| Density[g/cm3] | | 2.520 | Not measured | 2.529 | 2.529 | 2.534 | 2.527 | 2.523 |
| Young's Modulus [GPa] | | Not measured | Not measured | Not measured | Not measured | Not measured | Not measured | Not measured |
| Modulus of rigidity [GPa] | | Not measured | Not measured | Not measured | Not measured | Not measured | Not measured | Not measured |
| Poisson's ratio | | Not measured | Not measured | Not measured | Not measured | Not measured | Not measured | Not measured |
| Appearance | | Colorless and | Colorless and | Colorless and | Colorless and | Colorless and | Colorless and | Colorless and |
| | | transparent | transparent | transparent | transparent | transparent | transparent | transparent |

Rate of change before and after crystallization[%]

| | | | | | | | |
|---|---|---|---|---|---|---|---|
| 200 nm | 49.3 | Not measured | 51.1 | 62.8 | 66.5 | 64.5 | 59.8 |
| 250 nm | 24.3 | Not measured | 47.7 | 41.5 | 42.8 | 54.3 | 43.9 |
| 300 nm | −16.4 | Not measured | −76.5 | 12.6 | 21.0 | 4.2 | 2.2 |
| 325 nm | 23.8 | Not measured | 22.2 | 21.6 | 22.4 | 19.0 | 13.6 |
| 350 nm | 20.1 | Not measured | 18.1 | 12.0 | 12.8 | 9.6 | 8.2 |
| 380 nm | 17.3 | Not measured | 13.7 | 8.9 | 9.6 | 7.1 | 6.6 |
| 800 nm | 2.1 | Not measured | 1.3 | 1.3 | 1.1 | 0.8 | 1.0 |
| 1200 nm | 1.0 | Not measured | 1.4 | 0.9 | 0.9 | 0.6 | 0.9 |

TABLE 9

| | | No. 27 | No. 28 | No. 29 | No. 30 | No. 31 | No. 32 | No. 33 |
|---|---|---|---|---|---|---|---|---|
| Composition | SiO₂ | 66.5 | 67.4 | | | | | |
| [wt %] | Al₂O₃ | 21.8 | 22.3 | | | | | |
| | B₂O₃ | 0.00 | 0.00 | | | | | |
| | P₂O₅ | 1.40 | 1.33 | | | | | |
| | Li₂O | 3.63 | 3.68 | | | | | |
| | Na₂O | 0.41 | 0.37 | | | | | |
| | K₂O | 0.00 | 0.00 | | | | | |
| | MgO | 0.69 | 1.24 | | | | | |
| | CaO | 0.00 | 0.00 | | | | | |
| | SrO | 0.00 | 0.00 | | | | | |
| | BaO | 1.18 | 0.00 | | | | | |
| | ZnO | 0.01 | 0.00 | | | | | |
| | TiO₂ | 0.0182 | 0.0145 | | | | | |
| | SnO₂ | 1.36 | 1.13 | | | | | |
| | ZrO₂ | 2.95 | 2.62 | | | | | |
| | Fe₂O₃ | 0.0018 | 0.0064 | | | | | |
| | Y₂O₃ | 0.00 | 0.00 | | | | | |
| | MoO₃ | 0.0000 | 0.0000 | | | | | |
| | Sb₂O₃ | 0.00 | 0.00 | 0.00 | 0.00 | 0.00 | 0.00 | 0.00 |
| | As₂O₃ | 0.00 | 0.00 | 0.00 | 0.00 | 0.00 | 0.00 | 0.00 |
| Composition | Pt | 0 | 0.03 | 0.16 | 0.30 | 0.49 | 0.71 | 0.03 |
| [ppm] | Rh | 0 | 0.02 | 0.09 | 0.06 | 0.07 | 0.10 | 0.22 |
| | Pt + Rh | 0 | 0.05 | 0.25 | 0.36 | 0.56 | 0.81 | 0.25 |

| | | |
|---|---|---|
| Sn/(P + B + Zr + Ti + Sn) | 0.237 | 0.222 |
| Al/(Zr + Sn) | 5.06 | 5.95 |
| (Mg + Zn)/Li | 0.194 | 0.337 |
| Sn/(Zr + Sn) | 0.32 | 0.30 |
| (Si + Al)/Li | 24.33 | 24.38 |
| (Si + Al)/Sn | 64.93 | 79.38 |
| (Li + Na + K)/Zr | 1.37 | 1.55 |
| Ti/Zr | 0.0062 | 0.0055 |
| Ti/(Ti + Fe) | 0.910 | 0.694 |
| Na + K + Ca + Sr + Ba | 4.73 | 5.29 |
| (Mg + Ca + Sr + Ba)/Zr | 0.64 | 0.47 |
| (Mg + Ca + Sr + Ba)/(Li + Na + K) | 0.47 | 0.31 |
| Al/(Li + (1/2 * (Mg + Zn)) | 6.36 | 6.68 |
| Sb + As | 0.00 | 0.00 |

Before crystallization

| Transmittance[%] | 200 nm | 72.0 | 83.4 | Not measured | Not measured | Not measured | Not measured | Not measured |
|---|---|---|---|---|---|---|---|---|
| 3 mm thickness | 250 nm | 22.1 | 24.6 | Not measured | Not measured | Not measured | Not measured | Not measured |
| | 300 nm | 35.3 | 45.9 | Not measured | Not measured | Not measured | Not measured | Not measured |
| | 325 nm | 72.6 | 76.6 | Not measured | Not measured | Not measured | Not measured | Not measured |
| | 350 nm | 86.8 | 87.5 | Not measured | Not measured | Not measured | Not measured | Not measured |
| | 380 nm | 90.4 | 90.3 | Not measured | Not measured | Not measured | Not measured | Not measured |
| | 800 nm | 91.6 | 91.7 | Not measured | Not measured | Not measured | Not measured | Not measured |
| | 1200 nm | 91.6 | 91.7 | Not measured | Not measured | Not measured | Not measured | Not measured |
| L* | | 96.7 | 96.6 | Not measured | Not measured | Not measured | Not measured | Not measured |
| a* | | 0.0 | −0.1 | Not measured | Not measured | Not measured | Not measured | Not measured |
| b* | | 0.2 | 0.4 | Not measured | Not measured | Not measured | Not measured | Not measured |
| Low temperature | Strain point[° C.] | 683 | Not measured | Not measured | Not measured | Not measured | Not measured | Not measured |
| viscosity | Annealing point | 742 | Not measured | Not measured | Not measured | Not measured | Not measured | Not measured |
| | [° C.] | | | | | | | |
| | Glass transition | 731 | 737 | Not measured | Not measured | Not measured | Not measured | Not measured |
| | point[° C.] | | | | | | | |
| High temperature | 10\hat{ }4[° C.] | 1362 | 1362 | Not measured | Not measured | Not measured | Not measured | Not measured |
| viscosity | 10\hat{ }3[° C.] | 1544 | 1542 | Not measured | Not measured | Not measured | Not measured | Not measured |
| | 10\hat{ }2.5[° C.] | 1656 | 1655 | Not measured | Not measured | Not measured | Not measured | Not measured |
| | 10\hat{ }2[° C.] | 1789 | 1789 | Not measured | Not measured | Not measured | Not measured | Not measured |

| | | | | | | | |
|---|---|---|---|---|---|---|---|
| Liquidus temperature[° C.] | 1442 | 1401 | Not measured | Not measured | Not measured | Not measured | Not measured |
| Liquidus viscosity[—] | 3.53 | 3.72 | Not measured | Not measured | Not measured | Not measured | Not measured |
| α[×10⁻⁷/° C.] | 39.3 | 37.8 | Not measured | Not measured | Not measured | Not measured | Not measured |
| Density[g/cm3] | 2.444 | 2.422 | Not measured | Not measured | Not measured | Not measured | Not measured |
| β-OH[/mm] | 0.12 | 0.12 | 0.12 | 0.12 | 0.12 | 0.12 | 0.12 |

TABLE 10

| | | | | | | |
|---|---|---|---|---|---|---|
| No. 27 | No. 28 | No. 29 | No. 30 | No. 31 | No. 32 | No. 33 |

After crystallization

| Crystallization condition | | 780° C.-3 h | 780° C.-3 h | 780° C.-3 h | 780° C.-3 h | 780° C.-3 h | 780° C.-3 h | 780° C.-3 h |
|---|---|---|---|---|---|---|---|---|
| | | 905° C.-1 h | 890° C.-1 h | 890° C.-1 h | 890° C.-1 h | 890° C.-1 h | 890° C.-1 h | 890° C.-1 h |
| Transmittance[%] | 200 nm | 34.9 | 30.6 | 37.5 | 36.7 | 36.7 | 35.9 | 30.6 |
| 3 mm thickness | 250 nm | 17.0 | 12.1 | 18.9 | 19.0 | 18.9 | 18.7 | 12.1 |
| | 300 nm | 34.9 | 30.6 | 20.6 | 23.0 | 22.9 | 23.1 | 30.6 |
| | 325 nm | 69.9 | 61.9 | 59.7 | 62.2 | 60.7 | 60.5 | 61.9 |
| | 350 nm | 85.3 | 81.7 | 78.7 | 79.7 | 77.6 | 77.2 | 81.7 |
| | 380 nm | 88.9 | 87.0 | 91.1 | 91.1 | 90.8 | 90.7 | 87.0 |
| | 800 nm | 91.4 | 91.4 | 91.1 | 91.1 | 90.8 | 90.7 | 91.4 |
| | 1200 nm | 91.2 | 91.3 | 91.0 | 90.9 | 90.8 | 90.8 | 91.3 |
| L* | | 96.3 | 96.2 | 95.9 | 95.9 | 95.6 | 95.5 | 96.2 |
| a* | | 0.1 | 0.0 | −0.1 | −0.1 | −0.1 | −0.1 | 0.0 |
| b* | | 0.4 | 0.7 | 1.2 | 1.1 | 1.5 | 1.6 | 0.7 |
| Diffuse | 600 nm | Not measured | 0.10 | Not measured | Not measured | Not measured | 0.53 | Not measured |
| transmittance[%] | 800 nm | Not measured | 0.04 | Not measured | Not measured | Not measured | 0.23 | Not measured |
| 3 mm thickness | 1200 nm | Not measured | 0.03 | Not measured | Not measured | Not measured | 0.06 | Not measured |
| Precipitated crystal | | β-Q | β-Q | β-Q | β-Q | β-Q | β-Q | β-Q |
| Average crystallite size[nm] | | 38 | Not measured | Not measured | Not measured | Not measured | Not measured | Not measured |
| α[×10⁻⁷/° C.] | 30-380° C. | −5.0 | −2.7 | Not measured | Not measured | Not measured | Not measured | Not measured |
| α[×10⁻⁷/° C.] | 30-750° C. | −3.4 | −1.7 | Not measured | Not measured | Not measured | Not measured | Not measured |
| Density[g/cm3] | | 2.530 | 2.515 | Not measured | Not measured | Not measured | Not measured | Not measured |
| Young's Modulus [GPa] | | Not measured | Not measured | Not measured | Not measured | Not measured | Not measured | Not measured |
| Modulus of rigidity [GPa] | | Not measured | Not measured | Not measured | Not measured | Not measured | Not measured | Not measured |
| Poisson's ratio | | Not measured | Not measured | Not measured | Not measured | Not measured | Not measured | Not measured |
| Appearance | | Colorless and | Colorless and | Colorless and | Colorless and | Colorless and | Colorless and | Colorless and |
| | | transparent | transparent | transparent | transparent | transparent | transparent | transparent |

Rate of change before and after crystallization[%]

| | | | | | | | |
|---|---|---|---|---|---|---|---|
| 200 nm | 51.5 | 63.3 | Not measured | Not measured | Not measured | Not measured | Not measured |
| 250 nm | 22.9 | 50.6 | Not measured | Not measured | Not measured | Not measured | Not measured |
| 300 nm | 1.1 | 33.3 | Not measured | Not measured | Not measured | Not measured | Not measured |
| 325 nm | 3.8 | 19.3 | Not measured | Not measured | Not measured | Not measured | Not measured |
| 350 nm | 1.7 | 6.6 | Not measured | Not measured | Not measured | Not measured | Not measured |
| 380 nm | 1.7 | 3.6 | Not measured | Not measured | Not measured | Not measured | Not measured |
| 800 nm | 0.2 | 0.3 | Not measured | Not measured | Not measured | Not measured | Not measured |
| 1200 nm | 0.4 | 0.5 | Not measured | Not measured | Not measured | Not measured | Not measured |

TABLE 11

| | | | | | | | | | |
|---|---|---|---|---|---|---|---|---|---|
| No.34 | No.35 | No.36 | No.37 | No.38 | No.39 | No.40 | No.41 | No.42 | No.43 |

| Composition | SiO₂ | 66.5 | | 66.2 |
|---|---|---|---|---|
| [wt %] | Al₂O₃ | 22.0 | | 22.2 |
| | B₂O₃ | 0.00 | | 0.00 |
| | P₂O₅ | 1.42 | | 1.40 |
| | Li₂O | 3.50 | | 2.35 |
| | Na₂O | 0.40 | | 0.40 |
| | K₂O | 0.00 | | 0.30 |
| | MgO | 1.20 | | 1.20 |
| | CaO | 0.00 | | 0.00 |
| | SrO | 0.01 | | 0.00 |
| | BaO | 0.00 | | 1.20 |
| | ZnO | 0.00 | | 0.00 |
| | TiO₂ | 0.0058 | | 0.0072 |
| | SnO₂ | 1.33 | | 1.30 |
| | ZrO₂ | 3.00 | | 2.99 |
| | Fe₂O₃ | 0.0057 | | 0.0066 |
| | Y₂O₃ | 0.00 | | 0.00 |
| | MoO₃ | 0.0000 | | 0.0000 |
| | Sb₂O₃ | 0.00 | | 0.00 |
| | As₂O₃ | 0.00 | | 0.00 |
| Composition | Pt | 0.01 | 0.00 | 1.90 |
| [ppm] | Rh | 0.03 | 0.00 | 0.05 |
| | Pt + Rh | 0.04 | 0.00 | 1.95 |

| | | |
|---|---|---|
| Sn/(P + B + Zr + Ti + Sn) | 0.231 | 0.228 |
| Al/(Zr + Sn) | 5.08 | 5.17 |
| (Mg + Zn)/Li | 0.343 | 0.511 |
| Sn/(Zr + Sn) | 0.31 | 0.30 |
| (Si + Al)/Li | 25.29 | 37.62 |
| (Si + Al)/Sn | 66.54 | 68.00 |
| (Li + Na + K)/Zr | 1.30 | 1.02 |
| Ti/Zr | 0.0019 | 0.0024 |
| Ti/(Ti + Fe) | 0.504 | 0.522 |
| Na + K + Ca + Sr + Ba | 0.41 | 1.90 |
| (Mg + Ca + Sr + Ba)/Zr | 0.40 | 0.80 |
| (Mg + Ca + Sr + Ba)/(Li + Na + K) | 0.31 | 0.79 |
| Al/(Li + (1/2*(Mg + Zn)) | 6.89 | 10.05 |
| Sb + As | 0.00 | 0.00 |

Before crystallization

| Transmittance[%] | 200 nm | 82.2 | Not measured | 81.5 |
|---|---|---|---|---|
| 3 mm thickness | 250 nm | 25.0 | Not measured | 23.7 |
| | 300 nm | 36.2 | Not measured | 30.6 |
| | 325 nm | 72.5 | Not measured | 68.1 |
| | 350 nm | 86.3 | Not measured | 85.0 |
| | 380 nm | 90.0 | Not measured | 89.9 |
| | 800 nm | 91.6 | Not measured | 91.6 |
| | 1200 nm | 91.7 | Not measured | 91.6 |
| L* | | 96.6 | Not measured | 96.6 |
| a* | | 0.0 | Not measured | −0.1 |
| b* | | 0.3 | Not measured | 0.4 |
| Low temperature | Strain point[° C.] | Not measured | Not measured | 695 |
| viscosity | Annealing point[° C.] | Not measured | Not measured | 754 |
| | Glass transition point[° C.] | 742 | Not measured | Not measured |
| High temperature | 10\hat{ }4[° C.] | Not measured | Not measured | 1364 |
| viscosity | 10\hat{ }3[° C.] | Not measured | Not measured | 1542 |
| | 10\hat{ }2.5[° C.] | Not measured | Not measured | 1658 |
| | 10\hat{ }2[° C.] | Not measured | Not measured | Not measured |

| | | | |
|---|---|---|---|
| Liquidus temperature[° C.] | Not measured | Not measured | 1440 |
| Liquidus viscosity[−] | Not measured | Not measured | 3.53 |

| | | | |
|---|---|---|---|
| α[× 10⁻⁷/° C.] | 30-380° C. | 37.1 | Not measured |

| | | |
|---|---|---|
| Density[g/cm3] | 2.431 | 2.460 |
| β-OH[/mm] | 0.19 | 0.19 |

TABLE 12

| | | | | |
|---|---|---|---|---|
| No.34 | No.35 | No.36 | No.37 | No.38 |

After crystallization

| Crystallization condition | | 780° C.-3 h | 780° C.-3 h | 810° C.-0.75 h | 810° C.-0.75 h | 825° C.-0.75 h |
|---|---|---|---|---|---|---|
| | | 890° C.-1 h | 920° C.-1 h | 920° C.-0.25 h | 935° C.-0.25 h | 935° C.-0.25 h |
| Transmittance[%] | 200 nm | 35.5 | 30.2 | 32.9 | 31.4 | 38.1 |
| 3 mm thickness | 250 nm | 15.8 | 14.5 | 15.9 | 16.0 | 18.9 |
| | 300 nm | 35.5 | 22.0 | 23.4 | 23.9 | 23.2 |
| | 325 nm | 67.7 | 66.5 | 64.4 | 65.4 | 60.8 |
| | 350 nm | 84.5 | 83.8 | 81.5 | 81.9 | 78.2 |
| | 380 nm | 88.6 | 88.1 | 86.6 | 86.9 | 84.4 |
| | 800 nm | 91.4 | 91.4 | 91.4 | 91.4 | 91.3 |
| | 1200 nm | 91.3 | 91.3 | 91.3 | 91.3 | 91.5 |
| L* | | 96.3 | 96.3 | 96.2 | 96.2 | 96.0 |
| a* | | 0.0 | 0.0 | 0.0 | 0.0 | −0.1 |
| b* | | 0.5 | 0.6 | 0.8 | 0.8 | 1.2 |
| Precipitated crystal | | β-Q | β-Q | β-Q | β-Q | β-Q |
| Average crystallite size[nm] | | 41 | Not measured | Not measured | Not measured | Not measured |
| α[× 10⁻⁷/° C.] | 30-380° C. | −1.7 | −1.6 | −1.7 | Not measured | Not measured |
| α[× 10⁻⁷/° C.] | 30-750° C. | −1.1 | −1.0 | −1.1 | Not measured | Not measured |

| | | | | | |
|---|---|---|---|---|---|
| Density[g/cm3] | 2.521 | Not measured | Not measured | Not measured | 2.521 |
| Young's Modulus[GPa] | Not measured | Not measured | Not measured | Not measured | Not measured |
| Modulus of rigidity[GPa] | Not measured | Not measured | Not measured | Not measured | Not measured |
| Poisson's ratio | Not measured | Not measured | Not measured | Not measured | Not measured |

| | |
|---|---|
| Appearance | Colorless and transparent |

Rate of change before and after crystallization[%]

| | | | | | | |
|---|---|---|---|---|---|---|
| Transmittance | 200 nm | 56.8 | 63.3 | 59.9 | 61.8 | 53.6 |
| 3 mm thickness | 250 nm | 36.7 | 42.1 | 36.6 | 36.1 | 24.6 |
| | 300 nm | 2.0 | 39.1 | 35.4 | 33.9 | 35.8 |
| | 325 nm | 6.6 | 8.3 | 11.1 | 9.8 | 16.1 |
| | 350 nm | 2.1 | 3.0 | 5.6 | 5.1 | 9.4 |
| | 380 nm | 1.5 | 2.1 | 3.8 | 3.5 | 6.2 |
| | 800 nm | 0.1 | 0.2 | 0.1 | 0.2 | 0.2 |
| | 1200 nm | 0.5 | 0.5 | 0.5 | 0.5 | 0.2 |

| | | | | |
|---|---|---|---|---|
| No.39 | No.40 | No . 41 | No.42 | No.43 |

After crystallization

| Crystallization condition | | 825° C.-0.75 h | 810° C.-1.5 h | 810° C.-1.5 h | 810° C.-1.5 h | 840° C.-1.5 h |
|---|---|---|---|---|---|---|
| | | 935° C.-0.25 h | 920° C.-1 h | 935° C.-1 h | 950° C.-1 h | 920° C.-1 h |
| Transmittance[%] | 200 nm | Not measured | Not measured | Not measured | Not measured | Not measured |
| 3 mm thickness | 250 nm | Not measured | Not measured | Not measured | Not measured | Not measured |
| | 300 nm | 23.2 | 23.2 | 24.3 | 23.5 | 20.2 |
| | 325 nm | Not measured | 60.8 | 47.1 | 50.1 | 45.7 |
| | 350 nm | Not measured | 78.2 | 59.5 | 64.0 | 60.7 |
| | 380 nm | Not measured | Not measured | Not measured | Not measured | Not measured |
| | 800 nm | Not measured | Not measured | Not measured | Not measured | Not measured |
| | 1200 nm | Not measured | Not measured | Not measured | Not measured | Not measured |
| L* | | Not measured | Not measured | Not measured | Not measured | Not measured |
| a* | | Not measured | Not measured | Not measured | Not measured | Not measured |
| b* | | Not measured | Not measured | Not measured | Not measured | Not measured |
| Precipitated crystal | | β-Q | β-Q | β-Q | β-Q | β-Q |
| Average crystallite size[nm] | | Not measured | Not measured | Not measured | Not measured | Not measured |
| α[× 10⁻⁷/° C.] | 30-380° C. | Not measured | 12.2 | 13.6 | 15.4 | 12.0 |
| α[× 10⁻⁷/° C.] | 30-750° C. | Not measured | Not measured | Not measured | Not measured | Not measured |

| | | | | | |
|---|---|---|---|---|---|
| Density[g/cm3] | 2.514 | Not measured | Not measured | Not measured | Not measured |
| Young's Modulus[GPa] | Not measured | Not measured | Not measured | Not measured | Not measured |
| Modulus of rigidity[GPa] | Not measured | Not measured | Not measured | Not measured | Not measured |
| Poisson's ratio | Not measured | Not measured | Not measured | Not measured | Not measured |

| | | |
|---|---|---|
| Appearance | Colorless and | Colorless and transparent |
| | transparent | |

Rate of change before and after crystallization[%]

| | | | | | | |
|---|---|---|---|---|---|---|
| Transmittance | 200 nm | 53.6 | Not measured | Not measured | Not measured | Not measured |
| 3 mm thickness | 250 nm | 24.6 | Not measured | Not measured | Not measured | Not measured |
| | 300 nm | 35.8 | 7.3 | 6.3 | 7.0 | 10.3 |
| | 325 nm | 16.1 | 7.3 | 21.0 | 18.0 | 22.4 |
| | 350 nm | 9.4 | 6.8 | 25.5 | 21.1 | 24.4 |
| | 380 nm | 6.2 | Not measured | Not measured | Not measured | Not measured |
| | 800 nm | 0.2 | Not measured | Not measured | Not measured | Not measured |
| | 1200 nm | 0.2 | Not measured | Not measured | Not measured | Not measured |

TABLE 13

| | | No.44 | No.45 | No.46 | No.47 | No.48 | No.49 | No.50 |
|---|---|---|---|---|---|---|---|---|
| Composition | SiO₂ | 66.60 | 64.4 | 67.0 | 66.9 | 66.9 | 66.7 | 67.0 |
| [wt %] | Al₂O₃ | 22.3 | 24.0 | 22.3 | 22.4 | 22.5 | 22.2 | 22.3 |
| | B₂O₃ | 0.00 | 0.00 | 0.02 | 0.00 | 0.00 | 0.00 | 0.00 |
| | P₂O₅ | 1.42 | 1.61 | 1.33 | 1.34 | 1.34 | 1.41 | 1.36 |
| | Li₂O | 3.65 | 3.85 | 3.59 | 3.64 | 3.61 | 3.60 | 3.68 |
| | Na₂O | 0.65 | 0.62 | 0.39 | 0.40 | 0.39 | 0.38 | 0.39 |
| | K₂O | 0.01 | 0.01 | 0.005 | 0.007 | 0.001 | 0.0001 | 0.0032 |
| | MgO | 1.05 | 1.38 | 1.26 | 1.31 | 1.32 | 1.32 | 1.17 |
| | CaO | 0.00 | 0.00 | 0.002 | 0.01 | 0.00 | 0.0007 | 0.00 |
| | SrO | 0.00 | 0.00 | 0.00 | 0.0012 | 0.01 | 0.00 | 0.00 |
| | BaO | 0.45 | 0.00 | 0.03 | 0.00 | 0.01 | 0.01 | 0.0008 |
| | ZnO | 0.0000 | 0.00 | 0.00 | 0.00 | 0.02 | 0.0001 | 0.00 |
| | TiO₂ | 0.0181 | 0.0147 | 0.0044 | 0.0048 | 0.0132 | 0.0222 | 0.0058 |
| | SnO₂ | 1.19 | 1.20 | 1.20 | 1.18 | 1.15 | 1.28 | 1.19 |
| | ZrO₂ | 2.57 | 2.69 | 2.57 | 2.61 | 2.62 | 2.94 | 2.73 |
| | Fe₂O₃ | 0.0132 | 0.0112 | 0.0085 | 0.0093 | 0.0095 | 0.0110 | 0.0082 |
| | Y₂O₃ | 0.00 | 0.00 | 0.00 | 0.00 | 0.00 | 0.00 | 0.00 |
| | MoO₃ | 0.0000 | 0.0000 | 0.0000 | 0.0000 | 0.0000 | 0.0000 | 0.0000 |
| | Sb₂O₃ | 0.00 | 0.00 | 0.00 | 0.00 | 0.00 | 0.00 | 0.00 |
| | As₂O₃ | 0.00 | 0.00 | 0.00 | 0.00 | 0.00 | 0.00 | 0.00 |
| Composition | Pt | 0.01 | 0.00 | 0.15 | 0.15 | 0.15 | 0.15 | 0.15 |
| [ppm] | Rh | 0.02 | 0.01 | 0.05 | 0.05 | 0.05 | 0.05 | 0.05 |
| | Pt + Rh | 0.03 | 0.01 | 0.20 | 0.20 | 0.20 | 0.20 | 0.20 |

| | | | | | | | |
|---|---|---|---|---|---|---|---|
| Sn/(P + B + Zr + Ti + Sn) | 0.229 | 0.218 | 0.234 | 0.230 | 0.224 | 0.226 | 0.225 |
| Al/(Zr + Sn) | 5.93 | 6.17 | 5.92 | 5.91 | 5.97 | 5.26 | 5.69 |
| (Mg + Zn)/Li | 0.288 | 0.358 | 0.351 | 0.360 | 0.372 | 0.367 | 0.318 |
| Sn/(Zr + Sn) | 0.32 | 0.31 | 0.32 | 0.31 | 0.31 | 0.30 | 0.30 |
| (Si + Al)/Li | 24.36 | 22.96 | 24.87 | 24.53 | 24.76 | 24.69 | 24.27 |
| (Si + Al)/Sn | 74.71 | 73.67 | 74.42 | 75.68 | 77.74 | 69.45 | 75.04 |
| (Li + Na + K)/Zr | 1.68 | 1.67 | 1.55 | 1.55 | 1.53 | 1.35 | 1.49 |
| Ti/Zr | 0.0070 | 0.0055 | 0.0017 | 0.0018 | 0.0050 | 0.0076 | 0.0021 |
| Ti/(Ti + Fe) | 0.578 | 0.568 | 0.341 | 0.340 | 0.581 | 0.669 | 0.414 |
| Na + K + Ca + Sr + Ba | 1.11 | 0.63 | 0.43 | 0.42 | 0.41 | 0.39 | 0.39 |
| (Mg + Ca + Sr + Ba)/Zr | 0.58 | 0.51 | 0.50 | 0.51 | 0.51 | 0.45 | 0.43 |
| (Mg + Ca + Sr + Ba)/(Li + Na + K) | 0.35 | 0.31 | 0.32 | 0.33 | 0.33 | 0.33 | 0.29 |
| Al/(Li + (1/2*(Mg + Zn)) | 6.63 | 6.92 | 6.84 | 6.81 | 6.90 | 6.83 | 6.64 |
| Sb + As | 0.00 | 0.00 | 0.00 | 0.00 | 0.00 | 0.00 | 0.00 |

Before crystallization

| Transmittance[%] | 200 nm | Not | Not | Not | Not | Not | Not | Not |
|---|---|---|---|---|---|---|---|---|
| 3 mm thickness | | measured | measured | measured | measured | measured | measured | measured |
| | 250 nm | Not | Not | Not | Not | Not | Not | Not |
| | | measured | measured | measured | measured | measured | measured | measured |
| | 300 nm | Not | Not | Not | Not | Not | Not | Not |
| | | measured | measured | measured | measured | measured | measured | measured |
| | 325 nm | Not | Not | Not | Not | Not | Not | Not |
| | | measured | measured | measured | measured | measured | measured | measured |
| | 350 nm | Not | Not | Not | Not | Not | Not | Not |
| | | measured | measured | measured | measured | measured | measured | measured |
| | 380 nm | Not | Not | Not | Not | Not | Not | Not |
| | | measured | measured | measured | measured | measured | measured | measured |
| | 800 nm | Not | Not | Not | Not | Not | Not | Not |
| | | measured | measured | measured | measured | measured | measured | measured |
| | 1200 nm | Not | Not | Not | Not | Not | Not | Not |
| | | measured | measured | measured | measured | measured | measured | measured |
| L* | | Not | Not | Not | Not | Not | Not | Not |
| | | measured | measured | measured | measured | measured | measured | measured |
| a* | | Not | Not | Not | Not | Not | Not | Not |
| | | measured | measured | measured | measured | measured | measured | measured |
| b* | | Not | Not | Not | Not | Not | Not | Not |
| | | measured | measured | measured | measured | measured | measured | measured |
| Low temperature | Strain point[° C.] | Not | Not | Not | Not | Not | Not | Not |
| viscosity | | measured | measured | measured | measured | measured | measured | measured |
| | Annealing point[° C.] | Not | Not | Not | Not | Not | Not | Not |
| | | measured | measured | measured | measured | measured | measured | measured |
| | Glass transition point[° C.] | Not | Not | Not | Not | Not | Not | Not |
| | | measured | measured | measured | measured | measured | measured | measured |
| High temperature | 10\hat{ }4[° C.] | Not | Not | Not | Not | Not | Not | Not |
| viscosity | | measured | measured | measured | measured | measured | measured | measured |
| | 10\hat{ }3[° C.] | Not | Not | Not | Not | Not | Not | Not |
| | | measured | measured | measured | measured | measured | measured | measured |
| | 10\hat{ }2.5[° C.] | Not | Not | Not | Not | Not | Not | Not |
| | | measured | measured | measured | measured | measured | measured | measured |
| | 10\hat{ }2[° C.] | Not | Not | Not | Not | Not | Not | Not |
| | | measured | measured | measured | measured | measured | measured | measured |
| Liquidus temperature[° C.] | | Not | Not | Not | Not | Not | Not | Not |
| | | measured | measured | measured | measured | measured | measured | measured |
| Liquidus viscosity[−] | | Not | Not | Not | Not | Not | Not | Not |
| | | measured | measured | measured | measured | measured | measured | measured |
| α[× 10⁻⁷/° C.] | 30-380° C. | Not | Not | Not | Not | Not | Not | Not |
| | | measured | measured | measured | measured | measured | measured | measured |

| | | | | | | | |
|---|---|---|---|---|---|---|---|
| Density[g/cm3] | Not | Not | 2.427 | 2.4275 | 2.429 | 2.435 | Not |
| | measured | measured | | | | | measured |
| β-OH[/mm] | 0.11 | 0.11 | 0.11 | 0.11 | 0.11 | 0.11 | 0.11 |

TABLE 14

| | | | | | | |
|---|---|---|---|---|---|---|
| No.44 | No.45 | No.46 | No.47 | No.48 | No.49 | No.50 |

After crystallization

| Crystallization condition | | 795° C.-3 h | 795° C.-3 h | 780° C.-3 h | 780° C.-3 h | 780° C.-3 h | 780° C.-3 h | 780° C.-3 h |
|---|---|---|---|---|---|---|---|---|
| | | 890° C.-1 h | 890° C.-1 h | 890° C.-1 h | 890° C.-1 h | 890° C.-1 h | 890° C.-1 h | 890° C.-1 h |
| Transmittance[%] | 200 nm | Not measured | Not measured | Not measured | Not measured | Not measured | Not measured | Not measured |
| 3 mm thickness | 250 nm | Not measured | Not measured | Not measured | Not measured | Not measured | Not measured | Not measured |
| | 300 nm | Not measured | Not measured | Not measured | Not measured | Not measured | Not measured | Not measured |
| | 325 nm | Not measured | Not measured | Not measured | Not measured | Not measured | Not measured | Not measured |
| | 350 nm | Not measured | Not measured | Not measured | Not measured | Not measured | Not measured | Not measured |
| | 380 nm | Not measured | Not measured | Not measured | Not measured | Not measured | Not measured | Not measured |
| | 800 nm | Not measured | Not measured | Not measured | Not measured | Not measured | Not measured | Not measured |
| | 1200 nm | Not measured | Not measured | Not measured | Not measured | Not measured | Not measured | Not measured |
| L* | | Not measured | Not measured | Not measured | Not measured | Not measured | Not measured | Not measured |
| a* | | Not measured | Not measured | Not measured | Not measured | Not measured | Not measured | Not measured |
| b* | | Not measured | Not measured | Not measured | Not measured | Not measured | Not measured | Not measured |
| Precipitated crystal | | β-Q | β-Q | β-Q | β-Q | β-Q | β-Q | β-Q |
| Average crystallite size[nm] | | Not measured | Not measured | Not measured | Not measured | Not measured | Not measured | Not measured |
| α[× 10⁻⁷/° C.] | 30-380° C. | Not measured | Not measured | −1.5 | −2.1 | −1.0 | −0.7 | Not measured |
| α[× 10⁻⁷/° C.] | 30-750° C. | Not measured | Not measured | −0.8 | −0.9 | −0.1 | 0.1 | Not measured |

| | | | | | | | |
|---|---|---|---|---|---|---|---|
| Density[g/cm3] | Not measured | Not measured | 2.514 | 2.513 | 2.513 | 2.527 | Not measured |
| Young's Modulus[GPa] | Not measured | Not measured | Not measured | Not measured | Not measured | Not measured | 93 |
| Modulus of rigidity[GPa] | Not measured | Not measured | Not measured | Not measured | Not measured | Not measured | 38 |
| Poisson's ratio | Not measured | Not measured | Not measured | Not measured | Not measured | Not measured | 0.22 |
| Appearance | Colorless and | Colorless and | Colorless and | Colorless and | Colorless and | Colorless and | Colorless and |
| | transparent | transparent | transparent | transparent | transparent | transparent | transparent |

Rate of change before and after crystallization[%]

| | | | | | | | |
|---|---|---|---|---|---|---|---|
| 200 nm | Not measured | Not measured | Not measured | Not measured | Not measured | Not measured | Not measured |
| 250 nm | Not measured | Not measured | Not measured | Not measured | Not measured | Not measured | Not measured |
| 300 nm | Not measured | Not measured | Not measured | Not measured | Not measured | Not measured | Not measured |
| 325 nm | Not measured | Not measured | Not measured | Not measured | Not measured | Not measured | Not measured |
| 350 nm | Not measured | Not measured | Not measured | Not measured | Not measured | Not measured | Not measured |
| 380 nm | Not measured | Not measured | Not measured | Not measured | Not measured | Not measured | Not measured |
| 800 nm | Not measured | Not measured | Not measured | Not measured | Not measured | Not measured | Not measured |
| 1200 nm | Not measured | Not measured | Not measured | Not measured | Not measured | Not measured | Not measured |

TABLE 15

| | | No.51 | No.52 | No.53 | No.54 | No.55 | No.56 | No.57 |
|---|---|---|---|---|---|---|---|---|
| Composition | SiO₂ | 65.20 | 65.0 | 65.3 | 64.6 | 65.8 | 65.1 | 64.8 |
| [wt %] | Al₂O₃ | 21.8 | 21.8 | 21.9 | 21.5 | 22.1 | 21.8 | 21.7 |
| | B₂O₃ | 0.00 | 0.00 | 0.00 | 0.00 | 0.00 | 0.00 | 0.00 |
| | P₂O₅ | 1.38 | 1.38 | 1.39 | 1.37 | 1.41 | 1.39 | 1.38 |
| | Li₂O | 3.66 | 3.65 | 3.66 | 3.63 | 3.70 | 3.66 | 3.64 |
| | Na₂O | 0.85 | 0.39 | 0.39 | 0.40 | 0.40 | 0.39 | 0.39 |
| | K₂O | 0.30 | 0.99 | 0.28 | 0.29 | 0.00 | 0.30 | 0.30 |
| | MgO | 0.68 | 0.68 | 0.95 | 0.65 | 1.23 | 0.68 | 0.67 |
| | CaO | 0.001 | 0.001 | 0.001 | 0.001 | 0.001 | 0.001 | 0.001 |
| | SrO | 0.00 | 0.00 | 0.00 | 0.00 | 0.002 | 0.002 | 0.002 |
| | BaO | 1.16 | 1.15 | 1.19 | 2.64 | 1.23 | 1.21 | 1.2300 |
| | ZnO | 0.001 | 0.001 | 0.001 | 0.001 | 0.00 | 0.00 | 0.00 |
| | TiO₂ | 0.0092 | 0.0113 | 0.0321 | 0.0140 | 0.0029 | 0.0201 | 0.0140 |
| | SnO₂ | 1.36 | 1.39 | 1.36 | 1.37 | 1.27 | 1.85 | 2.24 |
| | ZrO₂ | 3.70 | 3.64 | 3.71 | 3.64 | 2.98 | 3.68 | 3.71 |
| | Fe₂O₃ | 0.0080 | 0.0075 | 0.0083 | 0.0081 | 0.0082 | 0.0078 | 0.0084 |
| | Y₂O₃ | 0.00 | 0.00 | 0.00 | 0.00 | 0.00 | 0.00 | 0.00 |
| | MoO₃ | 0.0000 | 0.0000 | 0.0000 | 0.0000 | 0.0000 | 0.0000 | 0.0000 |
| | Sb₂O₃ | 0.00 | 0.00 | 0.00 | 0.00 | 0.00 | 0.00 | 0.00 |
| | As₂O₃ | 0.00 | 0.00 | 0.00 | 0.00 | 0.00 | 0.00 | 0.00 |
| Composition | Pt | 0.41 | 0.01 | 0.20 | 0.11 | 0.05 | 0.09 | 0.07 |
| [ppm] | Rh | 0.00 | 0.01 | 0.02 | 0.02 | 0.02 | 0.02 | 0.02 |
| | Pt + Rh | 0.41 | 0.02 | 0.22 | 0.13 | 0.07 | 0.11 | 0.09 |

| | | | | | | | |
|---|---|---|---|---|---|---|---|
| Sn/(P + B + Zr + Ti + Sn) | 0.211 | 0.216 | 0.210 | 0.214 | 0.224 | 0.267 | 0.305 |
| Al/(Zr + Sn) | 4.31 | 4.33 | 4.31 | 4.29 | 5.20 | 3.94 | 3.65 |
| (Mg + Zn)/Li | 0.186 | 0.187 | 0.260 | 0.179 | 0.332 | 0.186 | 0.184 |
| Sn/(Zr + Sn) | 0.27 | 0.28 | 0.27 | 0.27 | 0.30 | 0.33 | 0.38 |
| (Si + Al)/Li | 23.77 | 23.78 | 23.83 | 23.72 | 23.76 | 23.74 | 23.76 |
| (Si + Al)/Sn | 63.97 | 62.45 | 63.98 | 62.85 | 69.21 | 46.97 | 38.62 |
| (Li + Na + K)/Zr | 1.30 | 1.38 | 1.17 | 1.19 | 1.38 | 1.18 | 1.17 |
| Ti/Zr | 0.0025 | 0.0031 | 0.0086 | 0.0038 | 0.0010 | 0.0055 | 0.0038 |
| Ti/(Ti + Fe) | 0.535 | 0.601 | 0.795 | 0.633 | 0.261 | 0.720 | 0.625 |
| Na + K + Ca + Sr + Ba | 2.31 | 2.53 | 1.86 | 3.33 | 1.63 | 1.90 | 1.92 |
| (Mg + Ca + Sr + Ba)/Zr | 0.50 | 0.50 | 0.58 | 0.90 | 0.83 | 0.51 | 0.51 |
| (Mg + Ca + Sr + Ba)/(Li + Na + K) | 0.38 | 0.36 | 0.49 | 0.76 | 0.60 | 0.44 | 0.44 |
| Al/(Li + (1/2*(Mg + Zn)) | 6.30 | 6.31 | 6.46 | 6.25 | 6.59 | 6.30 | 6.30 |
| Sb + As | 0.00 | 0.00 | 0.00 | 0.00 | 0.00 | 0.00 | 0.00 |

Before crystallization

| Transmittance[%] | 200 nm | Not | 69.1 | 73.0 | 72.4 | 78.3 | 65.1 | 59.6 |
|---|---|---|---|---|---|---|---|---|
| 3 mm thickness | | measured | | | | | | |
| | 250 nm | Not | 20.7 | 21.8 | 21.1 | 23.3 | 20.2 | 18.8 |
| | | measured | | | | | | |
| | 300 nm | Not | 27.9 | 32.3 | 27.9 | 30.6 | 22.8 | 17.7 |
| | | measured | | | | | | |
| | 325 nm | Not | 65.9 | 70.3 | 65.9 | 68.0 | 62.9 | 58.6 |
| | | measured | | | | | | |
| | 350 nm | Not | 83.9 | 85.6 | 84.0 | 84.8 | 83.2 | 82.0 |
| | | measured | | | | | | |
| | 380 nm | Not | 89.3 | 89.8 | 89.4 | 89.7 | 89.0 | 88.6 |
| | | measured | | | | | | |
| | 800 nm | Not | 91.4 | 91.6 | 91.5 | 91.5 | 91.4 | 91.3 |
| | | measured | | | | | | |
| | 1200 nm | Not | 91.2 | 91.6 | 91.4 | 91.8 | 91.7 | 91.7 |
| | | measured | | | | | | |
| L* | | Not | 96.6 | 96.6 | 96.6 | 96.6 | 96.5 | 96.5 |
| | | measured | | | | | | |
| a* | | Not | −0.1 | −0.1 | −0.1 | 0.0 | −0.1 | −0.1 |
| | | measured | | | | | | |
| b* | | Not | 0.4 | 0.3 | 0.4 | 0.3 | 0.4 | 0.5 |
| | | measured | | | | | | |
| Low temperature | Strain point[° C.] | 674 | 674 | 678 | 680 | Not | Not | Not |
| viscosity | | | | | | measured | measured | measured |
| | Annealing point[° C.] | 733 | 733 | 736 | 739 | Not | Not | Not |
| | | | | | | measured | measured | measured |
| | Glass transition point[° C.] | 733 | 730 | 732 | 733 | 724 | 726 | 728 |
| High temperature | 10\hat{ }4[° C.] | 1346 | 1346 | 1341 | 1345 | 1343 | 1348 | 1345 |
| viscosity | 10\hat{ }3[° C.] | 1526 | 1524 | 1518 | 1523 | 1523 | 1527 | 1524 |
| | 10\hat{ }2.5[° C.] | 1641 | 1639 | 1630 | 1630 | 1636 | 1639 | 1638 |
| | 10\hat{ }2[° C.] | 1778 | 1777 | 1762 | 1762 | 1768 | 1769 | 1773 |
| Liquidus temperature[° C.] | | Not | Not | 1493 | Not | Not | Not | Not |
| | | measured | measured | | measured | measured | measured | measured |
| Liquidus viscosity[−] | | Not | Not | 3.1 | Not | Not | Not | Not |
| | | measured | measured | | measured | measured | measured | measured |
| α[× 10⁻⁷/° C.] | 30-380° C. | 42.2 | 42.4 | 40.7 | 41.7 | 39.6 | 39.4 | 39.7 |

| | | | | | | | |
|---|---|---|---|---|---|---|---|
| Density[g/cm3] | 2.463 | 2.462 | 2.465 | 2.484 | 2.450 | 2.463 | 2.469 |
| β-OH[/mm] | 0.14 | 0.14 | 0.14 | 0.14 | 0.14 | 0.14 | 0.14 |

TABLE 16

| | | | | | | |
|---|---|---|---|---|---|---|
| No.51 | No.52 | No.53 | No.54 | No.55 | No.56 | No.57 |

After crystallization

| Crystallization condition | | 855° C.-3 h | 855° C.-3 h | 840° C.-3 h | 840° C.-3 h | 765° C.-3 h | 810° C.-3 h | 810° C.-3 h |
|---|---|---|---|---|---|---|---|---|
| | | 920° C.-1 h | 920° C.-1 h | 920° C.-1 h | 920° C.-1 h | 890° C.-1 h | 920° C.-1 h | 920° C.-1 h |
| Transmittance[%] | 200 nm | Not measured | Not measured | Not measured | Not measured | Not measured | 36.9 | 37.7 |
| 3 mm thickness | 250 nm | Not measured | 20.1 | 14.5 | 16.1 | Not measured | 14.6 | 13.2 |
| | 300 nm | Not measured | 18.1 | 17.7 | 17.9 | 20.4 | 14.4 | 11.2 |
| | 325 nm | Not measured | 41.4 | 54.9 | 52.6 | 58.8 | 52.5 | 49.6 |
| | 350 nm | Not measured | Not measured | Not measured | Not measured | 75.8 | 72.8 | 73.8 |
| | 380 nm | Not measured | Not measured | Not measured | Not measured | 81.5 | 79.3 | 80.8 |
| | 800 nm | Not measured | Not measured | Not measured | Not measured | 90.4 | 90.4 | 90.4 |
| | 1200 nm | Not measured | Not measured | Not measured | Not measured | 90.9 | 90.9 | 91.1 |
| L* | | Not measured | Not measured | Not measured | Not measured | 95.2 | 94.9 | 95.1 |
| a* | | Not measured | Not measured | Not measured | Not measured | 0.1 | 0.1 | 0.1 |
| b* | | Not measured | Not measured | Not measured | Not measured | 1.8 | 2.4 | 2.1 |
| Precipitated crystal | | β-Q | β-Q | β-Q | β-Q | β-Q | β-Q | β-Q |
| Average crystallite size[nm] | | 47 | Not measured | Not measured | Not measured | Not measured | Not measured | Not measured |
| α[× 10⁻⁷/° C.] | 30-380° C. | 1.4 | 2.5 | 0.9 | 1.4 | 1.1 | −0.9 | −1.0 |
| α[× 10⁻⁷/° C.] | 30-750° C. | 3.4 | 4.7 | 2.5 | 3.2 | 1.9 | 0.6 | 0.5 |

| | | | | | | | |
|---|---|---|---|---|---|---|---|
| Density[g/cm3] | 2.525 | 2.519 | 2.539 | 2.549 | 2.534 | 2.542 | 2.548 |
| Young's Modulus[GPa] | Not measured | Not measured | Not measured | Not measured | Not measured | Not measured | Not measured |
| Modulus of rigidity[GPa] | Not measured | Not measured | Not measured | Not measured | Not measured | Not measured | Not measured |
| Poisson's ratio | Not measured | Not measured | Not measured | Not measured | Not measured | Not measured | Not measured |
| Appearance | Colorless and | Colorless and | Colorless and | Colorless and | Colorless and | Colorless and | Colorless and |
| | transparent | transparent | transparent | transparent | transparent | transparent | transparent |

Rate of change before and after crystallization[%]

| | | | | | | | |
|---|---|---|---|---|---|---|---|
| 200 nm | Not measured | Not measured | Not measured | Not measured | Not measured | 43.3 | 36.8 |
| 250 nm | Not measured | 2.7 | 33.6 | 23.9 | Not measured | 27.7 | 29.9 |
| 300 nm | Not measured | 35.0 | 45.2 | 35.9 | 33.4 | 36.8 | 36.6 |
| 325 nm | Not measured | 37.1 | 21.9 | 20.2 | 13.6 | 16.6 | 15.3 |
| 350 nm | Not measured | Not measured | Not measured | Not measured | 10.6 | 12.4 | 10.0 |
| 380 nm | Not measured | Not measured | Not measured | Not measured | 9.1 | 11.0 | 8.8 |
| 800 nm | Not measured | Not measured | Not measured | Not measured | 1.2 | 1.2 | 1.0 |
| 1200 nm | Not measured | Not measured | Not measured | Not measured | 1.0 | 0.9 | 0.6 |

TABLE 17

| | | No. 58 | No. 59 | No. 60 | No. 61 |
|---|---|---|---|---|---|
| Composition | SiO₂ | 65.20 | 64.9 | 64.5 | 64.6 |
| [wt %] | Al₂O₃ | 22.5 | 22.4 | 22.5 | 22.6 |
| | B₂O₃ | 0.00 | 0.00 | 0.00 | 0.00 |
| | P₂O₅ | 1.38 | 1.38 | 1.89 | 1.37 |
| | Li₂O | 3.66 | 3.81 | 3.66 | 3.63 |
| | Na₂O | 0.85 | 0.39 | 0.49 | 0.40 |
| | K₂O | 0.35 | 0.79 | 0.28 | 0.29 |
| | MgO | 1.08 | 0.68 | 0.85 | 0.85 |
| | CaO | 0.001 | 0.001 | 0.001 | 0.001 |
| | SrO | 0.00 | 0.00 | 0.00 | 0.00 |
| | BaO | 1.16 | 1.15 | 1.19 | 2.60 |
| | ZnO | 0.001 | 0.82 | 0.50 | 0.001 |
| | TiO₂ | 0.0092 | 0.0113 | 0.0321 | 0.0140 |
| | SnO₂ | 1.13 | 1.11 | 1.52 | 1.10 |
| | ZrO₂ | 2.58 | 2.55 | 2.49 | 2.57 |
| | Fe₂O₃ | 0.0080 | 0.0075 | 0.0083 | 0.0081 |
| | Y₂O₃ | 0.00 | 0.00 | 0.00 | 0.00 |
| | MoO₃ | 0.0000 | 0.0000 | 0.0000 | 0.0000 |
| | Sb₂O₃ | 0.00 | 0.00 | 0.00 | 0.00 |
| | As₂O₃ | 0.00 | 0.00 | 0.00 | 0.00 |
| Composition | Pt | 0.09 | 0.01 | 0.07 | 0.05 |
| [ppm] | Rh | 0.02 | 0.01 | 0.02 | 0.02 |
| | Pt + Rh | 0.11 | 0.02 | 0.09 | 0.07 |

| | | | | |
|---|---|---|---|---|
| Sn/(P + B + Zr + Ti + Sn) | 0.222 | 0.220 | 0.256 | 0.218 |
| Al/(Zr + Sn) | 6.06 | 6.12 | 5.61 | 6.16 |
| (Mg + Zn)/Li | 0.295 | 0.394 | 0.369 | 0.234 |
| Sn/(Zr + Sn) | 0.30 | 0.30 | 0.38 | 0.30 |
| (Si + Al)/Li | 23.96 | 22.91 | 23.77 | 24.02 |
| (Si + Al)/Sn | 77.61 | 78.65 | 57.24 | 79.27 |
| (Li + Na + K)/Zr | 1.88 | 1.96 | 1.78 | 1.68 |
| Ti/Zr | 0.0036 | 0.0044 | 0.0129 | 0.0054 |
| Ti/(Ti + Fe) | 0.535 | 0.601 | 0.795 | 0.633 |
| Na + K + Ca + Sr + Ba | 2.36 | 2.33 | 1.96 | 3.29 |
| (Mg + Ca + Sr + Ba)/Zr | 0.87 | 0.72 | 0.82 | 1.34 |
| (Mg + Ca + Sr + Ba)/(Li + Na + K) | 0.46 | 0.37 | 0.46 | 0.80 |
| Al/(Li + (1/2*(Mg + Zn)) | 6.69 | 6.63 | 6.82 | 6.65 |
| Sb + As | 0.00 | 0.00 | 0.00 | 0.00 |

Before crystallization

| Transmittance[%] | 200 | nm | Not measured | Not measured | Not measured | Not measured |
|---|---|---|---|---|---|---|
| 3 mm thickness | 250 | nm | Not measured | Not measured | Not measured | Not measured |
| | 300 | nm | Not measured | Not measured | Not measured | Not measured |
| | 325 | nm | Not measured | Not measured | Not measured | Not measured |
| | 350 | nm | Not measured | Not measured | Not measured | Not measured |
| | 380 | nm | Not measured | Not measured | Not measured | Not measured |
| | 800 | nm | Not measured | Not measured | Not measured | Not measured |
| | 1200 | nm | Not measured | Not measured | Not measured | Not measured |
| L* | | | Not measured | Not measured | Not measured | Not measured |
| a* | | | Not measured | Not measured | Not measured | Not measured |
| b* | | | Not measured | Not measured | Not measured | Not measured |
| Low temperature | Strain point[° C.] | | 671 | 673 | 672 | 678 |
| viscosity | Annealing point[° C.] | | 730 | 732 | 734 | 735 |
| | Glass transition point[° C.] | | Not measured | Not measured | Not measured | Not measured |
| High temperature | 10\hat{ }4[° C.] | | Not measured | Not measured | Not measured | Not measured |
| viscosity | 10\hat{ }3[° C.] | | Not measured | Not measured | Not measured | Not measured |
| | 10\hat{ }2.5[° C.] | | Not measured | Not measured | Not measured | Not measured |
| | 10\hat{ }2[° C.] | | Not measured | Not measured | Not measured | Not measured |
| Liquidus temperature[° C.] | | | 1399 | 1390 | 1379 | 1402 |
| Liquidus viscosity[—] | | | Not measured | Not measured | Not measured | Not measured |
| α [×10⁻⁷/° C.] | 30-380° | C. | 43.0 | 43.3 | 42.4 | 41.7 |

| | | | | |
|---|---|---|---|---|
| Density[g/cm3] | Not measured | Not measured | Not measured | Not measured |
| β -OH[/mm] | 0.13 | 0.13 | 0.13 | 0.13 |

TABLE 18

| | | | |
|---|---|---|---|
| No. 58 | No. 59 | No. 60 | No. 61 |

After crystallization

| Crystallization condition | | | 840° C.-5 h | 855° C.-7 h | 840° C.-3 h | 840° C.-8 h |
|---|---|---|---|---|---|---|
| | | | 920° C.-1 h | 920° C.-1 h | 920° C.-1.5 h | 920° C.-1 h |
| Transmittance[%] | 200 | nm | Not measured | Not measured | Not measured | Not measured |
| 3 mm thickness | 250 | nm | Not measured | Not measured | Not measured | Not measured |
| | 300 | nm | Not measured | Not measured | Not measured | Not measured |
| | 325 | nm | Not measured | Not measured | Not measured | Not measured |
| | 350 | nm | Not measured | Not measured | Not measured | Not measured |
| | 380 | nm | Not measured | Not measured | Not measured | Not measured |
| | 800 | nm | Not measured | Not measured | Not measured | Not measured |
| | 1200 | nm | Not measured | Not measured | Not measured | Not measured |
| L* | | | Not measured | Not measured | Not measured | Not measured |
| a* | | | Not measured | Not measured | Not measured | Not measured |
| b* | | | Not measured | Not measured | Not measured | Not measured |
| Precipitated crystal | | | β -Q | β -Q | β -Q | β -Q |
| Average crystallite size[nm] | | | Not measured | Not measured | Not measured | Not measured |
| α[×10⁻⁷/° C.] | 30-380° | C. | Not measured | Not measured | Not measured | Not measured |
| α[×10⁻⁷/° C.] | 30-750° | C. | Not measured | Not measured | Not measured | Not measured |

| Density[g/cm3] | Not measured | Not measured | Not measured | Not measured |
|---|---|---|---|---|
| Young's Modulus[GPa] | Not measured | Not measured | Not measured | Not measured |
| Modulus of rigidity [GPa] | Not measured | Not measured | Not measured | Not measured |
| Poisson's ratio | Not measured | Not measured | Not measured | Not measured |
| Appearance | Colorless and | Colorless and | Colorless and | Colorless and |
| | transparent | transparent | transparent | transparent |

Rate of change before and after crystallization[%]

| | | | | |
|---|---|---|---|---|
| 200 nm | Not measured | Not measured | Not measured | Not measured |
| 250 nm | Not measured | Not measured | Not measured | Not measured |
| 300 nm | Not measured | Not measured | Not measured | Not measured |
| 325 nm | Not measured | Not measured | Not measured | Not measured |
| 350 nm | Not measured | Not measured | Not measured | Not measured |
| 380 nm | Not measured | Not measured | Not measured | Not measured |
| 800 nm | Not measured | Not measured | Not measured | Not measured |
| 1200 nm | Not measured | Not measured | Not measured | Not measured |

TABLE 19

| | | No.62 | No.63 | No.64 | No.65 | No.66 | No.67 | No.68 |
|---|---|---|---|---|---|---|---|---|
| Composition | SiO₂ | 64.50 | 67.4 | 67.3 | 67.0 | 64.5 | 64.4 | 64.5 |
| [wt %] | Al₂O₃ | 24.2 | 22.1 | 22.3 | 22.2 | 25.1 | 23.7 | 23.7 |
| | B₂O₃ | 0.00 | 0.00 | 0.00 | 0.00 | 0.00 | 0.00 | 0.00 |
| | P₂O₅ | 1.44 | 1.31 | 1.30 | 1.29 | 1.31 | 2.22 | 2.22 |
| | Li₂O | 4.02 | 3.68 | 3.70 | 3.68 | 3.68 | 3.68 | 3.68 |
| | Na₂O | 0.38 | 0.50 | 0.50 | 0.35 | 0.33 | 0.90 | 0.35 |
| | K₂O | 0.00 | 0.00 | 0.00 | 0.00 | 0.00 | 0.00 | 0.00 |
| | MgO | 1.34 | 1.23 | 1.14 | 1.22 | 1.22 | 1.22 | 1.22 |
| | CaO | 0.018 | 0.017 | 0.018 | 0.014 | 0.015 | 0.014 | 0.014 |
| | SrO | 0.00 | 0.00 | 0.00 | 0.00 | 0.00 | 0.00 | 0.00 |
| | BaC | 0.00 | 0.00 | 0.00 | 0.58 | 0.00 | 0.00 | 0.58 |
| | ZnO | 0.00 | 0.00 | 0.00 | 0.00 | 0.00 | 0.00 | 0.00 |
| | TiO₂ | 0.0100 | 0.0100 | 0.0100 | 0.0100 | 0.0100 | 0.0100 | 0.0100 |
| | SnO₂ | 1.23 | 1.12 | 1.08 | 1.07 | 1.13 | 1.14 | 1.13 |
| | ZrO₂ | 2.88 | 2.65 | 2.66 | 2.60 | 2.62 | 2.62 | 2.61 |
| | Y₂O₃ | 0.00 | 0.00 | 0.00 | 0.00 | 0.00 | 0.00 | 0.00 |
| | MoO₃ | 0.0000 | 0.0000 | 0.0000 | 0.0000 | 0.0000 | 0.0000 | 0.0000 |
| | Fe₂O₃ | 0.0060 | 0.0060 | 0.0060 | 0.0040 | 0.0060 | 0.0060 | 0.0040 |
| | Sb₂O₃ | 0.00 | 0.00 | 0.00 | 0.00 | 0.00 | 0.00 | 0.00 |
| | As₂O₃ | 0.00 | 0.00 | 0.00 | 0.00 | 0.00 | 0.00 | 0.00 |
| Composition | Pt | 1.50 | 1.50 | 1.50 | 1.50 | 1.50 | 1.50 | 1.50 |
| [ppm] | Rh | 0.02 | 0.02 | 0.02 | 0.02 | 0.02 | 0.02 | 0.02 |
| | Pt + Rh | 1.52 | 1.52 | 1.52 | 1.52 | 1.52 | 1.52 | 1.52 |

| | | | | | | | |
|---|---|---|---|---|---|---|---|
| Sn/(P + B + Zr + Ti + Sn) | 0.221 | 0.220 | 0.214 | 0.215 | 0.223 | 0.190 | 0.189 |
| Al/(Zr + Sn) | 5.89 | 5.86 | 5.96 | 6.05 | 6.69 | 6.30 | 6.34 |
| (Mg + Zn)/Li | 0.333 | 0.334 | 0.308 | 0.332 | 0.332 | 0.332 | 0.332 |
| Sn/(Zr + Sn) | 0.30 | 0.30 | 0.29 | 0.29 | 0.30 | 0.30 | 0.30 |
| (Si + Al)/Li | 22.06 | 24.32 | 24.22 | 24.24 | 24.35 | 23.94 | 23.97 |
| (Si + Al)/Sn | 72.11 | 79.91 | 82.96 | 83.36 | 79.29 | 77.28 | 78.05 |
| (Li + Na + K)/Zr | 1.53 | 1.58 | 1.58 | 1.55 | 1.53 | 1.75 | 1.54 |
| Ti/Zr | 0.0035 | 0.0038 | 0.0038 | 0.0038 | 0.0038 | 0.0038 | 0.0038 |
| Ti/(Ti + Fe) | 0.625 | 0.625 | 0.625 | 0.714 | 0.625 | 0.625 | 0.714 |
| Na + K + Ca + Sr + Ba | 1.74 | 1.75 | 1.66 | 2.16 | 1.57 | 2.13 | 2.16 |
| (Mg + Ca + Sr + Ba)/Zr | 0.47 | 0.47 | 0.44 | 0.70 | 0.47 | 0.47 | 0.70 |
| (Mg + Ca + Sr + Ba)/(Li + Na + K) | 0.31 | 0.30 | 0.28 | 0.45 | 0.31 | 0.27 | 0.45 |
| Al/(Li + (1/2*(Mg + Zn)) | 6.69 | 6.62 | 6.60 | 6.64 | 7.43 | 7.05 | 7.05 |
| Sb + As | 0.00 | 0.00 | 0.00 | 0.00 | 0.00 | 0.00 | 0.00 |

Before crystallization

| Transmittance[%] | 200 nm | Not | Not | Not | 78.7 | 78.7 | 77.2 | 81.2 |
|---|---|---|---|---|---|---|---|---|
| 3 mm thickness | | measured | measured | measured | | | | |
| | 250 nm | Not | Not | Not | 23.6 | 23.0 | 23.0 | 23.9 |
| | | measured | measured | measured | | | | |
| | 300 nm | Not | Not | Not | 38.7 | 33.6 | 35.8 | 37.1 |
| | | measured | measured | measured | | | | |
| | 325 nm | Not | Not | Not | 72.5 | 69.1 | 71.0 | 72.9 |
| | | measured | measured | measured | | | | |
| | 350 nm | Not | Not | Not | 85.1 | 83.9 | 84.9 | 85.7 |
| | | measured | measured | measured | | | | |
| | 380 nm | Not | Not | Not | 89.0 | 88.6 | 89.2 | 89.4 |
| | | measured | measured | measured | | | | |
| | 800 nm | Not | Not | Not | 91.4 | 91.1 | 91.4 | 91.5 |
| | | measured | measured | measured | | | | |
| | 1200 nm | Not | Not | Not | 91.6 | 91.1 | 91.3 | 91.6 |
| | | measured | measured | measured | | | | |
| L* | | 96.6 | 96.6 | 96.7 | 96.4 | 96.3 | 96.5 | 96.5 |
| a* | | 0.0 | 0.0 | 0.0 | 0.0 | 0.0 | 0.0 | 0.0 |
| b* | | 0.4 | 0.3 | 0.3 | 0.5 | 0.5 | 0.4 | 0.4 |
| Low temperature | Strain point[° C.] | Not | Not | Not | Not | Not | Not | Not |
| viscosity | | measured | measured | measured | measured | measured | measured | measured |
| | Annealing point[° C.] | Not | Not | Not | Not | Not | Not | Not |
| | | measured | measured | measured | measured | measured | measured | measured |
| | Glass transition | Not | Not | Not | 741 | 738 | 732 | 736 |
| | point[° C.] | measured | measured | measured | | | | |
| High temperature | 10\hat{ }4[° C.] | Not | Not | Not | 1352 | 1325 | 1330 | 1334 |
| viscosity | | measured | measured | measured | | | | |
| | 10\hat{ }3[° C.] | Not | Not | Not | 1534 | 1500 | 1508 | 1512 |
| | | measured | measured | measured | | | | |
| | 10\hat{ }2.5[° C.] | Not | Not | Not | 1650 | 1611 | 1619 | 1622 |
| | | measured | measured | measured | | | | |
| | 10\hat{ }2[° C.] | Not | Not | Not | 1793 | 1743 | 1749 | 1751 |
| | | measured | measured | measured | | | | |
| Liquidus temperature[° C.] | | Not | Not | Not | Not | Not | Not | Not |
| | | measured | measured | measured | measured | measured | measured | measured |
| Liquidus viscosity[−] | | Not | Not | Not | Not | Not | Not | Not |
| | | measured | measured | measured | measured | measured | measured | measured |
| α[× 10⁻⁷/° C.] | 30-380° C. | Not | Not | Not | 38.8 | 38.0 | 40.9 | 38.3 |
| | | measured | measured | measured | | | | |

| | | | | | | | |
|---|---|---|---|---|---|---|---|
| Density[g/cm3] | 2.447 | 2.425 | 2.425 | 2.437 | 2.447 | 2.438 | 2.446 |
| β-OH[/mm] | 0.13 | 0.17 | 0.09 | 0.11 | 0.12 | 0.12 | 0.21 |

TABLE 20

| | | | | | | |
|---|---|---|---|---|---|---|
| No.62 | No.63 | No.64 | No.65 | No.66 | No.67 | No.68 |

After crystallization

| Crystallization condition | | 780° C.-3 h | 780° C.-3 h | 780° C.-3 h | 780° C.-3 h | 810° C.-3 h | 780° C.-3 h | 780° C.-3 h |
|---|---|---|---|---|---|---|---|---|
| | | 890° C.-1 h | 890° C.-1 h | 920° C.-1 h | 890° C.-1 h | 890° C.-1 h | 920° C.-1 h | 920° C.-1 h |
| Transmittance[%] | 200 nm | Not measured | Not measured | Not measured | Not measured | Not measured | 49.8 | Not measured |
| 3 mm thickness | 250 nm | Not measured | Not measured | Not measured | Not measured | Not measured | 20.8 | Not measured |
| | 300 nm | Not measured | Not measured | Not measured | Not measured | Not measured | 19.6 | Not measured |
| | 325 nm | Not measured | Not measured | Not measured | Not measured | Not measured | 40.5 | Not measured |
| | 350 nm | Not measured | Not measured | Not measured | Not measured | Not measured | 52.8 | Not measured |
| | 380 nm | Not measured | Not measured | Not measured | Not measured | Not measured | 60.6 | Not measured |
| | 800 nm | Not measured | Not measured | Not measured | Not measured | Not measured | 88.3 | Not measured |
| | 1200 nm | Not measured | Not measured | Not measured | Not measured | Not measured | 90.4 | Not measured |
| L* | | Not measured | Not measured | Not measured | Not measured | Not measured | 94.5 | Not measured |
| a* | | Not measured | Not measured | Not measured | Not measured | Not measured | 0.4 | Not measured |
| b* | | Not measured | Not measured | Not measured | Not measured | Not measured | 6.8 | Not measured |
| Precipitated crystal | | β-Q | β-Q | β-Q | β-Q | β-Q | β-Q | β-Q |
| Average crystallite size[nm] | | Not measured | Not measured | Not measured | Not measured | Not measured | Not measured | Not measured |
| α[× 10⁻⁷/° C.] | 30-380° C. | −1.5 | −1.1 | −2.1 | Not measured | Not measured | Not measured | Not measured |
| α[× 10⁻⁷/° C.] | 30-750° C. | −0.3 | −0.3 | −1.4 | Not measured | Not measured | Not measured | Not measured |

| | | | | | | | |
|---|---|---|---|---|---|---|---|
| Density[g/cm3] | 2.514 | 2.507 | 2.508 | 2.519 | 2.514 | 2.499 | 2.520 |
| Young's Modulus[GPa] | Not measured | Not measured | Not measured | Not measured | Not measured | Not measured | Not measured |
| Modulus of rigidity[GPa] | Not measured | Not measured | Not measured | Not measured | Not measured | Not measured | Not measured |
| Poisson's ratio | Not measured | Not measured | Not measured | Not measured | Not measured | Not measured | Not measured |
| Appearance | Colorless and | Colorless and | Colorless and | Colorless and | Colorless and | Colorless and | Colorless and |
| | transparent | transparent | transparent | transparent | transparent | transparent | transparent |

Rate of change before and after crystallization[%]

| | | | | | | | |
|---|---|---|---|---|---|---|---|
| 200 nm | Not measured | Not measured | Not measured | Not measured | Not measured | 35.4 | Not measured |
| 250 nm | Not measured | Not measured | Not measured | Not measured | Not measured | 9.4 | Not measured |
| 300 nm | Not measured | Not measured | Not measured | Not measured | Not measured | 45.2 | Not measured |
| 325 nm | Not measured | Not measured | Not measured | Not measured | Not measured | 43.0 | Not measured |
| 350 nm | Not measured | Not measured | Not measured | Not measured | Not measured | 37.8 | Not measured |
| 380 nm | Not measured | Not measured | Not measured | Not measured | Not measured | 32.1 | Not measured |
| 800 nm | Not measured | Not measured | Not measured | Not measured | Not measured | 3.3 | Not measured |
| 1200 nm | Not measured | Not measured | Not measured | Not measured | Not measured | 1.1 | Not measured |

TABLE 21

| | | No.69 | No.70 | No.71 | No.72 | No.73 | No.74 | No.75 |
|---|---|---|---|---|---|---|---|---|
| Composition | SiO₂ | 64.50 | 64.6 | 64.5 | 65.9 | 67.2 | 67.5 | 64.7 |
| [wt %] | Al₂O₃ | 23.7 | 24.6 | 24.6 | 22.2 | 22.2 | 22.2 | 23.6 |
| | B₂O₃ | 0.00 | 0.00 | 0.00 | 0.00 | 0.00 | 0.00 | 0.00 |
| | P₂O₅ | 2.23 | 1.91 | 2.84 | 1.31 | 0.00 | 0.00 | 1.31 |
| | Li₂O | 3.68 | 3.68 | 3.68 | 3.68 | 3.68 | 3.68 | 3.68 |
| | Na₂O | 0.34 | 0.35 | 0.35 | 0.33 | 0.33 | 0.07 | 0.08 |
| | K₂O | 0.58 | 0.00 | 0.00 | 0.00 | 0.00 | 0.00 | 0.00 |
| | MgO | 1.23 | 1.22 | 0.37 | 2.83 | 2.83 | 2.83 | 2.84 |
| | CaO | 0.014 | 0.014 | 0.009 | 0.024 | 0.023 | 0.023 | 0.024 |
| | SrO | 0.00 | 0.00 | 0.00 | 0.00 | 0.00 | 0.00 | 0.00 |
| | BaO | 0.00 | 0.00 | 0.00 | 0.00 | 0.00 | 0.00 | 0.00 |
| | ZnO | 0.00 | 0.00 | 0.00 | 0.00 | 0.00 | 0.00 | 0.00 |
| | TiO₂ | 0.0100 | 0.0100 | 0.0100 | 0.0100 | 0.0100 | 0.0100 | 0.0100 |
| | SnO₂ | 1.17 | 1.13 | 1.15 | 1.17 | 1.17 | 1.15 | 1.17 |
| | ZrO₂ | 2.59 | 2.60 | 2.61 | 2.60 | 2.60 | 2.59 | 2.61 |
| | Fe₂O₃ | 0.0040 | 0.0050 | 0.0050 | 0.0050 | 0.0050 | 0.0050 | 0.0050 |
| | Y₂O₃ | 0.00 | 0.00 | 0.00 | 0.00 | 0.00 | 0.00 | 0.00 |
| | MoO₃ | 0.0000 | 0.0000 | 0.0000 | 0.0000 | 0.0000 | 0.0000 | 0.0000 |
| | Sb₂O₃ | 0.00 | 0.00 | 0.00 | 0.00 | 0.00 | 0.00 | 0.00 |
| | As₂O₃ | 0.00 | 0.00 | 0.00 | 0.00 | 0.00 | 0.00 | 0.00 |
| Composition | Pt | 1.50 | 1.50 | 1.50 | 1.50 | 1.50 | 1.50 | 1.50 |
| [ppm] | Rh | 0.02 | 0.02 | 0.02 | 0.02 | 0.02 | 0.02 | 0.02 |
| | Pt + Rh | 1.52 | 1.52 | 1.52 | 1.52 | 1.52 | 1.52 | 1.52 |

| | | | | | | | |
|---|---|---|---|---|---|---|---|
| Sn/(P + B + Zr + Ti + Sn) | 0.195 | 0.200 | 0.174 | 0.230 | 0.310 | 0.307 | 0.229 |
| Al/(Zr + Sn) | 6.30 | 6.60 | 6.54 | 5.89 | 5.89 | 5.94 | 6.24 |
| (Mg + Zn)/Li | 0.334 | 0.332 | 0.101 | 0.769 | 0.769 | 0.769 | 0.772 |
| Sn/(Zr + Sn) | 0.31 | 0.30 | 0.31 | 0.31 | 0.31 | 0.31 | 0.31 |
| (Si + Al)/Li | 23.97 | 24.24 | 24.21 | 23.94 | 24.29 | 24.38 | 23.99 |
| (Si + Al)/Sn | 75.38 | 78.94 | 77.48 | 75.30 | 76.41 | 78.00 | 75.47 |
| (Li + Na + K)/Zr | 1.78 | 1.55 | 1.54 | 1.54 | 1.54 | 1.45 | 1.44 |
| Ti/Zr | 0.0039 | 0.0038 | 0.0038 | 0.0038 | 0.0038 | 0.0039 | 0.0038 |
| Ti/(Ti + Fe) | 0.714 | 0.667 | 0.667 | 0.667 | 0.667 | 0.667 | 0.667 |
| Na + K + Ca + Sr + Ba | 2.16 | 1.58 | 0.73 | 3.18 | 3.18 | 2.92 | 2.94 |
| (Mg + Ca + Sr + Ba)/Zr | 0.48 | 0.47 | 0.15 | 1.10 | 1.10 | 1.10 | 1.10 |
| (Mg + Ca + Sr + Ba)/(Li + Na + K) | 0.27 | 0.31 | 0.09 | 0.71 | 0.71 | 0.76 | 0.76 |
| Al/(Li + (1/2*(Mg + Zn)) | 7.06 | 7.29 | 6.87 | 7.45 | 7.45 | 7.45 | 7.83 |
| Sb + As | 0.00 | 0.00 | 0.00 | 0.00 | 0.00 | 0.00 | 0.00 |

Before crystallization

| Transmittance[%] | 200 nm | 72.4 | 73.9 | 82.2 | 76.4 | 75.4 | 77.1 | 76.6 |
|---|---|---|---|---|---|---|---|---|
| 3 mm thickness | 250 nm | 23.1 | 23.5 | 24.1 | 23.7 | 23.4 | 24.0 | 23.8 |
| | 300 nm | 38.5 | 37.1 | 34.5 | 37.2 | 35.7 | 34.5 | 36.2 |
| | 325 nm | 73.8 | 73.5 | 71.9 | 72.0 | 70.7 | 70.1 | 71.0 |
| | 350 nm | 86.5 | 86.6 | 86.1 | 85.2 | 84.8 | 84.5 | 84.6 |
| | 380 nm | 90.0 | 90.1 | 89.9 | 89.1 | 89.2 | 88.7 | 88.7 |
| | 800 nm | 91.6 | 91.7 | 91.7 | 91.1 | 91.3 | 90.9 | 90.9 |
| | 1200 nm | 91.8 | 91.7 | 91.8 | 91.4 | 91.4 | 91.2 | 91.1 |
| L* | | 96.6 | 96.7 | 96.6 | 96.3 | 96.5 | 96.3 | 96.2 |
| a* | | 0.0 | 0.0 | 0.0 | 0.0 | −0.1 | 0.0 | 0.0 |
| b* | | 0.3 | 0.3 | 0.3 | 0.4 | 0.4 | 0.5 | 0.5 |
| Low temperature | Strain point[° C.] | Not | Not | Not | Not | Not | Not | Not |
| viscosity | | measured | measured | measured | measured | measured | measured | measured |
| | Annealing point[° C.] | Not | Not | Not | Not | Not | Not | Not |
| | | measured | measured | measured | measured | measured | measured | measured |
| | Glass transition | 732 | 739 | 750 | Not | Not | Not | Not |
| | point[° C.] | | | | measured | measured | measured | measured |
| High temperature | 10\hat{ }4[° C.] | 1334 | 1327 | 1350 | Not | 1309 | Not | Not |
| viscosity | | | | | measured | | measured | measured |
| | 10\hat{ }3[° C.] | 1512 | 1502 | 1528 | Not | 1488 | Not | Not |
| | | | | | measured | | measured | measured |
| | 10\hat{ }2.5[° C.] | 1624 | 1612 | 1639 | Not | 1602 | Not | Not |
| | | | | | measured | | measured | measured |
| | 10\hat{ }2[° C.] | 1756 | 1741 | 1 770 | Not | 1739 | Not | Not |
| | | | | | measured | | measured | measured |
| Liquidus temperature[° C.] | | Not | Not | Not | Not | Not | Not | Not |
| | | measured | measured | measured | measured | measured | measured | measured |
| Liquidus viscosity[−] | | Not | Not | Not | Not | Not | Not | Not |
| | | measured | measured | measured | measured | measured | measured | measured |
| α[× 10⁻⁷/° C.] | 30-380° C. | 40.5 | 38.2 | 37.4 | Not | Not | Not | Not |
| | | | | | measured | measured | measured | measured |

| | | | | | | | |
|---|---|---|---|---|---|---|---|
| Density[g/cm3] | 2.437 | 2.442 | 2.423 | 2.450 | 2.451 | 2.450 | 2.458 |
| β-OH[/mm] | 0.23 | 0.29 | 0.05 | 0.18 | 0.40 | 0.71 | 0.94 |

TABLE 22

| | | | | | | |
|---|---|---|---|---|---|---|
| No.69 | No.70 | No.71 | No.72 | No.73 | No.74 | No.75 |

After crystallization

| Crystallization condition | | 780° C.-3 h | 780° C.-3 h | 810° C.-3 h | 810° C.-3 h | 780° C.-3 h | 780° C.-3 h | 810° C.-3 h |
|---|---|---|---|---|---|---|---|---|
| | | 920° C.-1 h | 920° C.-1 h | 890° C.-1 h | 890° C.-1 h | 920° C.-1 h | 860° C.-1 h | 920° C.-1 h |
| Transmittance[%] | 200 nm | 48.6 | Not measured | 73.0 | Not measured | Not measured | Not measured | Not measured |
| 3 mm thickness | 250 nm | 20.1 | Not measured | 30.3 | Not measured | Not measured | Not measured | Not measured |
| | 300 nm | 21.6 | Not measured | 20.1 | Not measured | Not measured | Not measured | Not measured |
| | 325 nm | 45.6 | Not measured | 32.0 | Not measured | Not measured | Not measured | Not measured |
| | 350 nm | 58.1 | Not measured | 42.3 | Not measured | Not measured | Not measured | Not measured |
| | 380 nm | 65.2 | Not measured | 48.6 | Not measured | Not measured | Not measured | Not measured |
| | 800 nm | 88.7 | Not measured | 76.6 | Not measured | Not measured | Not measured | Not measured |
| | 1200 nm | 90.7 | Not measured | 86.6 | Not measured | Not measured | Not measured | Not measured |
| L* | | 92.5 | Not measured | 83.3 | Not measured | Not measured | Not measured | Not measured |
| a* | | −0.2 | Not measured | 1.4 | Not measured | Not measured | Not measured | Not measured |
| b* | | 5.6 | Not measured | 7.1 | Not measured | Not measured | Not measured | Not measured |
| Precipitated crystal | | β-Q | β-Q | β-Q | β-Q | β-Q | β-Q | β-Q |
| Average crystallite size[nm] | | Not measured | Not measured | Not measured | Not measured | Not measured | Not measured | Not measured |
| α[× 10⁻⁷/° C.] | 30-380° C. | Not measured | Not measured | Not measured | Not measured | Not measured | Not measured | Not measured |
| α[× 10⁻⁷/° C.] | 30-750° C. | Not measured | Not measured | Not measured | Not measured | Not measured | Not measured | Not measured |

| | | | | | | | |
|---|---|---|---|---|---|---|---|
| Density[g/cm3] | 2.498 | 2.522 | 2.499 | 2.514 | 2.526 | 2.519 | 2.510 |
| Young's Modulus[GPa] | Not measured | Not measured | Not measured | Not measured | Not measured | Not measured | Not measured |
| Modulus of rigidity[GPa] | Not measured | Not measured | Not measured | Not measured | Not measured | Not measured | Not measured |
| Poisson's ratio | Not measured | Not measured | Not measured | Not measured | Not measured | Not measured | Not measured |
| Appearance | Colorless and | Colorless and | Colorless and | Colorless and | Colorless and | Colorless and | Colorless and |
| | transparent | transparent | transparent | transparent | transparent | transparent | transparent |

Rate of change before and after crystallization[%]

| | | | | | | | |
|---|---|---|---|---|---|---|---|
| 200 nm | Not measured | Not measured | Not measured | Not measured | Not measured | 35.4 | Not measured |
| 250 nm | Not measured | Not measured | Not measured | Not measured | Not measured | 9.4 | Not measured |
| 300 nm | Not measured | Not measured | Not measured | Not measured | Not measured | 45.2 | Not measured |
| 325 nm | Not measured | Not measured | Not measured | Not measured | Not measured | 43.0 | Not measured |
| 350 nm | Not measured | Not measured | Not measured | Not measured | Not measured | 37.8 | Not measured |
| 380 nm | Not measured | Not measured | Not measured | Not measured | Not measured | 32.1 | Not measured |
| 800 nm | Not measured | Not measured | Not measured | Not measured | Not measured | 3.3 | Not measured |
| 1200 nm | Not measured | Not measured | Not measured | Not measured | Not measured | 1.1 | Not measured |

TABLE 23

| | | No.76 | No.77 | No.78 | No.79 | No.80 | No.81 | No.82 |
|---|---|---|---|---|---|---|---|---|
| Composition | SiO₂ | 64.30 | 64.4 | 64.4 | 64.5 | 67.4 | 68.1 | 68.5 |
| [wt %] | Al₂O₃ | 23.7 | 23.6 | 23.7 | 24.5 | 22.2 | 22.2 | 22.2 |
| | B₂O₃ | 0.00 | 0.00 | 0.00 | 0.00 | 0.00 | 0.00 | 0.00 |
| | P₂O₅ | 1.81 | 1.31 | 0.81 | 1.30 | 1.35 | 0.81 | 0.40 |
| | Li₂O | 3.68 | 3.68 | 3.68 | 3.68 | 3.65 | 3.66 | 3.68 |
| | Na₂O | 0.36 | 0.36 | 0.36 | 0.35 | 0.35 | 0.35 | 0.35 |
| | K₂O | 0.00 | 0.00 | 0.00 | 0.00 | 0.00 | 0.00 | 0.00 |
| | MgO | 1.23 | 1.22 | 1.22 | 1.23 | 1.22 | 1.23 | 1.23 |
| | CaO | 0.014 | 0.014 | 0.014 | 0.020 | 0.019 | 0.020 | 0.020 |
| | SrO | 0.00 | 0.00 | 0.00 | 0.00 | 0.00 | 0.00 | 0.00 |
| | BaO | 0.98 | 1.46 | 1.95 | 0.00 | 0.00 | 0.00 | 0.00 |
| | ZnO | 0.000 | 0.000 | 0.000 | 0.000 | 0.00 | 0.00 | 0.00 |
| | TiO₂ | 0.0100 | 0.0100 | 0.0100 | 0.0100 | 0.0100 | 0.0100 | 0.0100 |
| | SnO₂ | 1.14 | 1.15 | 1.19 | 1.12 | 1.15 | 1.13 | 1.15 |
| | ZrO₂ | 2.61 | 2.62 | 2.60 | 2.61 | 2.76 | 2.58 | 2.56 |
| | Fe₂O₃ | 0.0050 | 0.0050 | 0.0040 | 0.0050 | 0.0040 | 0.0040 | 0.0050 |
| | Y₂O₃ | 0.00 | 0.00 | 0.00 | 0.00 | 0.00 | 0.00 | 0.00 |
| | MoO₃ | 0.0000 | 0.0000 | 0.0000 | 0.0000 | 0.0000 | 0.0000 | 0.0000 |
| | Sb₂O₃ | 0.00 | 0.00 | 0.00 | 0.00 | 0.00 | 0.00 | 0.00 |
| | As₂O₃ | 0.00 | 0.00 | 0.00 | 0.00 | 0.00 | 0.00 | 0.00 |
| Composition | Pt | 1.50 | 1.50 | 1.50 | 1.50 | 1.50 | 1.50 | 1.50 |
| [ppm] | Rh | 0.02 | 0.02 | 0.02 | 0.02 | 0.02 | 0.02 | 0.02 |
| | Pt + Rh | 1.52 | 1.52 | 1.52 | 1.52 | 1.52 | 1.52 | 1.52 |

| | | | | | | | |
|---|---|---|---|---|---|---|---|
| Sn/(P + B + Zr + Ti + Sn) | 0.205 | 0.226 | 0.258 | 0.222 | 0.218 | 0.249 | 0.279 |
| Al/(Zr + Sn) | 6.32 | 6.26 | 6.25 | 6.57 | 5.68 | 5.98 | 5.98 |
| (Mg + Zn)/Li | 0.334 | 0.332 | 0.332 | 0.334 | 0.334 | 0.336 | 0.334 |
| Sn/(Zr + Sn) | 0.30 | 0.31 | 0.31 | 0.30 | 0.29 | 0.30 | 0.31 |
| (Si + Al)/Li | 23.91 | 23.91 | 23.94 | 24.18 | 24.55 | 24.67 | 24.65 |
| (Si + Al)/Sn | 77.19 | 76.52 | 74.03 | 79.46 | 77.91 | 79.91 | 78.87 |
| (Li + Na + K)/Zr | 1.55 | 1.54 | 1.55 | 1.54 | 1.45 | 1.55 | 1.57 |
| Ti/Zr | 0.0038 | 0.0038 | 0.0038 | 0.0038 | 0.0036 | 0.0039 | 0.0039 |
| Ti/(Ti + Fe) | 0.667 | 0.667 | 0.714 | 0.667 | 0.714 | 0.714 | 0.667 |
| Na + K + Ca + Sr + Ba | 2.58 | 3.05 | 3.54 | 1.60 | 1.59 | 1.60 | 1.60 |
| (Mg + Ca + Sr + Ba)/Zr | 0.85 | 1.03 | 1.22 | 0.48 | 0.45 | 0.48 | 0.49 |
| (Mg + Ca + Sr + Ba)/(Li + Na + K) | 0.55 | 0.67 | 0.79 | 0.31 | 0.31 | 0.31 | 0.31 |
| Al/(Li + (1/2*(Mg + Zn)) | 7.06 | 7.02 | 7.05 | 7.27 | 6.69 | 6.68 | 6.65 |
| Sb + As | 0.00 | 0.00 | 0.00 | 0.00 | 0.00 | 0.00 | 0.00 |

Before crystallization

| Transmittance[%] | 200 nm | 80.8 | 74.6 | 74.7 | 84.9 | 83.4 | 83.7 | 81.2 |
|---|---|---|---|---|---|---|---|---|
| 3 mm thickness | 250 nm | 23.5 | 23.1 | 23.1 | 24.5 | 24.1 | 24.4 | 23.9 |
| | 300 nm | 38.5 | 37.3 | 35.9 | 37.2 | 36.2 | 37.0 | 34.6 |
| | 325 nm | 73.7 | 72.9 | 72.3 | 72.6 | 71.8 | 73.2 | 71.4 |
| | 350 nm | 86.4 | 86.1 | 85.9 | 85.7 | 85.5 | 86.4 | 85.7 |
| | 380 nm | 90.0 | 89.9 | 89.8 | 89.6 | 89.6 | 90.2 | 89.8 |
| | 800 nm | 91.7 | 91.7 | 91.6 | 91.5 | 91.7 | 91.8 | 91.6 |
| | 1200 nm | 91.6 | 91.7 | 91.6 | 91.5 | 91.6 | 91.7 | 91.6 |
| L* | | 96.6 | 96.6 | 96.6 | 96.5 | 96.6 | 96.7 | 96.6 |
| a* | | −0.1 | −0.1 | −0.1 | 0.0 | 0.0 | 0.0 | 0.0 |
| b* | | 0.3 | 0.4 | 0.4 | 0.4 | 0.4 | 0.3 | 0.3 |
| Low temperature | Strain point[° C.] | Not | Not | Not | Not | Not | Not | Not |
| viscosity | | measured | measured | measured | measured | measured | measured | measured |
| | Annealing point[° C.] | Not | Not | Not | Not | Not | Not | Not |
| | | measured | measured | measured | measured | measured | measured | measured |
| | Glass transition | Not | Not | Not | Not | 738 | Not | Not |
| | point[° C.] | measured | measured | measured | measured | | measured | measured |
| High temperature | 10\hat{ }4[° C.] | Not | Not | Not | Not | 1354 | 1353 | Not |
| viscosity | | measured | measured | measured | measured | | | measured |
| | 10\hat{ }3[° C.] | Not | Not | Not | Not | 1538 | 1536 | Not |
| | | measured | measured | measured | measured | | | measured |
| | 10\hat{ }2.5[° C.] | Not | Not | Not | Not | 1652 | 1653 | Not |
| | | measured | measured | measured | measured | | | measured |
| | 10\hat{ }2[° C.] | Not | Not | Not | Not | 1782 | 1792 | Not |
| | | measured | measured | measured | measured | | | measured |
| Liquidus temperature[° C.] | | Not | Not | Not | Not | Not | 1399 | 1413 |
| | | measured | measured | measured | measured | measured | | |
| Liquidus viscosity[−] | | Not | Not | Not | Not | Not | 3.7 | Not |
| | | measured | measured | measured | measured | measured | | measured |
| α[× 10⁻⁷/° C.] | 30-380° C. | Not | Not | Not | Not | 38.8 | Not | Not |
| | | measured | measured | measured | measured | | measured | measured |

| | | | | | | | |
|---|---|---|---|---|---|---|---|
| Density[g/cm3] | 2.455 | 2.464 | 2.476 | 2.454 | 2.428 | 2.427 | 2.427 |
| β-OH[/mm] | 0.65 | 0.30 | 0.26 | 0.44 | 0.03 | 0.58 | 0.20 |

TABLE 24

| | | | | | | |
|---|---|---|---|---|---|---|
| No.76 | No.77 | No.78 | No.79 | No.80 | No.81 | No.82 |

After crystallization

| Crystallization condition | | 780° C.-3 h | 810° C.-3 h | 765° C.-3 h | 780° C.-3 h | 780° C.-3 h | 780° C.-3 h | 780° C.-3 h |
|---|---|---|---|---|---|---|---|---|
| | | 860° C.-1 h | 920° C.-1 h | 860° C.-1 h | 890° C.-1 h | 890° C.-1 h | 890° C.-1 h | 890° C.-1 h |
| Transmittance[%] | 200 nm | Not measured | Not measured | Not measured | Not measured | Not measured | Not measured | Not measured |
| 3 mm thickness | 250 nm | Not measured | Not measured | Not measured | Not measured | Not measured | Not measured | Not measured |
| | 300 nm | Not measured | Not measured | Not measured | Not measured | Not measured | Not measured | Not measured |
| | 325 nm | Not measured | Not measured | Not measured | Not measured | Not measured | Not measured | Not measured |
| | 350 nm | Not measured | Not measured | Not measured | Not measured | Not measured | Not measured | Not measured |
| | 380 nm | Not measured | Not measured | Not measured | Not measured | Not measured | Not measured | Not measured |
| | 800 nm | Not measured | Not measured | Not measured | Not measured | Not measured | Not measured | Not measured |
| | 1200 nm | Not measured | Not measured | Not measured | Not measured | Not measured | Not measured | Not measured |
| L* | | Not measured | Not measured | Not measured | Not measured | Not measured | Not measured | Not measured |
| a* | | Not measured | Not measured | Not measured | Not measured | Not measured | Not measured | Not measured |
| b* | | Not measured | Not measured | Not measured | Not measured | Not measured | Not measured | Not measured |
| Precipitated crystal | | β-Q | β-Q | β-Q | β-Q | β-Q | β-Q | β-Q |
| Average crystallite size[nm] | | Not measured | Not measured | Not measured | Not measured | Not measured | Not measured | Not measured |
| α[× 10⁻⁷/° C.] | 30-380° C. | Not measured | Not measured | Not measured | Not measured | Not measured | Not measured | −2.5 |
| α[× 10⁻⁷/° C.] | 30-750° C. | Not measured | Not measured | Not measured | Not measured | Not measured | Not measured | −1.8 |

| | | | | | | | |
|---|---|---|---|---|---|---|---|
| Density[g/cm3] | 2.519 | 2.510 | 2.530 | 2.530 | 2.536 | 2.520 | 2.515 |
| Young's Modulus[GPa] | Not measured | Not measured | Not measured | Not measured | Not measured | Not measured | Not measured |
| Modulus of rigidity[GPa] | Not measured | Not measured | Not measured | Not measured | Not measured | Not measured | Not measured |
| Poisson's ratio | Not measured | Not measured | Not measured | Not measured | Not measured | Not measured | Not measured |
| Appearance | Colorless and | Colorless and | Colorless and | Colorless and | Colorless and | Colorless and | Colorless and |
| | transparent | transparent | transparent | transparent | transparent | transparent | transparent |

Rate of change before and after crystallization[%]

| | | | | | | | |
|---|---|---|---|---|---|---|---|
| 200 nm | Not measured | Not measured | Not measured | Not measured | Not measured | Not measured | Not measured |
| 250 nm | Not measured | Not measured | Not measured | Not measured | Not measured | Not measured | Not measured |
| 300 nm | Not measured | Not measured | Not measured | Not measured | Not measured | Not measured | Not measured |
| 325 nm | Not measured | Not measured | Not measured | Not measured | Not measured | Not measured | Not measured |
| 350 nm | Not measured | Not measured | Not measured | Not measured | Not measured | Not measured | Not measured |
| 380 nm | Not measured | Not measured | Not measured | Not measured | Not measured | Not measured | Not measured |
| 800 nm | Not measured | Not measured | Not measured | Not measured | Not measured | Not measured | Not measured |
| 1200 nm | Not measured | Not measured | Not measured | Not measured | Not measured | Not measured | Not measured |

TABLE 25

| | | No.83 | No.84 | No.85 | No.86 | No.87 | No.88 | No.89 |
|---|---|---|---|---|---|---|---|---|
| Composition | SiO₂ | 68.9 | 65.7 | 66.1 | 66.5 | 65.2 | 67.9 | 67.9 |
| [wt %] | Al₂O₃ | 22.2 | 24.5 | 24.5 | 24.5 | 24.5 | 22.3 | 22.3 |
| | B₂O₃ | 0.00 | 0.00 | 0.00 | 0.00 | 0.00 | 0.00 | 0.00 |
| | P₂O₅ | 0.00 | 0.81 | 0.40 | 0.00 | 1.31 | 0.40 | 0.40 |
| | Li₂O | 3.68 | 3.68 | 3.68 | 3.68 | 3.68 | 3.68 | 3.68 |
| | Na₂O | 0.35 | 0.36 | 0.35 | 0.36 | 0.39 | 0.67 | 0.67 |
| | K₂O | 0.00 | 0.00 | 0.00 | 0.00 | 0.00 | 0.01 | 0.01 |
| | MgO | 1.22 | 1.22 | 1.23 | 1.23 | 1.23 | 1.25 | 1.25 |
| | CaO | 0.020 | 0.020 | 0.020 | 0.020 | 0.020 | 0.024 | 0.024 |
| | SrO | 0.00 | 0.00 | 0.00 | 0.00 | 0.00 | 0.00 | 0.00 |
| | BaO | 0.00 | 0.00 | 0.00 | 0.00 | 0.00 | 0.00 | 0.00 |
| | ZnO | 0.00 | 0.00 | 0.00 | 0.00 | 0.00 | 0.00 | 0.00 |
| | TiO₂ | 0.0100 | 0.0100 | 0.0100 | 0.0100 | 0.0100 | 0.0080 | 0.0200 |
| | SnO₂ | 1.17 | 1.16 | 1.18 | 1.14 | 1.11 | 1.13 | 1.13 |
| | ZrO₂ | 2.56 | 2.59 | 2.59 | 2.58 | 2.59 | 2.62 | 2.62 |
| | Y₂O₃ | 0.00 | 0.00 | 0.00 | 0.00 | 0.00 | 0.00 | 0.00 |
| | MoO₃ | 0.0000 | 0.0000 | 0.0000 | 0.0000 | 0.0000 | 0.0000 | 0.0000 |
| | Fe₂O₃ | 0.0050 | 0.0050 | 0.0050 | 0.0050 | 0.0050 | 0.0050 | 0.0090 |
| | Sb₂O₃ | 0.00 | 0.00 | 0.00 | 0.00 | 0.00 | 0.00 | 0.00 |
| | As₂O₃ | 0.00 | 0.00 | 0.00 | 0.00 | 0.00 | 0.00 | 0.00 |
| Composition | Pt | 1.50 | 1.50 | 1.50 | 1.50 | 1.50 | 1.50 | 0.02 |
| [ppm] | Rh | 0.02 | 0.02 | 0.02 | 0.02 | 0.02 | 0.02 | 0.01 |
| | Pt + Rh | 1.52 | 1.52 | 1.52 | 1.52 | 1.52 | 1.52 | 0.03 |

| | | | | | | | |
|---|---|---|---|---|---|---|---|
| Sn/(P + B + Zr + Ti + Sn) | 0.313 | 0.254 | 0.282 | 0.306 | 0.221 | 0.272 | 0.271 |
| Al/(Zr + Sn) | 5.95 | 6.53 | 6.50 | 6.59 | 6.62 | 5.95 | 5.95 |
| (Mg + Zn)/Li | 0.332 | 0.332 | 0.334 | 0.334 | 0.334 | 0.340 | 0.340 |
| Sn/(Zr + Sn) | 0.31 | 0.31 | 0.31 | 0.31 | 0.30 | 0.30 | 0.30 |
| (Si + Al)/Li | 24.76 | 24.51 | 24.62 | 24.73 | 24.38 | 24.51 | 24.51 |
| (Si + Al)/Sn | 77.86 | 77.76 | 76.78 | 79.82 | 80.81 | 79.82 | 79.82 |
| (Li + Na + K)/Zr | 1.57 | 1.56 | 1.56 | 1.57 | 1.57 | 1.66 | 1.66 |
| Ti/Zr | 0.0039 | 0.0039 | 0.0039 | 0.0039 | 0.0039 | 0.0031 | 0.0076 |
| Ti/(Ti + Fe) | 0.667 | 0.667 | 0.667 | 0.667 | 0.667 | 0.615 | 0.690 |
| Na + K + Ca + Sr + Ba | 1.59 | 1.60 | 1.60 | 1.61 | 1.64 | 1.95 | 1.95 |
| (Mg + Ca + Sr + Ba)/Zr | 0.48 | 0.48 | 0.48 | 0.48 | 0.48 | 0.49 | 0.49 |
| (Mg + Ca + Sr + Ba)/(Li + Na + K) | 0.31 | 0.31 | 0.31 | 0.31 | 0.31 | 0.29 | 0.29 |
| Al/(Li + (1/2*(Mg + Zn)) | 6.64 | 7.27 | 7.27 | 7.27 | 7.27 | 6.68 | 6.68 |
| Sb + As | 0.00 | 0.00 | 0.00 | 0.00 | 0.00 | 0.00 | 0.00 |

Before crystallization

| Transmittance[%] | 200 nm | 76.7 | 77.3 | 77.4 | 76.6 | 79.5 | 83.6 | 71.9 |
|---|---|---|---|---|---|---|---|---|
| 3 mm thickness | 250 nm | 23.4 | 23.6 | 23.7 | 23.6 | 24.0 | 24.1 | 20.9 |
| | 300 nm | 34.1 | 35.2 | 35.5 | 35.8 | 37.5 | 37.6 | 28.5 |
| | 325 nm | 71.5 | 72.2 | 72.5 | 72.2 | 73.2 | 73.3 | 66.0 |
| | 350 nm | 85.9 | 86.1 | 86.2 | 86.1 | 86.4 | 86.5 | 84.0 |
| | 380 nm | 90.0 | 90.0 | 90.0 | 90.1 | 90.1 | 90.3 | 89.7 |
| | 800 nm | 91.7 | 91.7 | 91.7 | 91.6 | 91.7 | 91.8 | 91.5 |
| | 1200 nm | 91.6 | 91.6 | 91.6 | 91.6 | 91.6 | 91.9 | 91.3 |
| L* | | 96.7 | 96.6 | 96.6 | 96.7 | 96.7 | 96.7 | 96.7 |
| a* | | 0.0 | 0.0 | 0.0 | 0.0 | −0.1 | 0.0 | −0.1 |
| b* | | 0.3 | 0.3 | 0.3 | 0.3 | 0.3 | 0.3 | 0.3 |
| Low temperature | Strain point[° C.] | Not measured | Not measured | Not measured | Not measured | Not measured | 678 | Not measured |
| viscosity | Annealing | Not measured | Not measured | Not measured | Not measured | Not measured | 737 | Not measured |
| | point[° C.] | | | | | | | |
| | Glass transition | Not measured | Not measured | Not measured | Not measured | Not measured | 738 | Not measured |
| | point[° C.] | | | | | | | |
| High temperature | 10\hat{ }4[° C.] | Not measured | Not measured | 1331 | Not measured | Not measured | 1354 | Not measured |
| viscosity | 10\hat{ }3[° C.] | Not measured | Not measured | 1506 | Not measured | Not measured | 1538 | Not measured |
| | 10\hat{ }2.5[° C.] | Not measured | Not measured | 1616 | Not measured | Not measured | 1654 | Not measured |
| | 10\hat{ }2[° C.] | Not measured | Not measured | 1744 | Not measured | Not measured | 1793 | Not measured |
| Liquidus temperature[° C.] | | 1419 | Not measured | Not measured | 1441 (mullite) | Not measured | 1407 | Not measured |
| Liquidus viscosity[−] | | Not measured | Not measured | Not measured | Not measured | Not measured | 3.7 | Not measured |
| α[× 10⁻⁷/° C.] | 30-380° C. | Not measured | Not measured | Not measured | Not measured | Not measured | 39.6 | Not measured |

| | | | | | | | |
|---|---|---|---|---|---|---|---|
| Density[g/cm3] | 2.428 | 2.442 | 2.443 | 2.444 | 2.441 | 2.429 | 2.429 |
| β-OH[/mm] | 0.83 | 0.07 | 0.15 | 0.18 | 0.22 | 0.12 | 0.54 |

TABLE 26

| No. 83 | No .84 | No. 85 | No. 86 | No. 87 | No. 88 | No. 89 |
|---|---|---|---|---|---|---|
| Crystallization condition | | | | | | |
| 780° C.-3 h | 780° C.-3 h | 780° C.-3 h | 780° C.-3 h | 780° C.-3 h | 780° C.-3 h | 780° C.-3 h |
| 890° C.-1 h | 890° C.-1 h | 890° C.-1 h | 890° C.-1 h | 890° C.-1 h | 890° C.-1 h | 890° C.-1 h |

After crystallization

| Transmittance[%] | 200 nm | Not measured | Not measured | Not measured | Not measured | Not measured | Not measured | Not measured |
|---|---|---|---|---|---|---|---|---|
| 3 mm thickness | 250 nm | Not measured | Not measured | Not measured | Not measured | Not measured | Not measured | Not measured |
| | 300 nm | Not measured | Not measured | Not measured | Not measured | Not measured | Not measured | Not measured |
| | 325 nm | Not measured | Not measured | Not measured | Not measured | Not measured | Not measured | Not measured |
| | 350 nm | Not measured | Not measured | Not measured | Not measured | Not measured | Not measured | Not measured |
| | 380 nm | Not measured | Not measured | Not measured | Not measured | Not measured | Not measured | Not measured |
| | 800 nm | Not measured | Not measured | Not measured | Not measured | Not measured | Not measured | Not measured |
| | 1200 nm | Not measured | Not measured | Not measured | Not measured | Not measured | Not measured | Not measured |
| L* | | Not measured | Not measured | Not measured | Not measured | Not measured | Not measured | Not measured |
| a* | | Not measured | Not measured | Not measured | Not measured | Not measured | Not measured | Not measured |
| b* | | Not measured | Not measured | Not measured | Not measured | Not measured | Not measured | Not measured |
| Precipitated crystal | | β-Q | β-Q | β-Q | β-Q | β-Q | β-Q | β-Q |
| Average crystallite size[nm] | | Not measured | Not measured | Not measured | Not measured | Not measured | Not measured | Not measured |
| α[×10⁻⁷/° C.] | 30-380° C. | −3.1 | Not measured | Not measured | Not measured | Not measured | Not measured | Not measured |
| α[×10⁻⁷/° C.] | 30-750° C. | −2.2 | Not measured | Not measured | Not measured | Not measured | Not measured | Not measured |

| | | | | | | | |
|---|---|---|---|---|---|---|---|
| Density[g/cm3] | 2.512 | 2.514 | 2.515 | 2.516 | 2.517 | 2.516 | 2.524 |
| Young's Modulus [ GPa] | Not measured | Not measured | Not measured | Not measured | Not measured | \|Not measured | Not measured |
| Modulus of rigidity [GPa] | Not measured | Not measured | Not measured | Not measured | Not measured | Not measured | Not measured |
| Poisson's ratio | Not measured | Not measured | Not measured | Not measured | Not measured | Not measured | Not measured |
| Appearance | Colorless and | Colorless and | Colorless and | Colorless and | Colorless and | Colorless and | Colorless and |
| | transparent | transparent | transparent | transparent | transparent | transparent | transparent |

Rate of change before and after crystallization [%]

| | | | | | | | |
|---|---|---|---|---|---|---|---|
| 200 nm | Not measured | Not measured | Not measured | \|Not measured | Not measured | Not measured | Not measured |
| 250 nm | Not measured | Not measured | Not measured | Not measured | Not measured | Not measured | Not measured |
| 300 nm | Not measured | Not measured | Not measured | Not measured | Not measured | Not measured | Not measured |
| 325 nm | Not measured | Not measured | Not measured | Not measured | Not measured | Not measured | Not measured |
| 350 nm | Not measured | Not measured | Not measured | Not measured | Not measured | Not measured | Not measured |
| 380 nm | Not measured | Not measured | Not measured | Not measured | Not measured | Not measured | Not measured |
| 800 nm | Not measured | Not measured | Not measured | Not measured | Not measured | Not measured | Not measured |
| 1200 nm | Not measured | Not measured | Not measured | Not measured | Not measured | Not measured | Not measured |

TABLE 27

| | | No. 90 | No. 91 | No. 92 | No. 93 | No. 94 | No. 95 |
|---|---|---|---|---|---|---|---|
| Composition | SiO₂ | 67.90 | 67.9 | 67.9 | 67.8 | 68.5 | 68.2 |
| [wt %] | Al₂O₃ | 22.3 | 22.3 | 22.3 | 22.5 | 21.9 | 22.0 |
| | B₂O₃ | 0.00 | 0.00 | 0.00 | 0.00 | 0.00 | 0.00 |
| | P₂O₅ | 0.40 | 0.40 | 0.40 | 0.40 | 0.40 | 0.45 |
| | Li₂O | 3.68 | 3.68 | 3.68 | 3.68 | 3.68 | 3.68 |
| | Na₂O | 0.67 | 0.67 | 0.67 | 0.58 | 0.58 | 0.68 |
| | K₂O | 0.01 | 0.01 | 0.01 | 0.00 | 0.00 | 0.02 |
| | MgO | 1.25 | 1.25 | 1.25 | 1.23 | 1.22 | 1.24 |
| | CaO | 0.024 | 0.024 | 0.024 | 0.020 | 0.019 | 0.054 |
| | SrO | 0.00 | 0.00 | 0.00 | 0.00 | 0.00 | 0.00 |
| | BaO | 0.00 | 0.00 | 0.00 | 0.00 | 0.00 | 0.06 |
| | ZnO | 0.00 | 0.00 | 0.00 | 0.00 | 0.00 | 0.00 |
| | TiO₂ | 0.0200 | 0.0200 | 0.0200 | 0.0100 | 0.0100 | 0.1200 |
| | SnO₂ | 1.13 | 1.13 | 1.13 | 1.18 | 1.18 | 1.04 |
| | ZrO₂ | 2.62 | 2.62 | 2.62 | 2.60 | 2.58 | 2.51 |
| | Fe₂O₃ | 0.0090 | 0.0090 | 0.0090 | 0.0050 | 0.0040 | 0.0140 |
| | Y₂O₃ | 0.00 | 0.00 | 0.00 | 0.00 | 0.00 | 0.00 |
| | MoO₃ | 0.0000 | 0.0000 | 0.0000 | 0.0000 | 0.0000 | 0.0000 |
| | Sb₂O₃ | 0.00 | 0.00 | 0.00 | 0.00 | 0.00 | 0.00 |
| | As₂O₃ | 0.00 | 0.00 | 0.00 | 0.00 | 0.00 | 0.00 |
| Composition | Pt | 0.02 | 0.02 | 0.02 | 1.50 | 1.50 | 1.50 |
| [ppm] | Rh | 0.01 | 0.01 | 0.01 | 0.02 | 0.02 | 0.02 |
| | Pt + Rh | 0.03 | 0.03 | 0.03 | 1.52 | 1.52 | 1.52 |

| | | | | | | |
|---|---|---|---|---|---|---|
| Sn/(P + B + Zr + Ti + Sn) | 0.271 | 0.271 | 0.271 | 0.282 | 0.283 | 0.252 |
| Al/(Zr + Sn) | 5.95 | 5.95 | 5.95 | 5.95 | 5.82 | 6.20 |
| (Mg + Zn)/Li | 0.340 | 0.340 | 0.340 | 0.334 | 0.332 | 0.337 |
| Sn/(Zr + Sn) | 0.30 | 0.30 | 0.30 | 0.31 | 0.31 | 0.29 |
| (Si + Al)/Li | 24.51 | 24.51 | 24.51 | 24.54 | 24.57 | 24.51 |
| (Si + Al)/Sn | 79.82 | 79.82 | 79.82 | 76.53 | 76.61 | 86.73 |
| (Li + Na + K)/Zr | 1.66 | 1.66 | 1.66 | 1.64 | 1.65 | 1.74 |
| Ti/Zr | 0.0076 | 0.0076 | 0.0076 | 0.0038 | 0.0039 | 0.0478 |
| Ti/(Ti + Fe) | 0.690 | 0.690 | 0.690 | 0.667 | 0.714 | 0.896 |
| Na + K + Ca + Sr + Ba | 1.95 | 1.95 | 1.95 | 1.83 | 1.82 | 2.05 |
| (Mg + Ca + Sr + Ba)/Zr | 0.49 | 0.49 | 0.49 | 0.48 | 0.48 | 0.54 |
| (Mg + Ca + Sr + Ba)/(Li + Na + K) | 0.29 | 0.29 | 0.29 | 0.29 | 0.29 | 0.31 |
| Al/(Li + (½*(Mg + Zn)) | 6.68 | 6.68 | 6.68 | 6.73 | 6.56 | 6.60 |
| Sb + As | 0.00 | 0.00 | 0.00 | 0.00 | 0.00 | 0.00 |

Before crystallization

| Transmittance[%] | 200 nm | 71.9 | 71.9 | 71.9 | 84.1 | 86.3 | Not measured |
|---|---|---|---|---|---|---|---|
| 3 mm thickness | 250 nm | 20.9 | 20.9 | 20.9 | 24.2 | 24.4 | Not measured |
| | 300 nm | 28.5 | 28.5 | 28.5 | 36.5 | 37.4 | Not measured |
| | 325 nm | 66.0 | 66.0 | 66.0 | 72.7 | 73.6 | Not measured |
| | 350 nm | 84.0 | 84.0 | 84.0 | 86.2 | 86.7 | Not measured |
| | 380 nm | 89.7 | 89.7 | 89.7 | 90.2 | 90.3 | Not measured |
| | 800 nm | 91.5 | 91.5 | 91.5 | 91.6 | 91.8 | Not measured |
| | 1200 nm | 91.3 | 91.3 | 91.3 | 91.7 | 91.9 | Not measured |
| L* | | 96.7 | 96.7 | 96.7 | 96.7 | 96.7 | 96.6 |
| a* | | −0.1 | −0.1 | −0.1 | 0.0 | −0.1 | −0.1 |
| b* | | 0.3 | 0.3 | 0.3 | 0.3 | 0.3 | 0.4 |
| Low temperature | Strain point[° C.] | Not measured | Not measured | Not measured | Not measured | Not measured | Not measured |
| viscosity | Annealing point[° C.] | Not measured | Not measured | Not measured | Not measured | Not measured | Not measured |
| | Glass transition point[° C.] | Not measured | Not measured | Not measured | Not measured | Not measured | 733 |
| High temperature | 10\hat{ }4[° C.] | Not measured | Not measured | Not measured | Not measured | Not measured | 1357 |
| viscosity | 10\hat{ }3[° C.] | Not measured | Not measured | Not measured | Not measured | Not measured | 1542 |
| | 10\hat{ }2.5[° C.] | Not measured | Not measured | Not measured | Not measured | Not measured | 1656 |
| | 10\hat{ }2[° C.] | Not measured | Not measured | Not measured | Not measured | Not measured | 1788 |
| Liquidus temperature[° C.] | | Not measured | Not measured | Not measured | 1409 | Not measured | 1400 |
| Liquidus viscosity[—] | | Not measured | Not measured | Not measured | Not measured | Not measured | 3.8 |
| α[×10⁻⁷/° C.] | 30-380° C. | Not measured | Not measured | Not measured | Not measured | Not measured | 39.2 |

| | | | | | | |
|---|---|---|---|---|---|---|
| Density[g/cm3] | 2.429 | 2.429 | 2.429 | 2.432 | 2.428 | 2.425 |
| β-OH[/mm] | 0.28 | 0.16 | 0.19 | 0.25 | 0.32 | 0.47 |

TABLE 28

| No. 90 | No. 91 | No. 92 | No. 93 | No. 94 | No. 95 |
|---|---|---|---|---|---|
| Crystallization condition | | | | | |
| 780° C.-3 h | 780° C.-3 h | 780° C.-3 h | 780° C.-1.5 h | 810° C.-0.75 h | 780° C.-3 h |
| 890° C.-1 h | 890° C.-1 h | 890° C.-0.25 h | 920° C.-0.5 h | 920° C.-0.25 h | 890° C.-1 h |

After crystallization

| Transmittance[%] | 200 nm | 30.9 | 33 | 35.2 | 35 | 40 | 37.8 |
|---|---|---|---|---|---|---|---|
| 3 mm thickness | 250 nm | 14.8 | 11.9 | 13.1 | 12.8 | 13 | 15.1 |
| | 300 nm | 24.2 | 16.8 | 18.7 | 17.5 | 14.1 | 22.5 |
| | 325 nm | 63.5 | 59.4 | 59.4 | 54.8 | 51.7 | 61.2 |
| | 350 nm | 78.3 | 79 | 77.8 | 73 | 72.9 | 76.6 |
| | 380 nm | 83.4 | 86 | 85.1 | 81 | 82.3 | 82.0 |
| | 800 nm | 90.9 | 91 | 91.2 | 91 | 90.9 | 90.6 |
| | 1200 nm | 91.3 | 91 | 90.6 | 91 | 90.2 | 91.1 |
| L* | | 95.6 | 96.2 | 96.1 | 95.56 | 95.7 | 95.3 |
| a* | | 0.1 | 0.0 | −0.1 | −0.15 | 0.0 | 0.1 |
| b* | | 1.5 | 0.8 | 1.0 | 1.82 | 1.5 | 1.8 |
| Precipitated crystal | | β-Q | β-Q | β-Q | β-Q | β-Q | β-Q |
| Average crystallite size[nm] | | 41 | Not measured | Not measured | Not measured | Not measured | Not measured |
| α[×10⁻⁷/° C.] | 30-380° C. | −1.3 | Not measured | Not measured | Not measured | Not measured | Not measured |
| α[×10⁻⁷/° C.] | 30-750° C. | −0.2 | Not measured | Not measured | Not measured | Not measured | Not measured |

| | | | | | | |
|---|---|---|---|---|---|---|
| Density[g/cm3] | 2.508 | 2.508 | 2.504 | 2.505 | 2.511 | 2.508 |
| Young's Modulus [GPa] | Not measured | Not measured | Not measured | Not measured | Not measured | Not measured |
| Modulus of rigidity [GPa] | Not measured | Not measured | Not measured | Not measured | Not measured | Not measured |
| Poisson's ratio | Not measured | Not measured | Not measured | Not measured | Not measured | Not measured |
| Appearance | Colorless and | Colorless and | Colorless and | Colorless and | Colorless and | Colorless and |
| | transparent | transparent | transparent | transparent | transparent | transparent |

Rate of change before and after crystallization[%]

| | | | | | | |
|---|---|---|---|---|---|---|
| 200 nm | 63.1 | 53.9 | 51.0 | 51.5 | 43.7 | 55.1 |
| 250 nm | 38.7 | 43.2 | 37.6 | 38.9 | 36.1 | 37.7 |
| 300 nm | 35.6 | 40.9 | 34.3 | 38.4 | 50.4 | 38.2 |
| 325 nm | 13.4 | 10.0 | 10.0 | 17.0 | 21.7 | 15.8 |
| 350 nm | 9.4 | 6.2 | 7.4 | 13.2 | 13.3 | 11.2 |
| 380 nm | 7.6 | 3.9 | 5.1 | 9.5 | 8.2 | 9.1 |
| 800 nm | 0.9 | 0.2 | 0.3 | 0.7 | 0.6 | 1.1 |
| 1200 nm | 0.6 | 0.5 | 0.7 | 0.7 | 1.2 | 0.7 |

TABLE 29

| | | No. 96 | No. 97 | No. 98 |
|---|---|---|---|---|
| Composition | SiO₂ | 67.3 | 67.3 | 67.2 |
| [wt %] | Al₂O₃ | 22.3 | 22.3 | 22.3 |
| | B₂O₃ | 0.00 | 0.00 | 0.00 |
| | P₂O₅ | 0.40 | 0.40 | 0.40 |
| | Li₂O | 3.68 | 3.68 | 3.68 |
| | Na₂O | 0.67 | 0.67 | 0.67 |
| | K₂O | 0.01 | 0.01 | 0.01 |
| | MgO | 1.25 | 1.25 | 1.25 |
| | CaO | 0.024 | 0.024 | 0.024 |
| | SrO | 0.00 | 0.00 | 0.00 |
| | BaO | 0.00 | 0.00 | 0.00 |
| | ZnO | 0.00 | 0.00 | 0.00 |
| | TiO₂ | 0.0080 | 0.0080 | 0.0080 |
| | SnO₂ | 1.13 | 1.13 | 1.13 |
| | ZrO₂ | 2.62 | 2.62 | 2.62 |
| | Fe₂O₃ | 0.0050 | 0.0050 | 0.0050 |
| | Y₂O₃ | 0.00 | 0.00 | 0.00 |
| | MoO₃ | 0.0000 | 0.0000 | 0.0000 |
| | Sb₂O₃ | 0.65 | 0.00 | 0.30 |
| | As₂O₃ | 0.00 | 0.65 | 0.38 |
| Composition | Pt | 1.50 | 1.50 | 1.50 |
| [ppm] | Rh | 0.02 | 0.02 | 0.02 |
| | Pt + Rh | 1.52 | 1.52 | 1.52 |

| | | | |
|---|---|---|---|
| Sn/(P + B + Zr + Ti + Sn) | 0.272 | 0.272 | 0.272 |
| Al/(Zr + Sn) | 5.95 | 5.95 | 5.95 |
| (Mg + Zn)/Li | 0.340 | 0.340 | 0.340 |
| Sn/(Zr + Sn) | 0.30 | 0.30 | 0.30 |
| (Si + Al)/Li | 24.33 | 24.33 | 24.33 |
| (Si + Al)/Sn | 79.25 | 79.25 | 79.22 |
| (Li + Na + K)/Zr | 1.66 | 1.66 | 1.66 |
| Ti/Zr | 0.0031 | 0.0031 | 0.0031 |
| Ti/(Ti + Fe) | 0.615 | 0.615 | 0.615 |
| Na + K + Ca + Sr + Ba | 1.95 | 1.95 | 1.95 |
| (Mg + Ca + Sr + Ba)/Zr | 0.49 | 0.49 | 0.49 |
| (Mg + Ca + Sr + Ba)/(Li + Na + K) | 0.29 | 0.29 | 0.29 |
| Al/(Li + (1/2*(Mg + Zn)) | 6.68 | 6.68 | 6.68 |
| Sb + As | 0.65 | 0.65 | 0.68 |

Before crystallization

| Transmittance[%] | 200 | nm | Not measured | Not measured | Not measured |
|---|---|---|---|---|---|
| 3 mm thickness | 250 | nm | Not measured | Not measured | Not measured |
| | 300 | nm | Not measured | Not measured | Not measured |
| | 325 | nm | Not measured | Not measured | Not measured |
| | 350 | nm | Not measured | Not measured | Not measured |
| | 380 | nm | Not measured | Not measured | Not measured |
| | 800 | nm | Not measured | Not measured | Not measured |
| | 1200 | nm | Not measured | Not measured | Not measured |
| L* | | | Not measured | Not measured | Not measured |
| a* | | | Not measured | Not measured | Not measured |
| b* | | | Not measured | Not measured | Not measured |
| Low temperature | Strain point[° C.] | | Not measured | Not measured | Not measured |
| viscosity | Annealing point[° C.] | | Not measured | Not measured | Not measured |
| | Glass transition point[° C.] | | Not measured | Not measured | Not measured |
| High temperature | 10\hat{ }4[° C.] | | Not measured | Not measured | Not measured |
| viscosity | 10\hat{ }3[° C.] | | Not measured | Not measured | Not measured |
| | 10\hat{ }2.5[° C.] | | Not measured | Not measured | Not measured |
| | 10\hat{ }2[° C.] | | Not measured | Not measured | Not measured |
| Liquidus temperature[° C.] | | | Not measured | Not measured | Not measured |
| Liquidus viscosity[—] | | | Not measured | Not measured | Not measured |
| α[×10⁻⁷/° C.] | 30-380° | C. | Not measured | Not measured | Not measured |

| | | | |
|---|---|---|---|
| Density[g/cm3] | Not measured | Not measured | Not measured |
| β -OH[/mm] | 0.001 | 1.12 | 0.69 |

TABLE 30

| | | |
|---|---|---|
| No. 90 | No. 91 | No. 92 |

After crystallization

| Crystallization condition | | | 780° C.-3 h | 780° C.-3 h | 780° C.-3 h |
|---|---|---|---|---|---|
| | | | 890° C.-1 h | 890° C.-1 h | 890° C.-0.25 h |
| Transmittance[%] | 200 | nm | 30.9 | 33 | 35.2 |
| 3 mm thickness | 250 | nm | 14.8 | 11.9 | 13.1 |
| | 300 | nm | 24.2 | 16.8 | 18.7 |
| | 325 | nm | 63.5 | 59.4 | 59.4 |
| | 350 | nm | 78.3 | 79 | 77.8 |
| | 380 | nm | 83.4 | 86 | 85.1 |
| | 800 | nm | 90.9 | 91 | 91.2 |
| | 1200 | nm | 91.3 | 91 | 90.6 |
| L* | | | 95.6 | 96.2 | 96.1 |
| a* | | | 0.1 | 0.0 | −0.1 |
| b* | | | 1.5 | 0.8 | 1.0 |
| Precipitated crystal | | | β -Q | β -Q | β -Q |
| Average crystallite size[nm] | | | 41 | Not measured | Not measured |
| α[×10⁻⁷/° C.] | 30-380° | C. | −1.3 | Not measured | Not measured |
| α[×10⁻⁷/° C.] | 30-750° | C. | −0.2 | Not measured | Not measured |

| Density[g/cm3] | 2.508 | 2.508 | 2.504 |
|---|---|---|---|
| Young's Modulus[GPa] | Not measured | Not measured | Not measured |
| Modulus of rigidity [GPa] | Not measured | Not measured | Not measured |
| Poisson's ratio | Not measured | Not measured | Not measured |
| Appearance | Colorless and | Colorless and | Colorless and |
| | transparent | transparent | transparent |

Rate of change before and after crystallization[%]

| | | | |
|---|---|---|---|
| 200 nm | 63.1 | 53.9 | 51.0 |
| 250 nm | 38.7 | 43.2 | 37.6 |
| 300 nm | 35.6 | 40.9 | 34.3 |
| 325 nm | 13.4 | 10.0 | 10.0 |
| 350 nm | 9.4 | 6.2 | 7.4 |
| 380 nm | 7.6 | 3.9 | 5.1 |
| 800 nm | 0.9 | 0.2 | 0.3 |
| 1200 nm | 0.6 | 0.5 | 0.7 |

TABLE 31

| | | No. 99 | No. 100 | No. 101 | No. 102 | No. 103 | No.104 |
|---|---|---|---|---|---|---|---|
| Composition | SiO₂ | 67.30 | 67.80 | 67.10 | 67.70 | 66.60 | 67.10 |
| [wt %] | Al₂O₃ | 22.80 | 22.20 | 22.80 | 22.30 | 22.80 | 22.70 |
| | B₂O₃ | 0.00 | 0.00 | 0.00 | 0.00 | 0.00 | 0.00 |
| | P₂O₅ | 0.43 | 0.40 | 0.41 | 0.40 | 0.41 | 0.41 |
| | Li₂O | 3.62 | 3.67 | 3.68 | 3.67 | 3.66 | 3.67 |
| | Na₂O | 0.69 | 0.70 | 0.69 | 0.69 | 0.71 | 0.70 |
| | K₂O | 0.00 | 0.35 | 0.00 | 0.00 | 0.00 | 0.00 |
| | MgO | 1.28 | 1.23 | 1.28 | 1.23 | 1.28 | 1.28 |
| | CaO | 0.05 | 0.05 | 0.24 | 0.05 | 0.05 | 0.05 |
| | SrO | 0.001 | 0.001 | 0.001 | 0.460 | 0.006 | 0.001 |
| | BaO | 0.001 | 0.001 | 0.001 | 0.006 | 0.760 | 0.001 |
| | ZnO | 0.001 | 0.001 | 0.001 | 0.001 | 0.001 | 0.001 |
| | TiO₂ | 0.0150 | 0.0150 | 0.0160 | 0.0160 | 0.0170 | 0.0140 |
| | SnO₂ | 1.16 | 1.14 | 1.17 | 1.14 | 1.16 | 1.16 |
| | ZrO₂ | 2.51 | 2.47 | 2.45 | 2.48 | 2.44 | 2.48 |
| | Fe₂O₃ | 0.0100 | 0.0100 | 0.0100 | 0.0100 | 0.0100 | 0.0100 |
| | Y₂O₃ | 0.00 | 0.00 | 0.00 | 0.00 | 0.00 | 0.00 |
| | MoO₃ | 0.0000 | 0.0000 | 0.0000 | 0.0000 | 0.0000 | 0.0000 |
| | Sb₂O₃ | 0.00 | 0.00 | 0.00 | 0.00 | 0.00 | 0.00 |
| | As₂O₃ | 0.00 | 0.00 | 0.00 | 0.00 | 0.00 | 0.00 |
| Composition | Pt | 0.02 | 0.02 | 0.02 | 0.02 | 0.02 | 0.02 |
| [ppm] | Rh | 0.01 | 0.01 | 0.01 | 0.01 | 0.01 | 0.01 |
| | Pt + Rh | 0.03 | 0.03 | 0.03 | 0.03 | 0.03 | 0.03 |

| | | | | | | |
|---|---|---|---|---|---|---|
| Sn/(P + B + Zr + Ti + Sn) | 0.282 | 0.283 | 0.289 | 0.282 | 0.288 | 0.285 |
| Al/(Zr + Sn) | 6.21 | 6.15 | 6.30 | 6.16 | 6.33 | 6.24 |
| (Mg + Zn)/Li | 0.354 | 0.335 | 0.348 | 0.335 | 0.350 | 0.349 |
| Sn/(Zr + Sn) | 0.32 | 0.32 | 0.32 | 0.31 | 0.32 | 0.32 |
| (Si + Al)/Li | 24.89 | 24.52 | 24.43 | 24.52 | 24.43 | 24.47 |
| (Si + Al)/Sn | 77.67 | 78.95 | 76.84 | 78.95 | 77.07 | 77.41 |
| (Li + Na + K)/Zr | 1.72 | 1.91 | 1.79 | 1.76 | 1.79 | 1.76 |
| Ti/Zr | 0.0060 | 0.0061 | 0.0065 | 0.0065 | 0.0070 | 0.0056 |
| Ti/(Ti + Fe) | 0.600 | 0.600 | 0.615 | 0.615 | 0.630 | 0.583 |
| Na + K + Ca + Sr + Ba | 0.74 | 1.10 | 0.94 | 1.21 | 1.53 | 0.75 |
| (Mg + Ca + Sr + Ba)/Zr | 0.53 | 0.52 | 0.62 | 0.70 | 0.86 | 0.54 |
| (Mg + Ca + Sr + Ba)/(Li + Na + K) | 0.31 | 0.27 | 0.35 | 0.40 | 0.48 | 0.30 |
| Al/(Li + (½*(Mg + Zn)) | 6.94 | 6.66 | 6.84 | 6.69 | 6.87 | 6.83 |
| Sb + As | 0.00 | 0.00 | 0.00 | 0.00 | 0.00 | 0.00 |

Brfore crystallization

| Transmittance[%] | 200 nm | Not measured | Not measured | Not measured | Not measured | Not measured | Not measured |
|---|---|---|---|---|---|---|---|
| 3 mm thickness | 250 nm | Not measured | Not measured | Not measured | Not measured | Not measured | Not measured |
| | 300 nm | Not measured | Not measured | Not measured | Not measured | Not measured | Not measured |
| | 325 nm | Not measured | Not measured | Not measured | Not measured | Not measured | Not measured |
| | 350 nm | Not measured | Not measured | Not measured | Not measured | Not measured | Not measured |
| | 380 nm | Not measured | Not measured | Not measured | Not measured | Not measured | Not measured |
| | 800 nm | Not measured | Not measured | Not measured | Not measured | Not measured | Not measured |
| | 1200 nm | Not measured | Not measured | Not measured | Not measured | Not measured | Not measured |
| L* | | Not measured | Not measured | Not measured | Not measured | Not measured | Not measured |
| a* | | Not measured | Not measured | Not measured | Not measured | Not measured | Not measured |
| b* | | Not measured | Not measured | Not measured | Not measured | Not measured | Not measured |
| Low temperature | Strain point[° C.] | Not measured | Not measured | Not measured | Not measured | Not measured | Not measured |
| viscosity | Annealing point[° C.] | Not measured | Not measured | Not measured | Not measured | Not measured | Not measured |
| | Glass transition point[° C.] | Not measured | Not measured | Not measured | Not measured | Not measured | Not measured |
| High temperature | 10\hat{ }4[° C.] | 1349 | Not measured | Not measured | Not measured | Not measured | Not measured |
| viscosity | 10\hat{ }3[° C.] | 1531 | Not measured | Not measured | Not measured | Not measured | Not measured |
| | 10\hat{ }2.5[° C.] | 1644 | Not measured | Not measured | Not measured | Not measured | Not measured |
| | 10\hat{ }2[° C.] | 1777 | Not measured | Not measured | Not measured | Not measured | Not measured |
| Liquidus temperature[° C.] | | Not measured | Not measured | Not measured | Not measured | Not measured | Not measured |
| Liquidus viscosity[—] | | Not measured | Not measured | Not measured | Not measured | Not measured | Not measured |
| α[×10⁻⁷/° C.] | 30-380° C. | Not measured | Not measured | Not measured | Not measured | Not measured | Not measured |

| | | | | | | |
|---|---|---|---|---|---|---|
| Density[g/cm3] | 2.435 | 2.428 | 2.437 | 2.439 | 2.447 | 2.440 |
| β-OH[/mm] | 0.43 | 0.37 | 0.40 | 0.40 | 0.40 | 0.42 |

TABLE 32

| | No. 99 | No. 100 | No. 101 | No. 102 | No. 103 | No. 104 |
|---|---|---|---|---|---|---|
| Crystallization condition | | | | | | |
| | 765° C.-3 h | 765° C.-3 h | 765° C.-3 h | 765° C.-3 h | 765° C.-3 h | 765° C.-3 h |
| | 890° C.-1 h | 890° C.-1 h | 890° C.-1 h | 890° C.-1 h | 890° C.-1 h | 890° C.-1 h |

After crystallization

| Transmittance[%] | 200 nm | 47.3 | 47.3 | 47.3 | 47.3 | 47.3 | 47.3 |
|---|---|---|---|---|---|---|---|
| 3 mm thickness | 250 nm | 20.1 | 21.8 | 19.7 | 20.5 | 20.7 | 19.3 |
| | 300 nm | 19.5 | 20.8 | 19.3 | 20.1 | 20.0 | 18.1 |
| | 325 nm | 58.5 | 53.5 | 57.1 | 58.2 | 57.6 | 56.8 |
| | 350 nm | 77.4 | 70.3 | 75.9 | 76.5 | 76.0 | 76.5 |
| | 380 nm | 84.5 | 78.2 | 83.3 | 83.6 | 83.3 | 84.1 |
| | 800 nm | 91.0 | 90.7 | 90.9 | 90.9 | 90.9 | 91.0 |
| | 1200 nm | 90.7 | 90.5 | 90.6 | 90.5 | 90.6 | 90.7 |
| L* | | 95.9 | 95.1 | 95.8 | 95.8 | 95.7 | 95.9 |
| a* | | −0.1 | −0.2 | −0.1 | −0.1 | −0.1 | −0.1 |
| b* | | 1.2 | 2.6 | 1.4 | 1.4 | 1.4 | 1.2 |
| Precipitated crystal | | β-Q | Not measured | Not measured | Not measured | Not measured | Not measured |
| Average crystallite size[nm] | | Not measured | Not measured | Not measured | Not measured | Not measured | Not measured |
| α[×10⁻⁷/° C.] | 30-380° C. | −2.4 | 0.5 | −0.4 | 0.1 | −1.4 | −1.7 |
| α[×10⁻⁷/° C.] | 30-750° C. | −0.7 | 1.9 | 0.6 | 1.4 | 0.4 | −0.1 |

| | | | | | | |
|---|---|---|---|---|---|---|
| Density[g/cm3] | 2.511 | 2.499 | 2.510 | 2.514 | 2.514 | 2.513 |
| Young's Modulus [GPa] | Not measured | Not measured | Not measured | Not measured | Not measured | Not measured |
| Modulus of rigidity [GPa] | Not measured | Not measured | Not measured | Not measured | Not measured | Not measured |
| Poisson's ratio | Not measured | Not measured | Not measured | Not measured | Not measured | Not measured |
| Appearance | Colorless and | Colorless and | Colorless and | Colorless and | Colorless and | Colorless and |
| | transparent | transparent | transparent | transparent | transparent | transparent |

Rate of change before and after crystallization[%]

| | | | | | | |
|---|---|---|---|---|---|---|
| 200 nm | Not measured | Not measured | Not measured | Not measured | Not measured | Not measured |
| 250 nm | Not measured | Not measured | Not measured | Not measured | Not measured | Not measured |
| 300 nm | Not measured | Not measured | Not measured | Not measured | Not measured | Not measured |
| 325 nm | Not measured | Not measured | Not measured | Not measured | Not measured | Not measured |
| 350 nm | Not measured | Not measured | Not measured | Not measured | Not measured | Not measured |
| 380 nm | Not measured | Not measured | Not measured | Not measured | Not measured | Not measured |
| 800 nm | Not measured | Not measured | Not measured | Not measured | Not measured | Not measured |
| 1200 nm | Not measured | Not measured | Not measured | Not measured | Not measured | Not measured |

TABLE 33

| | | No. 105 | No. 106 | No. 107 | No. 108 | No. 109 | No. 110 |
|---|---|---|---|---|---|---|---|
| Composition | SiO₂ | 67.10 | 67.40 | 67.60 | 67.50 | 67.00 | 68.23 |
| [wt %] | Al₂O₃ | 22.20 | 22.60 | 22.50 | 23.00 | 22.60 | 22.41 |
| | B₂O₃ | 0.00 | 0.00 | 0.00 | 0.00 | 0.00 | 0.00 |
| | P₂O₅ | 0.40 | 0.41 | 0.41 | 0.41 | 0.96 | 0.00 |
| | Li₂O | 3.65 | 3.67 | 3.67 | 3.69 | 3.66 | 3.70 |
| | Na₂O | 0.67 | 0.69 | 0.93 | 0.45 | 0.69 | 0.67 |
| | K₂O | 0.004 | 0.004 | 0.004 | 0.008 | 0.003 | 0.003 |
| | MgO | 1.24 | 1.27 | 1.25 | 1.28 | 1.27 | 1.26 |
| | CaO | 0.05 | 0.05 | 0.05 | 0.05 | 0.05 | 0.05 |
| | SrO | 0.001 | 0.001 | 0.001 | 0.001 | 0.001 | 0.001 |
| | BaO | 0.001 | 0.001 | 0.001 | 0.001 | 0.001 | 0.001 |
| | ZnO | 0.00 | 0.00 | 0.00 | 0.00 | 0.00 | 0.00 |
| | TiO₂ | 0.0150 | 0.3200 | 0.0150 | 0.0160 | 0.0150 | 0.0150 |
| | SnO₂ | 1.14 | 1.15 | 1.14 | 1.16 | 1.15 | 1.14 |
| | ZrO₂ | 2.45 | 2.40 | 2.43 | 2.41 | 2.46 | 2.48 |
| | Fe₂O₃ | 0.0100 | 0.0100 | 0.0100 | 0.0100 | 0.0100 | 0.0100 |
| | Y₂O₃ | 0.89 | 0.00 | 0.00 | 0.00 | 0.00 | 0.00 |
| | MoO₃ | 0.00000 | 0.00000 | 0.00000 | 0.00000 | 0.00000 | 0.00000 |
| | Sb₂O₃ | 0.00 | 0.00 | 0.00 | 0.00 | 0.00 | 0.00 |
| | As₂O₃ | 0.00 | 0.00 | 0.00 | 0.00 | 0.00 | 0.00 |
| Composition | Pt | 0.02 | 0.02 | 0.02 | 0.02 | 0.02 | 0.02 |
| [ppm] | Rh | 0.01 | 0.01 | 0.01 | 0.01 | 0.01 | 0.01 |
| | Pt + Rh | 0.03 | 0.03 | 0.03 | 0.03 | 0.03 | 0.03 |

| | | | | | | |
|---|---|---|---|---|---|---|
| Sn/(P + B + Zr + Ti + Sn) | 0.285 | 0.269 | 0.285 | 0.290 | 0.251 | 0.313 |
| Al/(Zr + Sn) | 6.18 | 6.37 | 6.30 | 6.44 | 6.26 | 6.20 |
| (Mg + Zn)/Li | 0.340 | 0.346 | 0.341 | 0.347 | 0.347 | 0.340 |
| Sn/(Zr + Sn) | 0.32 | 0.32 | 0.32 | 0.32 | 0.32 | 0.31 |
| (Si + Al)/Li | 24.47 | 24.52 | 24.55 | 24.53 | 24.48 | 24.51 |
| (Si + Al)/Sn | 78.33 | 78.26 | 79.04 | 78.02 | 77.91 | 79.82 |
| (Li + Na + K)/Zr | 1.76 | 1.82 | 1.89 | 1.72 | 1.77 | 1.76 |
| Ti/Zr | 0.0061 | 0.1333 | 0.0062 | 0.0066 | 0.0061 | 0.0060 |
| Ti/(Ti + Fe) | 0.600 | 0.970 | 0.600 | 0.615 | 0.600 | 0.600 |
| Na + K + Ca + Sr + Ba | 0.72 | 0.74 | 0.98 | 0.51 | 0.74 | 0.72 |
| (Mg + Ca + Sr + Ba)/Zr | 0.53 | 0.55 | 0.53 | 0.55 | 0.54 | 0.53 |
| (Mg + Ca + Sr + Ba)/(Li + Na + K) | 0.30 | 0.30 | 0.28 | 0.32 | 0.30 | 0.30 |
| Al/(Li + (½*(Mg + Zn)) | 6.70 | 6.79 | 6.76 | 6.87 | 6.81 | 6.69 |
| Sb + As | 0.00 | 0.00 | 0.00 | 0.00 | 0.00 | 0.00 |

Before crystallization

| Transmittance[%] | 200 nm | Not measured | Not measured | Not measured | Not measured | Not measured | Not measured |
|---|---|---|---|---|---|---|---|
| 3 mm thickness | 250 nm | Not measured | Not measured | Not measured | Not measured | Not measured | Not measured |
| | 300 nm | Not measured | Not measured | Not measured | Not measured | Not measured | Not measured |
| | 325 nm | Not measured | Not measured | Not measured | Not measured | Not measured | Not measured |
| | 350 nm | Not measured | Not measured | Not measured | Not measured | Not measured | Not measured |
| | 380 nm | Not measured | Not measured | Not measured | Not measured | Not measured | Not measured |
| | 800 nm | Not measured | Not measured | Not measured | Not measured | Not measured | Not measured |
| | 1200 nm | Not measured | Not measured | Not measured | Not measured | Not measured | Not measured |
| L* | | Not measured | Not measured | Not measured | Not measured | Not measured | Not measured |
| a* | | Not measured | Not measured | Not measured | Not measured | Not measured | Not measured |
| b* | | Not measured | Not measured | Not measured | Not measured | Not measured | Not measured |
| Low temperature | Strain point[° C.] | Not measured | Not measured | Not measured | Not measured | Not measured | Not measured |
| viscosity | Annealing point[° C.] | Not measured | Not measured | Not measured | Not measured | Not measured | Not measured |
| | Glass transition point | Not measured | Not measured | Not measured | Not measured | Not measured | Not measured |
| | [° C.] | | | | | | |
| High temperature | 10\hat{ }4[° C.] | Not measured | Not measured | Not measured | Not measured | Not measured | Not measured |
| viscosity | 10\hat{ }3[° C.] | Not measured | Not measured | Not measured | Not measured | Not measured | Not measured |
| | 10\hat{ }2.5[° C.] | Not measured | Not measured | Not measured | Not measured | Not measured | Not measured |
| | 10\hat{ }2[° C.] | Not measured | Not measured | Not measured | Not measured | Not measured | Not measured |
| Liquidus temperature[° C.] | | Not measured | Not measured | Not measured | Not measured | Not measured | Not measured |
| Liquidus viscosity[—] | | Not measured | Not measured | Not measured | Not measured | Not measured | Not measured |
| α[×10⁻⁷/° C.] | 30-380° C. | Not measured | Not measured | Not measured | Not measured | Not measured | Not measured |

| | | | | | | |
|---|---|---|---|---|---|---|
| Density[g/cm3] | 2.448 | 2.433 | 2.433 | 2.433 | 2.431 | 2.434 |
| β-OH[/mm] | 0.40 | 0.39 | 0.40 | 0.37 | 0.41 | 0.37 |

TABLE 34

| No. 105 | No. 106 | No. 107 | No. 108 | No. 109 | No. 110 |
|---|---|---|---|---|---|
| Crystallization condition | | | | | |
| 765° C.-3 h | 765° C.-3 h | 765° C.-3 h | 765° C.-3 h | 765° C.-3 h | 765° C.-3 h |
| 890° C.-1 h | 890° C.-1 h | 890° C.-1 h | 890° C.-1 h | 890° C.-1 h | 890° C.-1 h |

After crystallization

| Transmittance[%] | 200 nm | 47.3 | 47.3 | 47.3 | 47.3 | 47.3 | 47.3 |
|---|---|---|---|---|---|---|---|
| 3 mm thickness | 250 nm | 23.7 | 4.1 | 20.7 | 17.4 | 18.5 | 18.8 |
| | 300 nm | 21.0 | 1.9 | 22.1 | 15.1 | 19.5 | 17.7 |
| | 325 nm | 49.3 | 8.9 | 57.7 | 50.0 | 58.5 | 52.1 |
| | 350 nm | 65.7 | 44.7 | 74.1 | 71.9 | 77.2 | 71.9 |
| | 380 nm | 74.2 | 73.4 | 81.1 | 81.4 | 84.5 | 80.2 |
| | 800 nm | 89.2 | 91.1 | 90.8 | 91.0 | 91.1 | 90.5 |
| | 1200 nm | 90.4 | 90.7 | 90.5 | 90.6 | 90.6 | 90.5 |
| L* | | 93.9 | 96.0 | 95.4 | 95.7 | 95.9 | 95.2 |
| a* | | −0.1 | −0.3 | −0.1 | −0.2 | −0.1 | −0.1 |
| b* | | 3.1 | 1.5 | 2.0 | 1.7 | 1.2 | 2.0 |
| Precipitated crystal | | β-Q | Not measured | Not measured | Not measured | Not measured | Not measured |
| Average crystallite size[nm] | | Not measured | Not measured | Not measured | Not measured | Not measured | Not measured |
| α[×10⁻⁷/° C.] | 30-380° C. | Not measured | Not measured | Not measured | Not measured | Not measured | Not measured |
| α[×10⁻⁷/° C.] | 30-750° C. | Not measured | Not measured | Not measured | Not measured | Not measured | Not measured |

| | | | | | | |
|---|---|---|---|---|---|---|
| Density[g/cm3] | 2.520 | 2.513 | 2.503 | 2.514 | 2.508 | 2.505 |
| Young's Modulus [ GPa] | Not measured | Not measured | Not measured | Not measured | Not measured | Not measured |
| Modulus of rigidity [GPa] | Not measured | Not measured | Not measured | Not measured | Not measured | Not measured |
| Poisson's ratio | Not measured | Not measured | Not measured | Not measured | Not measured | Not measured |
| Appearance | Colorless and | Colorless and | Colorless and | Colorless and | Colorless and | Colorless and |
| | transparent | transparent | transparent | transparent | transparent | transparent |

Rate of change before and after crystallization[%]

| | | | | | | |
|---|---|---|---|---|---|---|
| 200 nm | Not measured | Not measured | Not measured | Not measured | Not measured | Not measured |
| 250 nm | Not measured | Not measured | Not measured | Not measured | Not measured | Not measured |
| 300 nm | Not measured | Not measured | Not measured | Not measured | Not measured | Not measured |
| 325 nm | Not measured | Not measured | Not measured | Not measured | Not measured | Not measured |
| 350 nm | Not measured | Not measured | Not measured | Not measured | Not measured | Not measured |
| 380 nm | Not measured | Not measured | Not measured | Not measured | Not measured | Not measured |
| 800 nm | Not measured | Not measured | Not measured | Not measured | Not measured | Not measured |
| 1200 nm | Not measured | Not measured | Not measured | Not measured | Not measured | Not measured |

TABLE 35

| | | No. 111 | No. 112 | No. 113 | No. 114 | No. 115 | No. 116 |
|---|---|---|---|---|---|---|---|
| Composition | SiO₂ | 68.23 | 67.56 | 68.35 | 67.85 | 68.06 | 67.93 |
| [wt %] | Al₂O₃ | 22.41 | 22.19 | 22.45 | 22.28 | 22.35 | 22.31 |
| | B₂O₃ | 0.00 | 0.00 | 0.00 | 0.00 | 0.00 | 0.00 |
| | P₂O₅ | 0.00 | 0.40 | 0.40 | 0.40 | 0.40 | 0.40 |
| | Li₂O | 3.70 | 3.66 | 3.70 | 3.68 | 3.69 | 3.68 |
| | Na₂O | 0.67 | 0.67 | 0.67 | 0.67 | 0.67 | 0.67 |
| | K₂O | 0.003 | 0.003 | 0.003 | 0.003 | 0.003 | 0.003 |
| | MgO | 1.26 | 1.24 | 1.26 | 1.40 | 1.10 | 1.25 |
| | CaO | 0.05 | 0.05 | 0.05 | 0.05 | 0.05 | 0.05 |
| | SrO | 0.001 | 0.001 | 0.001 | 0.001 | 0.001 | 0.001 |
| | BaO | 0.001 | 0.001 | 0.001 | 0.001 | 0.001 | 0.001 |
| | ZnO | 0.001 | 0.001 | 0.001 | 0.001 | 0.001 | 0.001 |
| | TiO₂ | 0.0150 | 0.0150 | 0.0150 | 0.0150 | 0.0150 | 0.0150 |
| | SnO₂ | 1.14 | 1.70 | 0.55 | 1.13 | 1.13 | 1.13 |
| | ZrO₂ | 2.48 | 2.46 | 2.49 | 2.47 | 2.47 | 2.47 |
| | Fe₂O₃ | 0.0100 | 0.0100 | 0.0100 | 0.0100 | 0.0100 | 0.0100 |
| | Y₂O₃ | 0.00 | 0.00 | 0.00 | 0.00 | 0.00 | 0.00 |
| | MoO₃ | 0.00000 | 0.00000 | 0.00000 | 0.00000 | 0.00000 | 0.00000 |
| | Sb₂O₃ | 0.00 | 0.00 | 0.00 | 0.00 | 0.00 | 0.00 |
| | As₂O₃ | 0.00 | 0.00 | 0.00 | 0.00 | 0.00 | 0.00 |
| Composition | Pt | 0.02 | 0.02 | 0.02 | 0.02 | 0.02 | 0.02 |
| [ppm] | Rh | 0.01 | 0.01 | 0.01 | 0.01 | 0.01 | 0.01 |
| | Pt + Rh | 0.03 | 0.03 | 0.03 | 0.03 | 0.03 | 0.03 |

| | | | | | | |
|---|---|---|---|---|---|---|
| Sn/(P + B + Zr + Ti + Sn) | 0.313 | 0.373 | 0.160 | 0.281 | 0.282 | 0.282 |
| Al/(Zr + Sn) | 6.20 | 5.33 | 7.39 | 6.20 | 6.20 | 6.20 |
| (Mg + Zn)/Li | 0.340 | 0.340 | 0.340 | 0.382 | 0.298 | 0.340 |
| Sn/(Zr + Sn) | 0.31 | 0.41 | 0.18 | 0.31 | 0.31 | 0.31 |
| (Si + Al)/Li | 24.51 | 24.51 | 24.51 | 24.51 | 24.51 | 24.51 |
| (Si + Al)/Sn | 79.82 | 52.69 | 164.59 | 79.82 | 79.82 | 79.82 |
| (Li + Na + K)/Zr | 1.76 | 1.76 | 1.76 | 1.76 | 1.76 | 1.76 |
| Ti/Zr | 0.0060 | 0.0061 | 0.0060 | 0.0061 | 0.0061 | 0.0061 |
| Ti/(Ti + Fe) | 0.600 | 0.600 | 0.600 | 0.600 | 0.600 | 0.600 |
| Na + K + Ca + Sr + Ba | 0.72 | 0.72 | 0.72 | 0.72 | 0.72 | 0.72 |
| (Mg + Ca + Sr + Ba)/Zr | 0.53 | 0.53 | 0.53 | 0.59 | 0.46 | 0.53 |
| (Mg + Ca + Sr + Ba)/(Li + Na + K) | 0.30 | 0.30 | 0.30 | 0.33 | 0.26 | 0.30 |
| Al/(Li + (½*(Mg + Zn)) | 6.69 | 6.68 | 6.69 | 6.76 | 6.61 | 6.69 |
| Sb + As | 0.00 | 0.00 | 0.00 | 0.00 | 0.00 | 0.00 |

Before crystallization

| Transmittance[%] | 200 nm | Not measured | Not measured | Not measured | Not measured | Not measured | Not measured |
|---|---|---|---|---|---|---|---|
| 3 mm thickness | 250 nm | Not measured | Not measured | Not measured | Not measured | Not measured | Not measured |
| | 300 nm | Not measured | Not measured | Not measured | Not measured | Not measured | Not measured |
| | 325 nm | Not measured | Not measured | Not measured | Not measured | Not measured | Not measured |
| | 350 nm | Not measured | Not measured | Not measured | Not measured | Not measured | Not measured |
| | 380 nm | Not measured | Not measured | Not measured | Not measured | Not measured | Not measured |
| | 800 nm | Not measured | Not measured | Not measured | Not measured | Not measured | Not measured |
| | 1200 nm | Not measured | Not measured | Not measured | Not measured | Not measured | Not measured |
| L* | | Not measured | Not measured | Not measured | Not measured | Not measured | Not measured |
| a* | | Not measured | Not measured | Not measured | Not measured | Not measured | Not measured |
| b* | | Not measured | Not measured | Not measured | Not measured | Not measured | Not measured |
| Low temperature | Strain point[° C.] | Not measured | Not measured | Not measured | Not measured | Not measured | Not measured |
| viscosity | Annealing point[° C.] | Not measured | Not measured | Not measured | Not measured | Not measured | Not measured |
| | Glass transition point[° C.] | Not measured | Not measured | Not measured | Not measured | Not measured | Not measured |
| High temperature | 10\hat{ }4[° C.] | Not measured | Not measured | Not measured | Not measured | Not measured | Not measured |
| viscosity | 10\hat{ }3[° C.] | Not measured | Not measured | Not measured | Not measured | Not measured | Not measured |
| | 10\hat{ }2.5[° C.] | Not measured | Not measured | Not measured | Not measured | Not measured | Not measured |
| | 10\hat{ }2[° C.] | Not measured | Not measured | Not measured | Not measured | Not measured | Not measured |
| Liquidus temperature[° C.] | | Not measured | Not measured | Not measured | Not measured | Not measured | Not measured |
| Liquidus viscosity[—] | | Not measured | Not measured | Not measured | Not measured | Not measured | Not measured |
| α[×10⁻⁷/° C.] | 30-380° C. | Not measured | Not measured | Not measured | Not measured | Not measured | Not measured |

| | | | | | | |
|---|---|---|---|---|---|---|
| Density[g/cm3] | 2.434 | 2.444 | 2.421 | 2.435 | 2.431 | 2.435 |
| β-OH[/mm] | 0.37 | 0.38 | 0.40 | 0.43 | 0.37 | 0.40 |

TABLE 36

| No. 111 | No. 112 | No. 113 | No. 114 | No. 115 | No. 116 |
|---|---|---|---|---|---|
| Crystallization condition | | | | | |
| 765° C.-3 h | 765° C.-3 h | 765° C.-3 h | 765° C.-3 h | 765° C.-3 h | 765° C.-3 h |
| 890° C.-1 h | 890° C.-1 h | 890° C.-1 h | 890° C.-1 h | 890° C.-1 h | 890° C.-1 h |

After crystallization

| Transmittance[%] | 200 nm | 47.3 | 47.3 | 47.3 | 47.3 | 47.3 | 47.3 |
|---|---|---|---|---|---|---|---|
| 3 mm thickness | 250 nm | 18.8 | 17.0 | 34.0 | 17.8 | 20.0 | 14.7 |
| | 300 nm | 17.7 | 12.8 | 20.2 | 17.9 | 19.9 | 11.7 |
| | 325 nm | 52.1 | 44.7 | 26.2 | 55.8 | 58.6 | 51.2 |
| | 350 nm | 71.9 | 70.3 | 36.8 | 75.3 | 77.0 | 73.7 |
| | 380 nm | 80.2 | 81.0 | 44.6 | 83.1 | 84.1 | 83.2 |
| | 800 nm | 90.5 | 90.8 | 56.1 | 90.9 | 91.0 | 91.0 |
| | 1200 nm | 90.5 | 90.5 | 67.8 | 90.6 | 90.7 | 90.7 |
| L* | | 95.2 | 95.6 | 75.8 | 95.7 | 95.9 | 95.9 |
| a* | | −0.1 | −0.2 | 0.6 | −0.1 | −0.1 | −0.1 |
| b* | | 2.0 | 1.7 | 1.9 | 1.4 | 1.3 | 1.3 |
| Precipitated crystal | | β-Q | Not measured | Not measured | Not measured | Not measured | Not measured |
| Average crystallite size[nm] | | Not measured | Not measured | Not measured | Not measured | Not measured | Not measured |
| α[×10⁻⁷/° C.] | 30-380° C. | Not measured | Not measured | Not measured | −0.1 | −3.0 | Not measured |
| α[×10⁻⁷/° C.] | 30-750° C. | Not measured | Not measured | Not measured | 1.4 | −1.7 | Not measured |

| | | | | | | |
|---|---|---|---|---|---|---|
| Density[g/cm3] | 2.505 | 2.528 | 2.493 | 2.510 | 2.508 | 2.510 |
| Young's Modulus [ GPa] | Not measured | Not measured | Not measured | Not measured | Not measured | Not measured |
| Modulus of rigidity [GPa] | Not measured | Not measured | Not measured | Not measured | Not measured | Not measured |
| Poisson's ratio | Not measured | Not measured | Not measured | Not measured | Not measured | Not measured |
| Appearance | Colorless and | Colorless and | Colorless and | Colorless and | Colorless and | Colorless and |
| | transparent | transparent | transparent | transparent | transparent | transparent |

Rate of change before and after crystallization[%]

| | | | | | | |
|---|---|---|---|---|---|---|
| 200 nm | Not measured | Not measured | Not measured | Not measured | Not measured | Not measured |
| 250 nm | Not measured | Not measured | Not measured | Not measured | Not measured | Not measured |
| 300 nm | Not measured | Not measured | Not measured | Not measured | Not measured | Not measured |
| 325 nm | Not measured | Not measured | Not measured | Not measured | Not measured | Not measured |
| 350 nm | Not measured | Not measured | Not measured | Not measured | Not measured | Not measured |
| 380 nm | Not measured | Not measured | Not measured | Not measured | Not measured | Not measured |
| 800 nm | Not measured | Not measured | Not measured | Not measured | Not measured | Not measured |
| 1200 nm | Not measured | Not measured | Not measured | Not measured | Not measured | Not measured |

TABLE 37

| | | No. 117 | No. 118 | No. 119 | No. 120 |
|---|---|---|---|---|---|
| Composition | SiO₂ | 67.64 | 68.27 | 69.04 | 70.17 |
| [wt %] | Al₂O₃ | 22.22 | 22.42 | 21.07 | 19.79 |
| | B₂O₃ | 0.00 | 0.00 | 0.00 | 0.00 |
| | P₂O₅ | 0.40 | 0.40 | 0.41 | 0.41 |
| | Li₂O | 4.04 | 3.54 | 3.74 | 3.80 |
| | Na₂O | 0.67 | 0.67 | 0.68 | 0.69 |
| | K₂O | 0.00 | 0.00 | 0.00 | 0.00 |
| | MgO | 1.25 | 1.26 | 1.27 | 1.29 |
| | CaO | 0.05 | 0.05 | 0.05 | 0.05 |
| | SrO | 0.00 | 0.00 | 0.00 | 0.00 |
| | BaO | 0.00 | 0.00 | 0.00 | 0.00 |
| | ZnO | 0.00 | 0.00 | 0.00 | 0.00 |
| | TiO₂ | 0.0150 | 0.0150 | 0.0150 | 0.0150 |
| | SnO₂ | 1.13 | 1.14 | 1.15 | 1.17 |
| | ZrO₂ | 2.46 | 2.48 | 2.51 | 2.56 |
| | Fe₂O₃ | 0.0100 | 0.0100 | 0.0100 | 0.0100 |
| | Y₂O₃ | 0.00 | 0.00 | 0.00 | 0.00 |
| | MoO₃ | 0.00000 | 0.00000 | 0.00000 | 0.00000 |
| | Sb₂O₃ | 0.00 | 0.00 | 0.00 | 0.00 |
| | As₂O₃ | 0.00 | 0.00 | 0.00 | 0.00 |
| Composition | Pt | 0.02 | 0.02 | 0.02 | 0.02 |
| [ppm] | Rh | 0.01 | 0.01 | 0.01 | 0.01 |
| | Pt + Rh | 0.03 | 0.03 | 0.03 | 0.03 |

| | | | | |
|---|---|---|---|---|
| Sn/(P + B + Zr + Ti + Sn) | 0.282 | 0.282 | 0.281 | 0.281 |
| Al/(Zr + Sn) | 6.20 | 6.20 | 5.76 | 5.32 |
| (Mg + Zn)/Li | 0.308 | 0.355 | 0.340 | 0.340 |
| Sn/(Zr + Sn) | 0.31 | 0.31 | 0.31 | 0.31 |
| (Si + Al)/Li | 22.24 | 25.62 | 24.08 | 23.65 |
| (Si + Al)/Sn | 79.82 | 79.82 | 78.43 | 77.03 |
| (Li + Na + K)/Zr | 1.92 | 1.70 | 1.76 | 1.76 |
| Ti/Zr | 0.0061 | 0.0060 | 0.0060 | 0.0059 |
| Ti/(Ti + Fe) | 0.600 | 0.600 | 0.600 | 0.600 |
| Na + K + Ca + Sr + Ba | 0.72 | 0.72 | 0.73 | 0.74 |
| (Mg + Ca + Sr + Ba)/Zr | 0.53 | 0.53 | 0.52 | 0.52 |
| (Mg + Ca + Sr + Ba)/(Li + Na + K) | 0.27 | 0.31 | 0.30 | 0.30 |
| Al/(Li + (1/2*(Mg + Zn)) | 6.12 | 6.96 | 6.27 | 5.85 |
| Sb + As | 0.00 | 0.00 | 0.00 | 0.00 |

Before crystallization

| Transmittance[%] | 200 | nm | Not measured | Not measured | Not measured | Not measured |
|---|---|---|---|---|---|---|
| 3 mm thickness | 250 | nm | Not measured | Not measured | Not measured | Not measured |
| | 300 | nm | Not measured | Not measured | Not measured | Not measured |
| | 325 | nm | Not measured | Not measured | Not measured | Not measured |
| | 350 | nm | Not measured | Not measured | Not measured | Not measured |
| | 380 | nm | Not measured | Not measured | Not measured | Not measured |
| | 800 | nm | Not measured | Not measured | Not measured | Not measured |
| | 1200 | nm | Not measured | Not measured | Not measured | Not measured |
| L* | | | Not measured | Not measured | Not measured | Not measured |
| a* | | | Not measured | Not measured | Not measured | Not measured |
| b* | | | Not measured | Not measured | Not measured | Not measured |
| Low temperature | Strain point[° C.] | | Not measured | Not measured | Not measured | Not measured |
| viscosity | Annealing point[° C.] | | Not measured | Not measured | Not measured | Not measured |
| | Glass transition point[° C.] | | Not measured | Not measured | Not measured | Not measured |
| High temperature | 10\hat{ }4[° C.] | | Not measured | Not measured | Not measured | Not measured |
| viscosity | 10\hat{ }3[° C.] | | Not measured | Not measured | Not measured | Not measured |
| | 10\hat{ }2.5[° C.] | | Not measured | Not measured | Not measured | Not measured |
| | 10\hat{ }2[° C.] | | Not measured | Not measured | Not measured | Not measured |
| Liquidus temperature[° C.] | | | Not measured | Not measured | Not measured | Not measured |
| Liquidus viscosity[—] | | | Not measured | Not measured | Not measured | Not measured |
| α[×10⁻⁷/° C.] | 30-380° | C. | Not measured | Not measured | Not measured | Not measured |

| | | | | |
|---|---|---|---|---|
| Density[g/cm3] | 2.432 | 2.442 | 2.426 | 2.417 |
| β -OH[/mm] | 0.40 | 0.37 | 0.37 | 0.38 |

TABLE 38

| | | | |
|---|---|---|---|
| No. 117 | No. 118 | No. 119 | No. 120 |

After crystallization

| Crystallization condition | | | 765° C.-3 h | 765° C.-3 h | 765° C.-3 h | 765° C.-3 h |
|---|---|---|---|---|---|---|
| | | | 890° C.-1 h | 890° C.-1 h | 890° C.-1 h | 890° C.-1 h |
| Transmittance[%] | 200 | nm | 47.3 | 47.3 | 47.3 | 47.3 |
| 3 mm thickness | 250 | nm | 15.2 | 22.2 | 20.9 | 16.0 |
| | 300 | nm | 14.0 | 20.7 | 19.4 | 12.6 |
| | 325 | nm | 49.1 | 53.2 | 57.3 | 48.3 |
| | 350 | nm | 71.4 | 71.0 | 77.4 | 74.2 |
| | 380 | nm | 80.9 | 79.1 | 85.2 | 84.6 |
| | 800 | nm | 90.6 | 90.4 | 91.0 | 91.2 |
| | 1200 | nm | 90.4 | 90.4 | 90.5 | 90.9 |
| L* | | | 95.4 | 95.1 | 96.0 | 96.1 |
| a* | | | −0.1 | −0.1 | −0.1 | −0.1 |
| b* | | | 1.8 | 2.2 | 1.0 | 1.0 |
| Precipitated crystal | | | Not measured | Not measured | Not measured | Not measured |
| Average crystallite size[nm] | | | Not measured | Not measured | Not measured | Not measured |
| α[×10⁻⁷/° C.] | 30-380° | C. | −1.7 | −0.6 | −0.7 | −0.6 |
| α[×10⁻⁷/° C.] | 30-750° | C. | 0.3 | 0.5 | 0.6 | 0.1 |

| Density[g/cm3] | 2.501 | 2.510 | 2.506 | 2.502 |
|---|---|---|---|---|
| Young's Modulus [GPa] | Not measured | Not measured | Not measured | Not measured |
| Modulus of rigidity [GPa] | Not measured | Not measured | Not measured | Not measured |
| Poisson's ratio | Not measured | Not measured | Not measured | Not measured |
| Appearance | Colorless and | Colorless and | Colorless and | Colorless and |
| | transparent | transparent | transparent | transparent |

Rate of change before and after crystallization[%]

| | | | | |
|---|---|---|---|---|
| 200 nm | Not measured | Not measured | Not measured | Not measured |
| 250 nm | Not measured | Not measured | Not measured | Not measured |
| 300 nm | Not measured | Not measured | Not measured | Not measured |
| 325 nm | Not measured | Not measured | Not measured | Not measured |
| 350 nm | Not measured | Not measured | Not measured | Not measured |
| 380 nm | Not measured | Not measured | Not measured | Not measured |
| 800 nm | Not measured | Not measured | Not measured | Not measured |
| 1200 nm | Not measured | Not measured | Not measured | Not measured |

TABLE 39

| | | No. 121 | No. 122 | No. 123 | No. 124 | No. 125 |
|---|---|---|---|---|---|---|
| Composition | SiO₂ | 68.50 | 69.60 | 68.11 | 69.77 | 69.77 |
| [wt %] | Al₂O₃ | 21.70 | 20.44 | 22.37 | 20.48 | 20.48 |
| | B₂O₃ | 0.00 | 0.00 | 0.00 | 0.00 | 0.00 |
| | P₂O₅ | 0.40 | 0.41 | 0.40 | 0.41 | 0.41 |
| | Li₂O | 3.71 | 3.77 | 3.46 | 3.54 | 3.54 |
| | Na₂O | 0.68 | 0.69 | 0.67 | 0.69 | 0.69 |
| | K₂O | 0.00 | 0.00 | 0.00 | 0.00 | 0.00 |
| | MgO | 1.26 | 1.28 | 1.25 | 1.28 | 1.28 |
| | CaO | 0.05 | 0.05 | 0.05 | 0.05 | 0.05 |
| | SrO | 0.00 | 0.00 | 0.00 | 0.00 | 0.00 |
| | BaO | 0.00 | 0.00 | 0.00 | 0.00 | 0.00 |
| | ZnO | 0.00 | 0.00 | 0.00 | 0.00 | 0.00 |
| | TiO₂ | 0.0150 | 0.0150 | 0.0150 | 0.0150 | 0.0150 |
| | SnO₂ | 1.14 | 1.16 | 1.13 | 1.16 | 1.16 |
| | ZrO₂ | 2.49 | 2.53 | 2.48 | 2.44 | 2.54 |
| | Fe₂O₃ | 0.0100 | 0.0100 | 0.0100 | 0.0100 | 0.0100 |
| | Y₂O₃ | 0.00 | 0.00 | 0.00 | 0.00 | 0.00 |
| | MoO₃ | 0.00000 | 0.00000 | 0.00000 | 0.00000 | 0.00000 |
| | Sb₂O₃ | 0.00 | 0.00 | 0.00 | 0.00 | 0.00 |
| | As₂O₃ | 0.00 | 0.00 | 0.00 | 0.00 | 0.00 |
| Composition | Pt | 0.02 | 0.02 | 0.02 | 0.02 | 0.02 |
| [ppm] | Rh | 0.01 | 0.01 | 0.01 | 0.01 | 0.01 |
| | Pt + Rh | 0.03 | 0.03 | 0.03 | 0.03 | 0.03 |

| | | | | | |
|---|---|---|---|---|---|
| Sn/(P + B + Zr + Ti + Sn) | 0.281 | 0.281 | 0.282 | 0.288 | 0.281 |
| Al/(Zr + Sn) | 5.98 | 5.54 | 6.20 | 5.69 | 5.54 |
| (Mg + Zn)/Li | 0.340 | 0.340 | 0.363 | 0.363 | 0.363 |
| Sn/(Zr + Sn) | 0.31 | 0.31 | 0.31 | 0.32 | 0.31 |
| (Si + Al)/Li | 24.30 | 23.87 | 26.15 | 25.47 | 25.47 |
| (Si + Al)/Sn | 79.13 | 77.73 | 79.82 | 77.73 | 77.73 |
| (Li + Na + K)/Zr | 1.76 | 1.76 | 1.67 | 1.74 | 1.67 |
| Ti/Zr | 0.0060 | 0.0059 | 0.0061 | 0.0061 | 0.0059 |
| Ti/(Ti + Fe) | 0.600 | 0.600 | 0.600 | 0.600 | 0.600 |
| Na + K + Ca + Sr + Ba | 0.73 | 0.74 | 0.72 | 0.74 | 0.74 |
| (Mg + Ca + Sr + Ba)/Zr | 0.53 | 0.52 | 0.53 | 0.55 | 0.52 |
| (Mg + Ca + Sr + Ba)/(Li + Na + K) | 0.30 | 0.30 | 0.31 | 0.31 | 0.31 |
| Al/(Li + (½*(Mg + Zn)) | 6.48 | 6.06 | 7.09 | 6.42 | 6.42 |
| Sb + As | 0.00 | 0.00 | 0.00 | 0.00 | 0.00 |

Before crystallization

| Transmittance[%] | 200 nm | Not measured | Not measured | Not measured | Not measured | Not measured |
|---|---|---|---|---|---|---|
| 3 mm thickness | 250 nm | Not measured | Not measured | Not measured | Not measured | Not measured |
| | 300 nm | Not measured | Not measured | Not measured | Not measured | Not measured |
| | 325 nm | Not measured | Not measured | Not measured | Not measured | Not measured |
| | 350 nm | Not measured | Not measured | Not measured | Not measured | Not measured |
| | 380 nm | Not measured | Not measured | Not measured | Not measured | Not measured |
| | 800 nm | Not measured | Not measured | Not measured | Not measured | Not measured |
| | 1200 nm | Not measured | Not measured | Not measured | Not measured | Not measured |
| L* | | Not measured | Not measured | Not measured | Not measured | Not measured |
| a* | | Not measured | Not measured | Not measured | Not measured | Not measured |
| b* | | Not measured | Not measured | Not measured | Not measured | Not measured |
| Low temperature | Strain point[° C.] | Not measured | Not measured | Not measured | Not measured | Not measured |
| viscosity | Annealing point[° C.] | Not measured | Not measured | Not measured | Not measured | Not measured |
| | Glass transition point[° C.] | Not measured | Not measured | Not measured | Not measured | Not measured |
| High temperature | 10\hat{ }4[° C.] | Not measured | 1369 | 1367 | 1380 | Not measured |
| viscosity | 10\hat{ }3[° C.] | Not measured | 1557 | 1544 | 1567 | Not measured |
| | 10\hat{ }2.5[° C.] | Not measured | 1676 | 1658 | 1684 | Not measured |
| | 10\hat{ }2[° C.] | Not measured | 1819 | 1794 | 1822 | Not measured |
| Liquidus temperature[° C.] | | Not measured | Not measured | Not measured | Not measured | Not measured |
| Liquidus viscosity[—] | | Not measured | Not measured | Not measured | Not measured | Not measured |
| α[×10⁻⁷/° C.] | 30-380° C. | Not measured | Not measured | Not measured | Not measured | Not measured |

| | | | | | |
|---|---|---|---|---|---|
| Density[g/cm3] | 2.428 | 2.421 | 2.434 | 2.418 | 2.420 |
| β-OH[/mm] | 0.40 | 0.40 | 0.37 | 0.37 | 0.38 |

TABLE 40

| No. 121 | No. 122 | No. 123 | No. 124 | No. 125 |
|---|---|---|---|---|
| Crystallization condition | | | | |
| 765° C.-3 h | 765° C.-3 h | 765° C.-3 h | 765° C.-3 h | 765° C.-3 h |
| 890° C.-1 h | 890° C.-1 h | 890° C.-1 h | 890° C.-1 h | 890° C.-1 h |

After crystallization

| Transmittance[%] | 200 nm | 47.3 | 47.3 | 47.3 | 47.3 | 47.3 |
|---|---|---|---|---|---|---|
| 3 mm thickness | 250 nm | 19.7 | 19.1 | 21.0 | 17.3 | 18.0 |
| | 300 nm | 19.9 | 16.0 | 22.5 | 17.5 | 17.7 |
| | 325 nm | 58.2 | 53.2 | 61.8 | 57.2 | 56.6 |
| | 350 nm | 77.3 | 76.2 | 79.0 | 78.5 | 77.9 |
| | 380 nm | 84.7 | 85.3 | 85.4 | 86.4 | 85.9 |
| | 800 nm | 91.0 | 91.1 | 91.0 | 91.2 | 91.2 |
| | 1200 nm | 90.5 | 90.7 | 90.5 | 90.6 | 90.5 |
| L* | | 95.9 | 96.1 | 96.0 | 96.2 | 96.2 |
| a* | | −0.1 | −0.1 | −0.1 | −0.1 | −0.1 |
| b* | | 1.1 | 0.9 | 1.0 | 0.7 | 0.8 |
| Precipitated crystal | | β-Q | β-Q | β-Q | β-Q | β-Q |
| Average crystallite size[nm] | | Not measured | Not measured | Not measured | Not measured | Not measured |
| α[×10⁻⁷/° C.] | 30-380° C. | −1.1 | −0.6 | −0.8 | −0.3 | 0.2 |
| α[×10⁻⁷/° C.] | 30-750° C. | 0.3 | 0.7 | 0.2 | 0.7 | 0.7 |

| | | | | | |
|---|---|---|---|---|---|
| Density[g/cm3] | 2.507 | 2.506 | 2.511 | 2.508 | 2.509 |
| Young's Modulus [GPa] | Not measured | Not measured | Not measured | Not measured | Not measured |
| Modulus of rigidity [GPa] | Not measured | Not measured | Not measured | Not measured | Not measured |
| Poisson's ratio | Not measured | Not measured | Not measured | Not measured | Not measured |
| Appearance | Colorless and | Colorless and | Colorless and | Colorless and | Colorless and |
| | transparent | transparent | transparent | transparent | transparent |

Rate of change before and after crystallization[%]

| | | | | | |
|---|---|---|---|---|---|
| 200 nm | Not measured | Not measured | Not measured | Not measured | Not measured |
| 250 nm | Not measured | Not measured | Not measured | Not measured | Not measured |
| 300 nm | Not measured | Not measured | Not measured | Not measured | Not measured |
| 325 nm | Not measured | Not measured | Not measured | Not measured | Not measured |
| 350 nm | Not measured | Not measured | Not measured | Not measured | Not measured |
| 380 nm | Not measured | Not measured | Not measured | Not measured | Not measured |
| 800 nm | Not measured | Not measured | Not measured | Not measured | Not measured |
| 1200 nm | Not measured | Not measured | Not measured | Not measured | Not measured |

TABLE 41

| | | No. 126 | No. 127 | No. 128 | No. 129 | No. 130 | No. 131 |
|---|---|---|---|---|---|---|---|
| Composition | SiO₂ | 67.95 | 67.95 | 67.96 | 69.18 | 69.60 | 69.05 |
| [wt %] | Al₂O₃ | 22.32 | 22.32 | 22.32 | 20.91 | 21.04 | 20.87 |
| | B₂O₃ | 0.00 | 0.00 | 0.00 | 0.00 | 0.00 | 0.00 |
| | P₂O₅ | 0.40 | 0.40 | 0.40 | 0.42 | 0.42 | 0.42 |
| | Li₂O | 3.68 | 3.68 | 3.68 | 3.62 | 3.64 | 3.61 |
| | Na₂O | 0.67 | 0.67 | 0.67 | 0.70 | 0.71 | 0.70 |
| | K₂O | 0.00 | 0.00 | 0.00 | 0.00 | 0.00 | 0.00 |
| | MgO | 1.25 | 1.25 | 1.25 | 1.31 | 1.32 | 1.31 |
| | CaO | 0.05 | 0.05 | 0.05 | 0.05 | 0.05 | 0.05 |
| | SrO | 0.00 | 0.00 | 0.00 | 0.00 | 0.00 | 0.00 |
| | BaO | 0.00 | 0.00 | 0.00 | 0.00 | 0.00 | 0.00 |
| | ZnO | 0.00 | 0.00 | 0.00 | 0.00 | 0.00 | 0.00 |
| | TiO₂ | 0.0150 | 0.0150 | 0.0150 | 0.0153 | 0.0154 | 0.0153 |
| | SnO₂ | 1.13 | 1.13 | 1.13 | 1.19 | 0.59 | 0.58 |
| | ZrO₂ | 2.47 | 2.47 | 2.47 | 2.59 | 2.61 | 3.40 |
| | Fe₂O₃ | 0.0100 | 0.0100 | 0.0100 | 0.0102 | 0.0102 | 0.0102 |
| | Y₂O₃ | 0.00 | 0.00 | 0.00 | 0.00 | 0.0005 | 0.0001 |
| | MoO₃ | 0.0056 | 0.0006 | 0.0003 | 0.0000 | 0.0001 | 0.0000 |
| | Sb₂O₃ | 0.00 | 0.00 | 0.00 | 0.00 | 0.00 | 0.00 |
| | As₂O₃ | 0.00 | 0.00 | 0.00 | 0.00 | 0.00 | 0.00 |
| Composition | Pt | 0.02 | 0.02 | 0.02 | 0.02 | 0.02 | 0.02 |
| [ppm] | Rh | 0.01 | 0.01 | 0.01 | 0.01 | 0.01 | 0.01 |
| | Pt + Rh | 0.03 | 0.03 | 0.03 | 0.03 | 0.03 | 0.03 |

| | | | | | | |
|---|---|---|---|---|---|---|
| Sn/(P + B + Zr + Ti + Sn) | 0.282 | 0.282 | 0.282 | 0.281 | 0.162 | 0.132 |
| Al/(Zr + Sn) | 6.20 | 6.20 | 6.20 | 5.54 | 6.58 | 5.24 |
| (Mg + Zn)/Li | 0.340 | 0.340 | 0.340 | 0.363 | 0.363 | 0.363 |
| Sn/(Zr + Sn) | 0.31 | 0.31 | 0.31 | 0.31 | 0.18 | 0.15 |
| (Si + Al)/Li | 24.51 | 24.51 | 24.51 | 24.90 | 24.90 | 24.90 |
| (Si + Al)/Sn | 79.82 | 79.82 | 79.82 | 76.01 | 153.93 | 153.93 |
| (Li + Na + K)/Zr | 1.76 | 1.76 | 1.76 | 1.67 | 1.67 | 1.27 |
| Ti/Zr | 0.0061 | 0.0061 | 0.0061 | 0.0059 | 0.0059 | 0.0045 |
| Ti/(Ti + Fe) | 0.600 | 0.600 | 0.600 | 0.600 | 0.601 | 0.600 |
| Na + K + Ca + Sr + Ba | 0.72 | 0.72 | 0.72 | 0.75 | 0.76 | 0.75 |
| (Mg + Ca + Sr + Ba)/Zr | 0.53 | 0.53 | 0.53 | 0.52 | 0.52 | 0.40 |
| (Mg + Ca + Sr + Ba)/(Li + Na + K) | 0.30 | 0.30 | 0.30 | 0.31 | 0.31 | 0.31 |
| Al/(Li + (½*(Mg + Zn)) | 6.69 | 6.69 | 6.69 | 6.44 | 6.44 | 6.43 |
| Sb + As | 0.00 | 0.00 | 0.00 | 0.00 | 0.00 | 0.00 |

Before crystallization

| Transmittance[%] | 200 nm | Not measured | Not measured | Not measured | Not measured | Not measured | Not measured |
|---|---|---|---|---|---|---|---|
| 3 mm thickness | 250 nm | Not measured | Not measured | Not measured | Not measured | Not measured | Not measured |
| | 300 nm | Not measured | Not measured | Not measured | Not measured | Not measured | Not measured |
| | 325 nm | Not measured | Not measured | Not measured | Not measured | Not measured | Not measured |
| | 350 nm | Not measured | Not measured | Not measured | Not measured | Not measured | Not measured |
| | 380 nm | Not measured | Not measured | Not measured | Not measured | Not measured | Not measured |
| | 800 nm | Not measured | Not measured | Not measured | Not measured | Not measured | Not measured |
| | 1200 nm | Not measured | Not measured | Not measured | Not measured | Not measured | Not measured |
| L* | | Not measured | Not measured | Not measured | Not measured | Not measured | Not measured |
| a* | | Not measured | Not measured | Not measured | Not measured | Not measured | Not measured |
| b* | | Not measured | Not measured | Not measured | Not measured | Not measured | Not measured |
| Low temperature | Strain point[° C.] | Not measured | Not measured | Not measured | Not measured | Not measured | Not measured |
| viscosity | Annealing point[° C.] | Not measured | Not measured | Not measured | Not measured | Not measured | Not measured |
| | Glass transition point[° C.] | Not measured | Not measured | Not measured | Not measured | Not measured | Not measured |
| High temperature | 10\hat{ }4[° C.] | Not measured | Not measured | Not measured | Not measured | Not measured | Not measured |
| viscosity | 10\hat{ }3[° C.] | Not measured | Not measured | Not measured | Not measured | Not measured | Not measured |
| | 10\hat{ }2.5[° C.] | Not measured | Not measured | Not measured | Not measured | Not measured | Not measured |
| | 10\hat{ }2[° C.] | Not measured | Not measured | Not measured | Not measured | Not measured | Not measured |
| Liquidus temperature[° C.] | | Not measured | Not measured | Not measured | Not measured | Not measured | Not measured |
| Liquidus viscosity[—] | | Not measured | Not measured | Not measured | Not measured | Not measured | Not measured |
| α[×10⁻⁷/° C.] | 30-380° C. | Not measured | Not measured | Not measured | Not measured | Not measured | Not measured |

| | | | | | | |
|---|---|---|---|---|---|---|
| Density[g/cm3] | 2.420 | 2.433 | 2.432 | 2.426 | 2.414 | 2.421 |
| β-OH[/mm] | 0.38 | 0.40 | 0.39 | 0.40 | 0.40 | 0.40 |

TABLE 42

| No. 126 | No. 127 | No. 128 | No. 129 | No. 130 | No. 131 |
|---|---|---|---|---|---|
| Crystallization condition | | | | | |
| 765° C.-3 h | 765° C.-3 h | 765° C.-3 h | 765° C.-3 h | 765° C.-3 h | 765° C.-3 h |
| 890° C.-1 h | 890° C.-1 h | 890° C.-1 h | 890° C.-1 h | 890° C.-1 h | 890° C.-1h |

After crystallization

| Transmittance[%] | 200 nm | 47.3 | 47.3 | 47.3 | Not measured | Not measured | Not measured |
|---|---|---|---|---|---|---|---|
| 3 mm thickness | 250 nm | 18.3 | 21.8 | 20.2 | Not measured | Not measured | Not measured |
| | 300 nm | 15.7 | 20.3 | 21.5 | Not measured | Not measured | Not measured |
| | 325 nm | 49.5 | 56.5 | 61.1 | Not measured | Not measured | Not measured |
| | 350 nm | 71.6 | 75.5 | 79.0 | Not measured | Not measured | Not measured |
| | 380 nm | 81.5 | 83.3 | 85.6 | Not measured | Not measured | Not measured |
| | 800 nm | 90.9 | 90.9 | 91.1 | Not measured | Not measured | Not measured |
| | 1200 nm | 90.6 | 90.7 | 90.5 | Not measured | Not measured | Not measured |
| L* | | 95.7 | 95.8 | 96.0 | Not measured | Not measured | Not measured |
| a* | | −0.2 | −0.1 | −0.1 | Not measured | Not measured | Not measured |
| b* | | 1.6 | 1.3 | 1.0 | Not measured | Not measured | Not measured |
| Precipitated crystal | | β-Q | β-Q | β-Q | β-Q | β-Q | β-Q |
| Average crystallite size[nm] | | Not measured | Not measured | Not measured | Not measured | Not measured | Not measured |
| α[×10⁻⁷/° C.] | 30-380° C. | Not measured | Not measured | −1.4 | Not measured | Not measured | Not measured |
| α[×10⁻⁷/° C.] | 30-750° C. | Not measured | Not measured | −0.2 | Not measured | Not measured | Not measured |

| | | | | | | |
|---|---|---|---|---|---|---|
| Density[g/cm3] | 2.509 | 2.509 | 2.510 | Not measured | Not measured | Not measured |
| Young's Modulus [ GPa] | Not measured | Not measured | Not measured | Not measured | Not measured | Not measured |
| Modulus of rigidity [GPa] | Not measured | Not measured | Not measured | Not measured | Not measured | Not measured |
| Poisson's ratio | Not measured | Not measured | Not measured | Not measured | Not measured | Not measured |
| Appearance | Colorless and | Colorless and | Colorless and | Colorless and | Colorless and | Colorless and |
| | transparent | transparent | transparent | transparent | transparent | transparent |

Rate of change before and after crystallization[%]

| | | | | | | |
|---|---|---|---|---|---|---|
| 200 nm | Not measured | Not measured | Not measured | Not measured | Not measured | Not measured |
| 250 nm | Not measured | Not measured | Not measured | Not measured | Not measured | Not measured |
| 300 nm | Not measured | Not measured | Not measured | Not measured | Not measured | Not measured |
| 325 nm | Not measured | Not measured | Not measured | Not measured | Not measured | Not measured |
| 350 nm | Not measured | Not measured | Not measured | Not measured | Not measured | Not measured |
| 380 nm | Not measured | Not measured | Not measured | Not measured | Not measured | Not measured |
| 800 nm | Not measured | Not measured | Not measured | Not measured | Not measured | Not measured |
| 1200 nm | Not measured | Not measured | Not measured | Not measured | Not measured | Not measured |

Firstly, in order that the glass has the composition shown in each table, each raw material was mixed in the form of an oxide, a hydroxide, a carbonate, a nitrates, and the like to obtain a glass batch (composition shown in each table is an analytical value of an actually-prepared glass). The obtained glass batch was placed in a crucible containing platinum and rhodium, a strengthened platinum crucible containing no rhodium, a refractory crucible, or a quartz crucible, the glass batch was melted at 1600° C. for 4 to 100 hours, and then, the temperature was raised to 1650 to 1680° C. to melt the glass batch for 0.5 to 20 hours, the melted glass batch was formed into a roll having a thickness of 5 mm, the resultant glass roll was further subject to heat treatment at 700° C. for 30 minutes using an annealing furnace, and the temperature of the annealing furnace was decreased to room temperature at 100° C./h to obtain a crystallizable glass. Note that the melting was performed by an electro-melting method used broadly for the development of glass materials.

Note that, by using the glass composition of Sample No. 27, it was confirmed that it is possible to melt the glass compositions in contact with a liquid or a solid by laser irradiation. By feeding the gas from around the glass sample to cause the glass sample to be in a suspended state, it was also confirmed that the glass composition in contact with a gas only can be melt by laser. It was further confirmed that it is possible to form the glass composition, which was melt in advance using an electric furnace or the like, into a semi-spherical, spherical, fiber-like, powdered form by a press method, a redraw method, a spray method, and the like. It was further confirmed, by using the glass compositions of Samples No. 28 to 49, that it is possible to perform the melting in a continuous furnace in which burner heating and energizing heating are combined, and confirmed that it is possible to form the glass composition into blocks, flakes, hollow shapes, and the like, by a roll method, a film method, and a lot method using dielectric heating. By using the glass composition of Sample No. 15, it was confirmed that it is possible to form the glass composition into a thin plate shape, a tubular shape, and a bulb shape by an up-draw method, a down-draw method, a slit method, an overflow (fusion) method, a hand-blown method, and the like. By using the glass composition of Sample No. 59, it was further confirmed that pouring a glass melt onto a liquid having a specific gravity greater than the Sample No. 59, and a subsequent cooling allows the glass composition to solidify into a plate. Note that all the glass produced in any method could be crystallized under the conditions described in the tables.

The contents of Pt and Rh of the sample were analyzed using ICP-MS equipment (Agilent 8800 manufactured by Agilent Technologies, Inc.). Firstly, after the produced glass sample was pulverized and wetted with pure water, perchloric acid, nitric acid, sulfuric acid, hydrofluoric acid, and the like were added, and the sample was melted. Thereafter, the contents of Pt and Rh of the sample were measured by ICP-MS. Based on a calibration curve prepared by using solutions containing Pt and Rh at known concentrations, which were prepared in advance, the contents of Pt and Rh of each measurement sample were evaluated. The measurement mode was He gas/HMI (low mode) for Pt and HEHe gas/HMI (medium mode) for Rh, and the mass numbers were 198 for Pt and 103 for Rh. Note that the content of Li₂O of the prepared sample was analyzed by using an atomic absorption spectrometer (ContrAA600, manufactured by Analytik Jena GmbH). Including a flow of melting the glass sample and the use of calibration curves, the analysis was performed basically in much the same way as in the analysis of Pt and Rh. The contents of other components were measured by using ICP-MS or atomic absorption spectrometry in much the same way as Pt, Rh, Li₂O, or by creating a calibration curve on an XRF analyzer (ZSX Primus IV manufactured by Rigaku Corporation) by using, as a calibration curve sample, a glass sample with a known concentration determined in advance using ICP-MS or an atomic absorption spectrometer, and, based on the calibration curve, evaluating an actual content of each component from an XRF analysis value of the measurement sample. During the XRF analysis, a tube voltage, a tube current, an exposure time, and the like were adjusted in accordance with the components to be analyzed.

The crystallizable glass described in each table was subjected to heat treatment for nucleation at from 750 to 900° C. for 0.75 to 60 hours, and then, a heat treatment at from 800 to 1000° C. for 0.25 to 3 hours was further performed for crystallization. Thereafter, heat treatment was performed at 700° C. for 30 minutes, and the temperature was decreased to room temperature by 100° C./h. The obtained crystallized glass was evaluated in terms of transmittance, diffuse transmittance, lightness, chromaticity, precipitated crystal, average crystallite size, thermal expansion coefficient, density, Young's modulus, modulus of rigidity, Poisson's ratio, and appearance. For the crystallizable glass before crystallization, the transmittance, the lightness, the chromaticity, and the like were measured in the same way as in the crystallized glass. The crystallizable glass was further evaluated in terms of a β-OH value, a viscosity, and a liquidus temperature.

The transmittance, the lightness, and the chromaticity were evaluated by measurement by using a spectrophotometer for a crystallized glass plate with both surfaces being optically polished to have 3 mm thick. A spectrophotometer V-670 manufactured by JASCO Corporation was used for the measurement. Note that V-670 is attached with “ISN-723”, which is an integrating sphere unit, and the transmittance measured corresponds to a total light transmittance. A measurement wavelength range was set from 200 to 1500 nm, a scan speed was set to 200 nm/min, a sampling pitch was set to 1 nm, a bandwidth was set to 5 nm for a wavelength range from 200 to 800 nm, and was set to 20 nm for other wavelength ranges. Baseline correction (100% adjustment) and dark measurement (0% adjustment) were performed before the measurement. During the dark measurement, a barium sulfate plate that came along with ISN-723 was removed. The measured transmittance was used to calculate tristimulus values XYZ according to JISZ8781-42013 and the corresponding international standards, and the lightness and the chromaticity were calculated from each stimulus value (light source C/10°). When the diffuse transmittance of the crystallized glass was measured, the same model as above was used, and the sample to be measured was placed and the measurement was performed while a barium sulfate plate that came along with ISN-723 was removed.

The precipitated crystal was evaluated by using an X-ray diffractometer (fully automatic multi-purpose horizontal X-ray diffractometer Smart Lab, manufactured by Rigaku Corporation). The scanning mode was set to 2θ/θ measurement, scan type was continuous scan, scattering and divergence slit width were 1°, light receiving slit width was 0.2°, a measuring range was from 10 to 60°, a measurement step was 0.1°, a scanning speed was 5°/min, and an analysis software packaged with the instrument was used to evaluate a main crystal and a crystal grain size. As a precipitation crystal seed identified as the main crystal, a β-quartz solid solution is indicated in the table as “β-Q”. The average crystallite size of the main crystals was calculated by using the measured X-ray diffraction peak, based on the ebeye-Scherrer method. Note that in the measurement for calculating the average crystallite size, the scanning speed was set to 1°/min.

The thermal expansion coefficient was evaluated by using a crystallized glass sample processed to have a length of 20 mm and a diameter of 3.8 mm, and as an average linear thermal expansion coefficient measured in the temperature ranges from 30 to 380° C. and from 30 to 750° C. A Dilatometer manufactured by NETZSCH was used for the measurement. Further, the same measuring instrument was used to measure the thermal expansion curve for the temperature range from 30 to 750° C. and the inflection point of the curve was calculated to evaluate the glass transition point of the crystallizable glass before crystallization.

The Young's modulus, the modulus of rigidity, and the Poisson's ratio was measured at room temperature by using a plate-shaped sample (40 mm×20 mm×20 mm) whose surface was polished with a polishing liquid in which 1200 mesh alumina powder was dispersed, and by using a free resonance type elastic modulus measuring device (JE-RT3 manufactured by Nihon Techno-Plus Co. Ltd.)

The density was evaluated by an Archimedes's method.

The strain point and the annealing point were evaluated by a fiber elongation method. Note that a fiber sample was prepared by subjecting the crystallizable glass to hand-drawing.

An FT-IR Frontier (PerkinElmer Inc.) was used to measure the transmittance of the glass to evaluate the β-OH value according to the following formula. Note that the scanning speed was set to 100 μm/min, and the sampling pitch was set to 1 cm⁻¹, and the number of times of scans was set to 10 times per measurement.

β-OH value=(1/X)log 10(T₁/T₂)
X: Glass thickness (mm)
T₁: Transmittance (%) at a reference wavelength of 3846 cm⁻¹
T₂: Minimum transmittance (%) near an absorption wavelength of hydroxyl groups of 3600 cm⁻¹

The high temperature viscosity was evaluated by a platinum ball pulling-up method. For the evaluation, a lumpy glass sample was crushed into appropriate sizes, and fed into an alumina crucible while inclusion of air bubbles was avoided as much as possible. Then, the alumina crucible was heated to melt the sample, and the viscosity of the glass was measured at a plurality of temperatures. The constant of the Vogel-Fulcher equation was calculated, a viscosity curve was created, and the temperature at each viscosity was calculated.

The liquidus temperature was evaluated by the following method. Firstly, a platinum boat of about 120×20×10 mm was filled with a glass powder having a uniform size from 300 to 500 micrometers, placed in an electric furnace, and melted at 1600° C. for 30 minutes. Thereafter, the platinum boat was placed in an electric furnace having a linear temperature gradient, left to stand for 20 hours, and the devitrification was precipitated. After air cooling of the measurement sample to room temperature, the devitrification precipitated at an interface between the platinum boat and the glass was observed. A temperature of a part where devitrification was precipitated was calculated from a temperature gradient graph of the electric furnace, and was recorded as the liquidus temperature. The obtained liquidus temperature was interpolated into a high-temperature viscosity curve of the glass, and the viscosity corresponding to the liquidus temperature was recorded as the liquidus viscosity. Note that it was found from results of X-ray diffraction, composition analysis, and the like (scanning electron microscope S3400N TyPE2 manufactured by Hitachi, Ltd., and EMAX ENERGY EX250X manufactured by HORIBA, Ltd.) that a primary phase of the glasses listed in each table was mainly ZrO₂.

Appearance was evaluated by visually observing the color tone of the crystallized glass. Note that the visual observation was performed on a white background and a black background under indoor light and sunlight, respectively (performed at 8:00, 12:00, and 16:00 on clear and cloudy days in January, April, July, and October). The color tone was determined comprehensively from each visual result.

As is evident from Tables 1 to 42, it was found that the crystallized glasses of the Samples Nos. 1 to 131 which are Examples were colorless and transparent in appearance and had high transmittance, the thermal expansion coefficient of approximately 0, and a sufficient degree of crystallization. It was also found that the rate of transmittance change before and after crystallization was small.

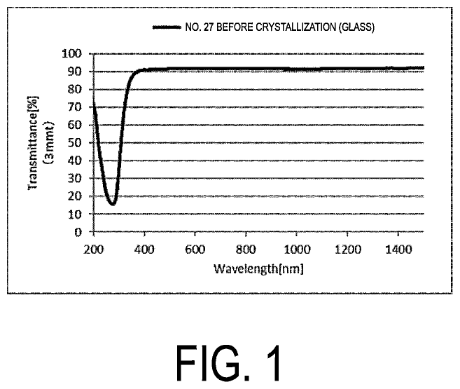

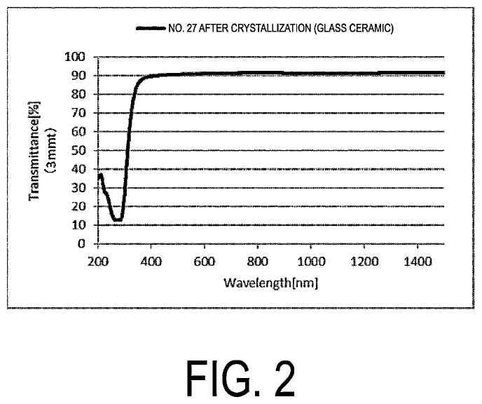

FIG. 1 shows a transmittance curve before crystallization of Sample No. 27 and FIG. 2 shows a transmittance curve after crystallization of Sample No. 27. It is also evident from FIGS. 1 and 2 that the rate of transmittance change before and after crystallization is small.

When the crystallized glass of the Sample No. 27 was immersed in a melt of KNO₃ at 475° C. for 7 hours, a compressive stress layer was formed on the sample surface (compressive stress: 110 MPa, compression depth: 10 micrometers).

### EXAMPLE 2

Table 43 and 44 shows Examples (Samples A to J) of the present invention. Table 45 shows Comparative Examples (Samples K to M) of the present invention.

TABLE 43

| | | | | |
|---|---|---|---|---|
| A | B | C | D | E |

| | | |
|---|---|---|
| Composition | SiO₂ | 67.4 |
| [wt %] | Al₂O₃ | 22.3 |
| | B₂O₃ | 0.00 |
| | P₂O₅ | 1.33 |
| | Li₂O | 3.68 |
| | Na₂O | 0.37 |
| | K₂O | 0.00 |
| | MgO | 1.24 |
| | CaO | 0.00 |
| | SrO | 0.00 |
| | BaO | 0.00 |
| | ZnO | 0.00 |
| | TiO₂ | 0.0145 |
| | SnO₂ | 1.13 |
| | ZrO₂ | 2.62 |
| | Fe₂O₃ | 0.0064 |
| | Y₂O₃ | 0.00 |
| | MoO₃ | 0.0000 |
| | Sb₂O₃ | 0.00 |
| | As₂O₃ | 0.00 |
| Composition | Pt | 0.71 |
| [ppm] | Rh | 0.10 |
| | Pt + Rh | 0.81 |

| | |
|---|---|
| Sn/(P + B + Zr + Ti + Sn) | 0.222 |
| Al/(Zr + Sn) | 5.95 |
| (Mg + Zn)/Li | 0.337 |
| Sn/(Zr + Sn) | 0.30 |
| (Si + Al)/Li | 24.38 |
| (Si + Al)/Sn | 79.38 |
| (Li + Na + K)/Zr | 1.55 |
| Ti/Zr | 0.0055 |
| Ti/(Ti + Fe) | 0.694 |
| Na + K + Ca + Sr + Ba | 0.37 |
| (Mg + Ca + Sr + Ba)/Zr | 0.47 |
| (Mg + Ca + Sr + Ba)/(Li + Na + K) | 0.31 |
| Al/(Li + (½*(Mg + Zn)) | 6.68 |
| Sb + As | 0.00 |

Before crystallization

| Density[g/cm3] | 2.422 | | | | |
|---|---|---|---|---|---|
| β-OH[/mm] | 0.14 | 0.20 | 0.36 | 0.42 | 0.62 |

After crystallization

| Crystallization condition | 780° C.-45 min | | | | |
|---|---|---|---|---|---|
| | 890° C.-15 min | | | | |
| Density[g/cm3] | 2.492 | 2.500 | 2.509 | 2.510 | 2.511 |

TABLE 44

| | | | | |
|---|---|---|---|---|
| F | G | H | I | J |

| | | |
|---|---|---|
| Composition | SiO₂ | 67.4 |
| [wt %] | Al₂O₃ | 22.3 |
| | B₂O₃ | 0.00 |
| | P₂O₅ | 1.33 |
| | Li₂O | 3.68 |
| | Na₂O | 0.37 |
| | K₂O | 0.00 |
| | MgO | 1.24 |
| | CaO | 0.00 |
| | SrO | 0.00 |
| | BaO | 0.00 |
| | ZnO | 0.00 |
| | TiO₂ | 0.0145 |
| | SnO₂ | 1.13 |
| | ZrO₂ | 2.62 |
| | Fe₂O₃ | 0.0064 |
| | Y₂O₃ | 0.00 |
| | MoO₃ | 0.0000 |
| | Sb₂O₃ | 0.00 |
| | As₂O₃ | 0.00 |
| Composition | Pt | 0.71 |
| [ppm] | Rh | 0.10 |
| | Pt + Rh | 0.81 |

| | |
|---|---|
| Sn/(P + B + Zr + Ti + Sn) | 0.222 |
| Al/(Zr + Sn) | 5.95 |
| (Mg + Zn)/Li | 0.337 |
| Sn/(Zr + Sn) | 0.30 |
| (Si + Al)/Li | 24.38 |
| (Si + Al)/Sn | 79.38 |
| (Li + Na + K)/Zr | 1.55 |
| Ti/Zr | 0.0055 |
| Ti/(Ti + Fe) | 0.694 |
| Na + K + Ca + Sr + Ba | 0.37 |
| (Mg + Ca + Sr + Ba)/Zr | 0.47 |
| (Mg + Ca + Sr + Ba)/(Li + Na + K) | 0.31 |
| Al/(Li + (½*(Mg + Zn)) | 10.09 |
| Sb + As | 0.00 |

Before crystallization

| Density[g/cm3] | 2.422 | | | | |
|---|---|---|---|---|---|
| β-OH[/mm] | 0.14 | 0.20 | 0.36 | 0.42 | 0.62 |

After crystallization

| Crystallization condition | 780° C.-15 min | | | | |
|---|---|---|---|---|---|
| | 890° C.-5 min | | | | |
| Density[g/cm3] | 2.449 | 2.472 | 2.491 | 2.499 | 2.508 |

TABLE 45

| | | |
|---|---|---|
| K | L | M |

| | | |
|---|---|---|
| Composition | SiO₂ | 65.7 |
| [wt %] | Al₂O₃ | 22.2 |
| | B₂O₃ | 0.00 |
| | P₂O₅ | 1.40 |
| | Li₂O | 3.70 |
| | Na₂O | 0.40 |
| | K₂O | 0.30 |
| | MgO | 0.70 |
| | CaO | 0.00 |
| | SrO | 0.00 |
| | BaO | 1.20 |
| | ZnO | 0.00 |
| | TiO₂ | 2.00 |
| | SnO₂ | 0.20 |
| | ZrO₂ | 2.20 |
| | Fe₂O₃ | 0.0150 |
| | Y₂O₃ | 0.00 |
| | MoO₃ | 0.0000 |
| | Sb₂O₃ | 0.00 |
| | As₂O₃ | 0.00 |
| Composition | Pt | 0.05 |
| [ppm] | Rh | 0.05 |
| | Pt + Rh | 0.10 |

| | |
|---|---|
| Sn/(P + B + Zr + Ti + Sn) | 0.034 |
| Al/(Zr + Sn) | 9.25 |
| (Mg + Zn)/Li | 0.189 |
| Sn/(Zr + Sn) | 0.08 |
| (Si + Al)/Li | 23.76 |
| (Si + Al)/Sn | 439.50 |
| (Li + Na + K)/Zr | 2.00 |
| Ti/Zr | 0.9091 |
| Ti/(Ti + Fe) | 0.993 |
| Na + K + Ca + Sr + Ba | 1.90 |
| (Mg + Ca + Sr + Ba)/Zr | 0.86 |
| (Mg + Ca + Sr + Ba)/(Li + Na + K) | 0.43 |
| Al/(Li + (1/2*(Mg + Zn)) | 6.35 |
| Sb + As | 0.00 |

Before crystallization

| Density[g/cm3] | 2.423 | | |
|---|---|---|---|
| β -OH[/mm] | 0.13 | 0.37 | 0.54 |

After crystallization

| Crystallization condition | 780° C.-45 min | | |
|---|---|---|---|
| | 890° C.-15 min | | |
| Density[g/cm3] | 2.516 | 2.520 | 2.520 |

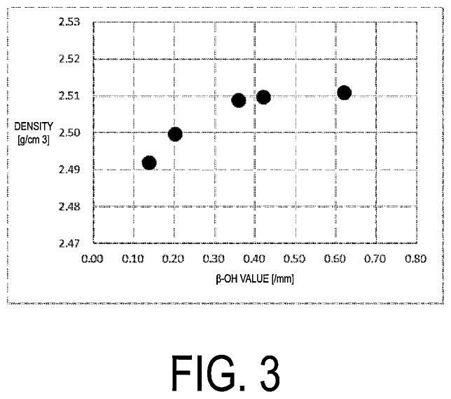

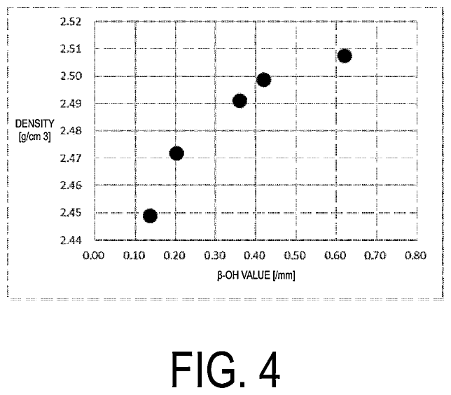

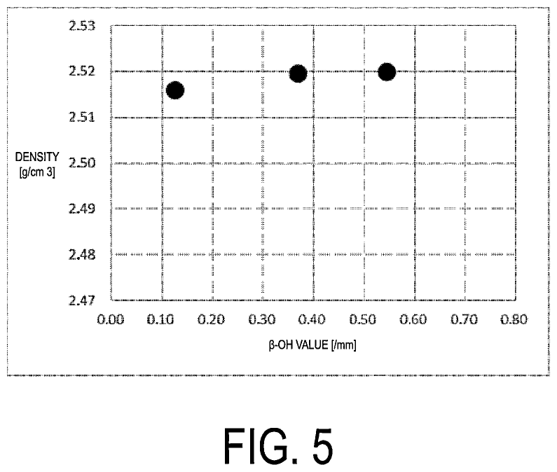

The Samples A to M listed in Tables 31, 32, and 33 were prepared in much the same way as in Example 1, and the β-OH value before crystallization, and the density after crystallization were measured. A relationship between the β-OH values and the densities of Samples A to E is shown in FIG. 3, a relationship between the β-OH value and the densities of Samples F to J is shown in FIG. 4, and a relationship between the β-OH value and the densities of Samples K to M is shown in FIG. 5.

As is evident from FIGS. 3 and 4, it was found that, for the crystallized glass samples having a small content of TiO₂ and being easily colorless and transparent, a higher β-OH value results in a higher density and a higher degree of crystallization. On the other hand, as is evident from FIG. 5, it was found that for the crystallized glass samples having a large content of TiO₂ and being easily colored in yellow, crystallization was progressed to a similar level regardless of the β-OH value. This result clearly indicates the effects of the present invention, that is, to efficiently provide a Li₂O—Al₂O₃—SiO₂-based crystallized glass in which yellow coloration caused by TiO₂, Fe₂O₃, and the like is suppressed and yet transparency is ensured. Note that although Tables 31 and 32 are described as representative Examples of the present invention this time, it was confirmed that similar effects were obtained even in other embodiments described herein. In the Examples listed in Tables 31 and 32, although the crystallization temperatures are fixed in a certain combination, it was confirmed that similar effects were obtained even in other combinations of crystallization temperatures. It is possible to change the crystallization temperature in any way depending on a desired firing time, and a characteristic of the crystallized glass.

### INDUSTRIAL APPLICABILITY

The Li₂O—Al₂O₃—SiO₂-based crystallized glass of the present invention is suitable for a front window of a kerosine stove, a wood stove, and the like, a substrate for a high-tech product such as a color filter and an image sensor substrate, a setter for firing an electronic part, a light diffusion plate, a furnace tube for semiconductor manufacture, a mask for semiconductor manufacture, an optical lens, a member for dimension measurement, a member for communications, a member for construction, a chemical reaction vessel, an electromagnetic cooking top plate, a heat-resistant tableware, a heat-resistant cover, a window glass for a fire door, an astronomical telescope member, a space optical member, and the like.

1. A Li₂O—Al₂O₃—SiO₂-based crystallized glass, comprising: in mass %, from 0 to less than 0.5% of TiO₂, and having a β-OH value from 0.001 to 2/mm.

2. The Li₂O—Al₂O₃—SiO₂-based crystallized glass according to claim 1, further comprising: in mass %, from 40 to 90% of SiO₂; from 5 to 30% of Al₂O₃; from 1 to 10% of Li₂O; from 0 to 20% of SnO₂; from 1 to 20% of ZrO₂; from 0 to 10% of MgO; from 0 to 10% of P₂O₅; and from 0 to less than 2% of Sb₂O₃+As₂O₃.

3. The Li₂O—Al₂O₃—SiO₂-based crystallized glass according to claim 1, further comprising: in mass %, from 0 to 10% of Na₂O; from 0 to 10% of K₂O; from 0 to 10% of CaO; from 0 to 10% of SrO; from 0 to 10% of BaO; from 0 to 10% of ZnO; and from 0 to 10% of B₂O₃.

4. The Li₂O—Al₂O₃—SiO₂-based crystallized glass according to claim 1, further comprising: in mass %, 0.1% or less of Fe₂O₃.

5. The Li₂O—Al₂O₃—SiO₂-based crystallized glass according to claim 1, wherein a mass ratio of SnO₂/(SnO₂+ZrO₂+P₂O₅+TiO₂+B₂O₃) is 0.06 or greater.

6. The Li₂O—Al₂O₃—SiO₂-based crystallized glass according to claim 1, wherein a mass ratio of Al₂O₃/(SnO₂+ZrO₂) is 7.1 or less.

7. The Li₂O—Al₂O₃—SiO₂-based crystallized glass according to claim 1, wherein a mass ratio of SnO₂/(SnO₂+ZrO₂) is 0.01 to 0.99.

8. The Li₂O—Al₂O₃—SiO₂-based crystallized glass according to claim 1, comprising: in mass %, 8% or less of Na₂O+K₂O+CaO+SrO+BaO.

9. The Li₂O—Al₂O₃—SiO₂-based crystallized glass according to claim 1, wherein a mass ratio of (SiO₂+Al₂O₃)/Li₂O is 20 or greater.

10. The Li₂O—Al₂O₃—SiO₂-based crystallized glass according to claim 1, wherein a mass ratio of (SiO₂+Al₂O₃)/SnO₂ is 44 or greater.

11. The Li₂O—Al₂O₃—SiO₂-based crystallized glass according to claim 1, wherein a mass ratio of (MgO+ZnO)/Li₂O is less than 0.395 or greater than 0.754.

12. The Li₂O—Al₂O₃—SiO₂-based crystallized glass according to claim 1, wherein a mass ratio of (Li₂O+Na₂O+K₂O)/ZrO₂ is 2.0 or less.

13. The Li₂O—Al₂O₃—SiO₂-based crystallized glass according to claim 1, wherein a mass ratio of TiO₂/ZrO₂ is 0.0001 to 5.0.

14. The Li₂O—Al₂O₃—SiO₂-based crystallized glass according to claim 1, wherein a mass ratio of TiO₂/(TiO₂+Fe₂O₃) is from 0.001 to 0.999.

15-18. (canceled)

19. The Li₂O—Al₂O₃—SiO₂-based crystallized glass according to claim 1, having a colorless and transparent appearance.

20. The Li₂O—Al₂O₃—SiO₂-based crystallized glass according to claim 1, having a transmittance of 10% or greater at a thickness of 3 mm and a wavelength of 300 nm.

21. The Li₂O—Al₂O₃—SiO₂-based crystallized glass according to claim 1, wherein a β-quartz solid solution is precipitated as a main crystal.

22. The Li₂O—Al₂O₃—SiO₂-based crystallized glass according to claim 1, wherein a thermal expansion coefficient at 30 to 380° C. is 30×10⁻⁷/° C. or less.

23-24. (canceled)

25. The Li₂O—Al₂O₃—SiO₂-based crystallized glass according to claim 1, wherein a mass ratio of Al₂O₃/(Li₂O+(½×(MgO+ZnO)) is from 3.0 to 8.0.

26. A Li₂O—Al₂O₃—SiO₂-based crystallized glass, comprising: in mass %, more than 0% of MoO₃, and having a β-OH value from 0.001 to 0.5/mm.
